(19) United States
(12) Patent Application Publication
(10) Pub. No.: US 2025/0210718 A1
(43) Pub. Date: Jun. 26, 2025

(54) ELECTROLYTE COMPOSITIONS, METHODS OF MAKING SAME, USES THEREOF

(71) Applicant: Cornell University, Ithaca, NY (US)

(72) Inventors: Lynden A. ARCHER, Ithaca, NY (US); Maria Regina GARCIA MENDEZ, Ithaca, NY (US); Jingxu ZHENG, Shenzhen (CN)

(21) Appl. No.: 18/848,170

(22) PCT Filed: Mar. 20, 2023
(86) PCT No.: PCT/US2023/015677

§ 371 Date: Sep. 18, 2024

Related U.S. Application Data
(60) Provisional application No. 63/321,747, filed on Mar. 20, 2022.

(51) Int. Cl. H01M 10/0568; H01M 4/02; H01M 4/134; H01M 4/36; H01M 4/38; H01M 10/054

(52) U.S. Cl. CPC H01M 10/0568; H01M 4/134; H01M 4/366; H01M 4/38; H01M 10/054; H01M 2004/021; H01M 2004/027

(57) ABSTRACT

Electrolyte compositions comprising one or more ion conducting salt(s) and one or more ammonium salt(s), such as, for example, asymmetric ammonium salt(s) or the like, which may, independently, be a quaternary ammonium salt. In various examples, the ammonium salt(s) independently comprise cations(s) chosen from primary ammonium cations, secondary ammonium cations, tertiary ammonium cations, quaternary ammonium cations, and the like, and any combination thereof. In various examples, an electrolyte composition further comprises one or more additional salt(s), which may, independently, be an ion-conducting salt. In various examples, an anode comprising an SEI layer is formed by contacting an anode, such as, for example, a metal anode or the like, with one or more electrolyte composition(s). In various examples, an electrochemical device, such as, for example, a battery, a supercapacitor, a fuel cell, an electrolyzer, an electrolytic cell, or the like comprises one or more composition(s) and/or one or more anode(s).

### CROSS-REFERENCE TO RELATED APPLICATIONS

This application claims the benefit of U.S. Provisional Patent Application No. 63/321,747, filed Mar. 20, 2022; the contents of the above-identified application are hereby fully incorporated herein by reference in their entirety.

### STATEMENT REGARDING FEDERALLY SPONSORED RESEARCH

This invention was made with government support under grant no. DE-SC0012673 awarded by the Department of Energy. The government has certain rights in the invention.

### BACKGROUND OF THE DISCLOSURE

Rechargeable batteries composed of earth-abundant and inexpensive metal anodes such as aluminum will have a crucial role in the widespread integration of renewable energy sources into the electric grid and electric vehicles, and are relevant due to their potential to significantly improve the energy density, safety, and cost compared to current state-of-art Lithium-ion batteries. A key barrier remains the high cost and corrosive characteristics of the ionic liquid electrolytes—the only electrolytes where Al anodes exhibit high-enough levels of reversibility to be of practical interest.

Aluminum is the most earth-abundant metal, is trivalent, is inert in ambient humid air, and has a density approximately four-times that of lithium at room temperature. These attributes together make it attractive as a candidate material for cost-effective, long-duration storage of electrical energy in batteries. Scientific discoveries in the past decade have established that secondary Al batteries can be created by paring an Al anode with a graphite or transition metal oxide cathode, in imidazolium-based, room-temperature ionic-liquid-AlCl₃ (IL) electrolytes.

Electrochemical cells based on aluminum have been pursued for more than a decade as a promising technology for storing electrical energy at low cost. The rationale for this interest is as straightforward as it is manifold. The low-cost and simplicity of the battery anode and of the most often used cathode materials (Al foil and a graphitic carbon sheet), mature manufacturing and recycling of Al, air stability of both anode and cathode, high volumetric energy density and Earth crust abundance of Al (13 kWh/L for Al versus 6, 4 and 3 kWh/L for Li, Zn and Na, respectively, and 8% abundance for Al vs. 0.0065, 0.0075, 2.3% for Li, Zn, and Na, respectively) are the leading attributes that differentiate Al batteries from other candidates of contemporary interest. Notwithstanding these beneficial features, Al-based batteries have historically failed to live up to the promise of the chemistry for mainly two reasons. First, the high bandgap (7 eV) Al₂O₃ coating, which forms spontaneously on Al, which protects it from chemical attack by atmospheric agents, passivates the metal in conventional liquid electrolytes. The result is that reversible plating/stripping of Al during charge and discharge of a secondary/rechargeable Al battery is limited to a small number of specialized, expensive electrolytes. Second, the redox active species in these electrolytes are known to be bulky four- ([AlX₄]⁻) and seven- ([Al₂X₇]⁻) fold coordinated Al species, which rules out most insertion type materials as cathode candidates because reversible de/insertion of the multivalent coordinated Al ions is difficult due to their low mobility. Here, X is most commonly a halogen.

Despite these challenges, a number of studies conducted particularly in the last decade have demonstrated that it is possible to create rechargeable Al batteries in 1-ethyl-3-methylimidazolium (EMIM)-AlCl₃ ionic liquid (IL) electrolyte melts. Why these electrolytes are successful in enabling Al reversibility largely remains an open question. Lewis acidity, high ion mobility at the Al/electrolyte interface, and a melting point below room temperature are considered required properties of ionic liquid electrolytes. Initial analyses of the interphases formed on an Al electrode suggested, but not confirmed, that the first of these properties is important for etching away the passivating Al₂O₃ coating and enabling fast interfacial ion transport at the Al/electrolyte interface. One study reported that exposure of Al to an imidazolium-based IL electrolyte creates an ionically conducting interphase on the Al electrode that remains intact when the electrode is immersed in other electrolyte media, including aqueous electrolytes up to 50 cycles.

### SUMMARY OF THE DISCLOSURE

The present disclosure provides, inter alia, compositions (such as, for example, electrolyte compositions or the like), anodes, and devices comprising compositions of the disclosure.

In various examples, a composition comprises: one or more ion-conducing salt(s); one or more ammonium salt(s), such as, for example, asymmetric ammonium salt(s) or the like; and optionally, one or more salt(s) (such as, for example, additional ion conducting salt(s)). In various examples, the composition is a liquid, a molten salt, an ionic liquid, or the like. In various examples, the ion-conducting salt(s) is/are chosen from lithium salts, sodium salts, calcium salts, magnesium salts, aluminum salts, zinc salts, and the like, and any combination thereof. In various examples, the ion-conducting salt cation(s) is/are chosen from lithium cation, sodium cation, calcium cation, magnesium cation, aluminum cation, zinc cation, and any combination thereof. In various examples, the ion-conducting salt anions(s) is/are chosen from halide anions, hydroxide, perchlorate, nitrate, sulfate, phosphate, borates, AsF₆⁻, OTf⁻, CF₃SO₃⁻, bis(fluoromethylsulfonyl)imide (FSI), bis(trifluoromethylsulfonyl)imide (BMPTFSI), bis(perfluoroethane)sulfonyl)imide (BETI), heterocyclic anions, and the like, and any combination thereof. In various examples, the ammonium salt(s) independently at each occurrence each comprise cations(s) chosen from primary ammonium cations, secondary ammonium cations, tertiary ammonium cations, quaternary ammonium cations, and the like, and any combination thereof. In various examples, the ammonium salt(s) is/are chosen from asymmetric primary ammonium salt(s), asymmetric secondary ammonium salt(s), asymmetric tertiary ammonium salt(s), asymmetric quaternary ammonium salt(s), and the like, and any combination thereof. In various examples, the asymmetric ammonium salt(s), such as, for example, asymmetric quaternary ammonium salt cation(s) or the like, comprises, independently at each occurrence, the following structure: N⁺(R¹)(R²)(R³)(R⁴), wherein R¹, R², R³, and R⁴ are independently at each occurrence chosen from H group, alkyl groups, aryl groups, and the like, with the proviso that no two of R¹, R², R³, or R⁴ are the same. In various examples, one or more or all of the ammonium salt(s), such as, for example, asymmetric ammonium salt(s) or the like, which may be quaternary ammonium salt(s) or the like, or the like, has/have C3v symmetry or the like. In various examples, the ammonium salt anions(s), such as, for example, quaternary ammonium salt anion(s) or the like, is/are chosen from halide anions, hydroxide, perchlorate, nitrate, sulfate, phosphate, borates, AsF₆⁻, OTf⁻, CF₃SO₃⁻, bis(fluoromethylsulfonyl)imide (FSI), bis(trifluoromethylsulfonyl)imide (BMPTFSI), bis(perfluoroethane)sulfonyl)imide (BETI), heterocyclic anions, and any combination thereof. In various examples, the ion-conducting salt(s):ammonium salt(s) (such as, for example, asymmetric ammonium salt(s) or the like, which may be quaternary ammonium salt(s) or the like) molar ratio is about 0.7:1 to about 3:1, including all 0.1 ratio values and ranges therebetween. In various examples, the salt(s) are chosen from lithium salts, sodium salts, calcium salts, magnesium salts, aluminum salts, zinc salts, and the like, and any combination thereof. In various examples, the salt(s), which may, independently, be ion-conducting salt(s), is/are present at about 0.01 M to about 1.5M, including all 0.005 M values and ranges therebetween, based on the total volume of the composition. In various examples, the composition is an electrolyte in an electrochemical device or the like. In various examples, at least a portion or all of the ion-conducting salt(s) is/are aluminum trichloride, and the composition comprises Al₂Cl₇⁻, AlCl₄⁻, or a combination thereof.

In various examples, an anode (such as, for example, metal anode or the like) comprises a solid electrolyte interphase (SEI) layer disposed on at least a portion or all of the relevant portion(s) of the anode (such as, for example, the metal substrate, the electrochemically active metal, or the like) formed by interaction with one or more composition(s) of the present disclosure. In various examples, In various examples, an anode (such as, for example, metal anode or the like) the SEI layer comprises a thickness of about 1 nm (nm(s)=nanometer(s)) to about 2 microns (micron(s)=micrometer(s)), including all 0.1 nm values and ranges therebetween. In various examples, an anode (such as, for example, metal anode or the like) comprises a layer of electrochemically active metal comprising lithium metal, sodium metal, calcium metal, magnesium metal, aluminum metal, zinc metal, or the like, or any combination thereof. In various examples, an anode (such as, for example, metal anode or the like), where the layer of the electrochemically active metal is continuous over about 50% or greater of one or more relevant surface(s) of anode and/or there are no observable discontinuities in the layer of the electrochemically active metal over about 50% or greater of one or more relevant surface(s) of anode and/or the layer of the electrochemically active metal does not exhibit an isolated electrochemically active metal deposit. In various examples, the metal anode further aluminium metal and the SEI layer comprises AlClO⁻ or the like, where at least a portion of the ion-conducting salt(s) may be aluminum trichloride or the like, and the composition comprises Al₂Cl₇⁻, AlCl₄⁻, or the like, or a combination thereof.

In various examples, a device comprises one or more composition(s) of present disclosure and/or one or more anode(s) (such as, for example, metal anode(s)) of the present disclosure, where the composition(s) is/are an electrolyte/electrolytes in the device. In various examples, the device is an electrochemical device or the like. In various examples, the electrochemical device is a battery, a supercapacitor, a fuel cell, an electrolyzer, an electrolytic cell or the like. In various examples, the battery is a metal ion-conducting battery and/or a metal battery, or the like. In various examples, the metal ion-conducting battery is an aluminum-ion conducting battery, a zinc-ion conducting battery, a lithium-ion conducting battery, a sodium-ion conducting battery, a calcium-ion conducting battery, a magnesium-ion conducting battery, or the like. In various examples, the metal ion-conducting battery is a rechargeable metal-ion conducting battery or the like. In various examples, at least a portion of the ion-conducting salt(s) is aluminum trichloride and the composition comprises Al₂Cl₇⁻, AlCl₄⁻, or the like, or a combination thereof, and the anode is an aluminum metal anode, comprises aluminum metal, or the like and the SEI layer comprises AlClO⁻ or the like. In various examples, the device comprises one or more cathode(s) or one or more cathode material(s), or the like, or both. In various examples, the device comprises one or more conversion-type cathode(s), intercalation-type cathode(s), or the like, or any combination thereof. In various examples, the device further comprises one or more cathode(s) and one or more separator(s) and/or one or more current collector(s) and/or one or more solid-phase electrolyte(s) and/or one or more additional structural component(s). In various examples, the composition(s), the anode(s), cathode(s), and, optionally, the current collector(s) form a cell of a battery or the like. In various examples, the device comprises a plurality of cells, each cell independently comprising one or more composition(s) and/or one or more anode(s) and/or anode material(s), and optionally, one or more current collector(s), or a combination thereof. In various examples, the device comprises 1 to 500 cells, including all integer values and ranges therebetweeen.

### BRIEF DESCRIPTION OF THE FIGURES

The patent or application file contains at least one drawing executed in color. Copies of this patent or patent application publication with color drawing(s) will be provided by the Office upon request and payment of the necessary fee.

For a fuller understanding of the nature and objects of the disclosure, reference should be made to the following detailed description taken in conjunction with the accompanying figures.

FIG. 1(A)-(B) shows (A) Effect of molecular structure and symmetry on cost and melting point of electrolytes that enable reversible stripping and plating of Aluminum* (B) Schematic illustrating the interplay between the AlCl₄⁻ to Al₂Cl₇⁻ ratio and the Al plating/stripping coulombic efficiency coupled with the interphase chemistry on an Al electrode. *The concentration used for liquidus temperatures: 1.5 moles of AlCl₃ to 1 mole of alkylammonium/imidazolium chloride. The costs only consider the solvent and not the salt: AlCl₃.

FIG. 2(A)-(D) shows phase diagrams of ammonium-based electrolytes as a function of AlCl₃ mole percent. (A) 1-ethyl-3-methylimidazolium chloride EMIMCl, (B) Triethylamine-hydrochloride (TriEAHCl), (C) Trimethylamine-hydrochloride (TriMAHCl), and (D) Tetramethylammonium chloride (TetraMACl). Blue dotted line corresponds to 25° C. (RT=room temperature).

FIG. 3(A)-(C) shows percentage of AlCl₄⁻ and Al₂Cl₇⁻ in ionic liquids as a function of AlCl₃ mole fraction, determined via quantitative ²⁷Al NMR (A) AlCl₃-EMIMCl (1-ethyl-3-methyl-imidazolium chloride) (B) AlCl₃-TriEAHCl (Triethylamine hydrochloride) (C) AlCl₃-TriMAHCl (Trimethylamine hydrochloride).

FIG. 4(A)-(C) shows electrochemical cycling behavior of Al electrodes in galvanostatic plating/stripping experiments using various electrolytes; (top) 1.8:1 AlCl₃-EMIMCl (1-ethyl-3-methyl-imidazolium chloride) (middle) 1.6:1 AlCl₃-TriEAHCl (Triethylamine hydrochloride) (bottom) 1.5:1 AlCl₃-TriMAHCl (Trimethylamine hydrochloride) (A) Al plating/stripping efficiency measured at 1 mAh·cm⁻² areal capacity, 4 mA·cm⁻² current density (B) Voltage profiles obtained during Al plating/stripping at 1 mAh·cm⁻² areal capacity, 4 mA·cm⁻² current density (C) SEM of FIB-milled cross-sections of Al anodes cycled using various electrolytes.

FIG. 5(A)-(K) shows X-Ray Photoelectron Spectroscopy (XPS) analysis of Al anodes as a function of cycle number and depth on O 1s, Al 2p, and Cl 2p core levels and electrochemical impedance spectroscopy (EIS) measurements on Al symmetric cells (A-C) cycle no. 5, (D-F) cycle no. 50, (G-I) cycle no. 50 after 127 min of Ar sputtering, (J) EIS spectra of Al symmetric cells as assembled (black trace) and after 50 cycles (red trace), (K) EIS spectrum of Al symmetric cell after 50 cycles of plating and stripping.

FIG. 6(A)-(D) shows electrochemical cycling behavior of Al-graphite cells and materials characterization of graphite cathode (A) Long-term stability cycling test of an Al-graphite cell over 1300 charging and discharging cycles at a current density of 335.4 mA·g⁻¹ (6 mA·cm⁻²) using 1.5:1 AlCl₃-TriMAHCl (trimethylamine hydrochloride) as the electrolyte (B) Specific discharge capacity and Coulombic efficiency as a function of current density of Al-graphite cells (C) X-ray diffraction on graphite cathodes upon charging at 1 mA·cm⁻² using 1.5:1 AlCl₃-TriMAHCl (trimethylamine hydrochloride) as the electrolyte (D) Raman on graphite cathodes upon charging at 1 mA·cm⁻² using 1.5:1 AlCl₃-TriMAHCl (trimethylamine hydrochloride) as the electrolyte.

FIG. 7(A)-(B) shows effect of cooling rate on freezing points in AlCl₃-[EMIM]Cl (1.5:1, in molar ratio). (A) Differential Scanning Calorimetry (DSC) spectra with varying cooling rates from 0.75 to 6° C. min-1 (B) Freezing points as a function of cooling rate.

FIG. 8(A)-(E) shows images of AlCl₃-ammonium-based compounds (molar ratio 1.5:1) (A) Trimethylamine-HCl (B) Triethylamine-HCl (C) Tetramethylammonium chloride (D) Tetraethylammonium chloride (E) Tetrapropylammonium chloride. Images B and D show the magnetic stirrer inside the glass vial.

FIG. 9(A)-(F) shows molecular structures of cations and anions present in the ammonium-based electrolytes. Blue=Nitrogen, Purple=Carbon, Gray=Hydrogen, Yellow=Aluminum, Green=Chlorine. (A) Trimethylammonium+(TriMAH+), (B) Tetrachloroaluminate⁻ (AlCl₄⁻), (C) Tetramethylammonium⁺ (TetraMA⁺), (D) Triethylammonium⁺ (TriEAH⁺), (E) Heptachloroaluminate (Al₂Cl₇⁻), (F) Tetraehtylammonium⁺ (TetraEA⁺).

FIG. 10(A)-(J) shows quantitative deconvolution of AlCl₄⁻ and Al₂Cl₇⁻ via liquid-state ²⁷Al NMR on AlCl₃-[EMIM]Cl ionic liquid electrolyte mixtures, varying AlCl₃ molar concentration keeping 1 mole of [EMIM]C1 constant (A) 0.6 AlCl₃, (B) 1 AlCl₃, (C) 1.2 AlCl₃, (D) 1.4 AlCl₃, (E) 1.5 AlCl₃, (F) 1.6 AlCl₃, (G) 1.8 AlCl₃, (H) 2 AlCl₃, (I) 2.2 AlCl₃ and (J) 3 AlCl₃. Traces; black—raw data, blue—fitting for individual species AlCl₄⁻ and Al₂Cl₇⁻, red—fitting of the sum of species.

FIG. 11(A)-(H) shows quantitative deconvolution of AlCl₄⁻ and Al₂Cl₇⁻ via liquid-state ²⁷Al NMR on AlCl₃-TriEAHCl ionic liquid electrolyte mixtures, varying AlCl₃ molar concentration keeping 1 mole of TriEAHCl constant (A) 1.2 AlCl₃, (B) 1.4 AlCl₃, (C) 1.5 AlCl₃, (D) 1.6 AlCl₃, (E) 1.8 AlCl₃, (F) 2.2 AlCl₃, (G) 2.6 AlCl₃, (H) 3 AlCl₃. Traces; black—raw data, blue—fitting for individual species AlCl₄⁻ and Al₂Cl₇⁻, red—fitting of the sum of species.

FIG. 12(A)-(H) shows quantitative deconvolution of AlCl₄⁻ and Al₂Cl₇⁻ via liquid-state ²⁷Al NMR on AlCl₃-TriMAHCl ionic liquid electrolyte mixtures, varying AlCl₃ molar concentration keeping 1 mole of TriMAHCl constant (A) 1 AlCl₃, (B) 1.2 AlCl₃, (C) 1.4 AlCl₃, (D) 1.5 AlCl₃, (E) 1.8 AlCl₃, (F) 2.2 AlCl₃, (G) 2.6 AlCl₃, (H) 3 AlCl₃. Traces; black—raw data, blue—fitting for individual species AlCl₄⁻ and Al₂Cl₇⁻, red—fitting of the sum of species.

FIG. 13(A)-(C) shows aluminum electrodeposition in room temperature molten salts (1.5:1, in molar ratio—AlCl₃: salt) onto carbon cloth substrate electrodes, SEM, and corresponding EDS elemental maps (A) AlCl₃-[EMIM]Cl, (B) AlCl₃-[TriMAH]Cl, and (C) AlCl₃-[TriEAH]Cl.

FIG. 14(A)-(F) shows electrochemical cycling behavior of Al electrodes in galvanostatic plating/stripping experiments using various electrolytes. (A, B) 1:1 and 2.2:1 AlCl₃-[EMIM]Cl (1-ethyl-3-methyl-imidazolium chloride), respectively, (C, D) 1.2:1 and 2.2:1 AlCl₃-TriEAHCl (Triethylamine hydrochloride), respectively, (E, F) 1:1 and 2.6:1 AiCl₃-TriMAHCl (Trimethylamine hydrochloride), respectively.

FIG. 15(A)-(C) shows voltage response in Al symmetric cells under galvanostatic cycling at 1 mAh·cm⁻² areal capacity, 4 mA·cm⁻² using different electrolytes. (A) 1.8:1 AlCl₃-EMIMCl (1-ethyl-3-methyl-imidazolium chloride), (B) 1.6:1 AlCl₃-TriEAHCl (Triethylamine hydrochloride), (C) 1.5:1 AlCl₃-TriMAHCl (Trimethylamine hydrochloride).

FIG. 16 shows representative potential curves obtained during Al plating/stripping at 1 mAh·cm⁻² areal capacity, 4 mA·cm⁻² demonstrate electrochemical corrosion occurring in the cells when using 2.6:1 AlCl₃-TriMAHCl (Trimethylamine hydrochloride) electrolyte.

FIG. 17(A)-(B) shows ionic transport of imidazolium- and ammonium-based electrolytes as a function of AlCl₃ mole fraction and temperature. (A) Ionic conductivity values measured as a function of AlCl₃ mole fraction at 30° C. via electrochemical impedance spectroscopy. (top) AlCl₃-[EMIM]Cl, (middle) AlCl₃-TriEAHCl, (bottom) AlCl₃-TriMAHCl (B) Ionic conductivity as a function of temperature and calculated energy of activation for transport. Inset shows two representative Nyquist plots used to determine the ionic conductivity of the liquid electrolytes.

FIG. 18 shows Energy Dispersive Spectroscopy (EDS) spectra of Al anodes after 100 cycles of plating and stripping, ending with a plating step, immersed in different electrolytes.

FIG. 19(A)-(C) shows Energy Dispersive Spectroscopy (EDS) elemental maps of Al anodes after 100 cycles of stripping and plating, ending with a plating step using different electrolytes (A) 1.8:1 AlCl₃-EMIMCl, (B) 1.6:1 AlCl₃-TriEAHCl, and (C) 1.5:1 AlCl₃-TriMAHCl.

FIG. 20(A)-(B) shows X-Ray Photoelectron Spectroscopy (XPS) analysis of Al foil as received. (A) O 1s core level (B) Al 2p core level.

FIG. 21 shows variation in atomic percent of C, O, Al, Cl, N as a function of Ar-sputtering time (etching time) of Al anodes collected after galvanostatic plating/stripping in 1.5:1 AlCl₃-[TriMAH]Cl (Trimethylamine hydrochloride) electrolyte, determined via x-ray photoelectron spectroscopy (XPS) survey scans.

FIG. 22 shows three-electrode cyclic voltammetry of AlCl₃-TriMAHCl electrolytes as a function of mole concentration of AlCl₃. Glassy carbon was used as the working electrode, Al as the counter electrode and Pt as the reference electrode.

FIG. 23 shows galvanostatic charge and discharge curves of an Al-graphite cell at a current density of 335.4 mA·g⁻¹ (6 mA·cm⁻²) using 1.5:1 AlCl₃-TriMAHCl (trimethylamine hydrochloride) as the electrolyte.

FIG. 24(A)-(D) shows electrochemical cycling behavior of Al-graphite cells and materials characterization of graphite cathode using 1.6:1 AlCl₃-TriEAHCl (Triethylamine hydrochloride) electrolyte. (A) Long-term cycling stability test of an Al-graphite cell for 1300 charging and discharging cycles at a current density of 335.4 mA·g⁻¹ (6 mA·cm⁻²) (B) Galvanostatic charge and discharge curves from A (C) X-ray diffraction on graphite cathodes upon charging at 1 mA·cm⁻² (D) Raman on graphite cathodes upon charging at 1 mA cm-2.

FIG. 25 (A)-(B) shows electrochemical window determination of (A) Triethylamine hydrochloride and (B) Trimethylamine hydrochloride via cyclic voltammetry, using glassy carbon as the working electrode carbon paper as the counter electrode and silver as the reference electrode, with a scanning rate of 20 mV/sec.

FIG. 26 shows variation in atomic percent of C, O, Al, Cl, N as a function of Ar-sputtering time (etching time) of Al anodes collected after galvanostatic plating/stripping in 1.6:1 AlCl₃-[TriEAH]Cl (Triethylamine hydrochloride) electrolyte, determined via x-ray photoelectron spectroscopy (XPS) survey scans. Average CE is 65%.

FIG. 27 shows electrochemical cycling behavior of Al electrodes in galvanostatic plating/stripping experiments using (A) 1.5:1 AlCl₃-TriMAHClCl (Trimethylamine hydrochloride) at different current densities (1.4 and 2.8 mA·cm⁻²) and 0.35 mA h of capacity, showing coulombic efficiency values of 99.17% (1.4 mA·cm⁻², 0.35 mA h) and 99.22% (2.8 mA·cm⁻², 0.35 mA h) over 1000 cycles, (B) 1.8:1 AlCl₃-EMIMCl (1-ethyl-3-methyl-imidazolium chloride) at 4 mA·cm⁻², 1 mAh·cm⁻² for two different cells.

FIG. 28 shows rate capability of Al∥graphite cells in various electrolytes (areal loadings of cathode materials ˜2 mg/cm²). (A) 1.6:1 AlCl₃-TriEAHCl (B) 1.5:1 AlCl₃-TriMAHCl.

### DETAILED DESCRIPTION OF THE DISCLOSURE

Although subject matter of the present disclosure is described in terms of certain embodiments and examples, other embodiments and examples, including embodiments and examples that do not provide all of the benefits and features set forth herein, are also within the scope of this disclosure. For example, various structural, logical, and process step changes may be made without departing from the scope of the disclosure.

As used herein, unless otherwise indicated, “about”, “substantially”, or “the like”, when used in connection with a measurable variable (such as, for example, a parameter, an amount, a temporal duration, or the like) or a list of alternatives, is meant to encompass variations of and from the specified value including, but not limited to, those within experimental error (which can be determined by, e.g., a given data set, an art accepted standard, etc. and/or with, e.g., a given confidence interval (e.g. 90%, 95%, or more confidence interval from the mean), such as, for example, variations of +/−10% or less, +/−5% or less, +/−1% or less, and +/−0.1% or less of and from the specified value), insofar such variations in a variable and/or variations in the alternatives are appropriate to perform in the instant disclosure. As used herein, the term “about” may mean that the amount or value in question is the exact value or a value that provides equivalent results or effects as recited in the claims or taught herein. That is, it is understood that amounts, sizes, compositions, parameters, and other quantities and characteristics are not and need not be exact, but may be approximate and/or larger or smaller, as desired, reflecting tolerances, conversion factors, rounding off, measurement error, or the like, or other factors known to those of skill in the art such that equivalent results or effects are obtained. In general, an amount, size, composition, parameter, or other quantity or characteristic, or alternative is “about” or “the like,” whether or not expressly stated to be such. It is understood that where “about,” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also, unless otherwise stated, include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

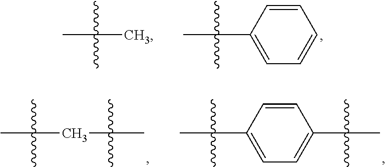

and the like.

As used herein, unless otherwise stated, the term “alkyl group” refers to branched or unbranched saturated hydrocarbon groups. Examples of alkyl groups include, but are not limited to, methyl groups, ethyl groups, propyl groups, butyl groups, isopropyl groups, tert-butyl groups, and the like. In various examples, an alkyl group is C₁ to C₄, including all integer numbers of carbons and ranges of numbers of carbons therebetween (e.g., C₁, C₂, C₃, C₄, C₅, and C₆). The alkyl group may be unsubstituted or substituted with one or more substituent(s). Examples of substituents include, but are not limited to, halogen groups (—F, —Cl, —Br, and —I), aryl groups, halogenated aryl groups, alkoxide groups, amine groups, nitro groups, carboxylate groups, carboxylic acid groups, ether groups, and the like, and any combination thereof.

As used herein, unless otherwise stated, the term “aryl group” refers to C₆ aromatic carbocyclic groups. An aryl group may be unsubstituted or substituted with one or more substituent(s). Examples of substituents include, but are not limited to, halogen groups (—F, —Cl, —Br, and —I), aryl groups, halogenated aryl groups, alkoxide groups, amine groups, nitro groups, carboxylate groups, carboxylic acid groups, ether groups, and the like, and any combination thereof. Aryl groups may include one or more heteroatom(s) in the ring(s) of an aryl group, such as, for example, nitrogen (e.g., pyridinyl groups and the like), and the like. Such groups may be referred to as heteroaryl groups. Examples of aryl groups include, but are not limited to, phenyl groups, tolyl groups, xylyl groups, pyridinyl groups, and the like.

The present disclosure provides, inter alia, compositions. The present disclosure also provides anodes and devices comprising compositions of the disclosure.

Beyond 50 cycles, typically an ionically conducting interphase on the Al electrode degrades and high levels of reversibility (>90%) for Al plating and stripping are not retained because the interphase reacts with the aqueous electrolyte. As an illustrative example, use of an electrolyte composition results in formation of an ionically conducting interphase that remains intact for over 1,400 cycles in a full-cell configuration (Al vs. graphite cathode) when using 1.5:1 AlCl₃-TriMAHCl as the electrolyte, and over 1,200 cycles in a full-cell configuration (Al vs. graphite cathode) when using 1.6:1 AlCl₃-TriEAHCl electrolyte.

In an aspect, the present disclosure provides compositions. A composition may be an electrolyte composition. In various examples, a composition or compositions is used in a device (e.g., as electrolyte(s) in a battery or the like). Non-limiting examples of compositions are disclosed herein.

In various examples, a composition (e.g., an electrolyte composition) comprises (or consists essentially of, or consists of): one or more ion-conducing salt(s) (which may be first salt(s)); one or more ammonium salt(s) (e.g., asymmetric ammonium salt(s) or the like). In various examples a composition further comprises one or more salt(s) (e.g., other ion-conducting salt(s) or the like that is/are compositionally different than the ion-conducting salts) (which may be second salt(s)). Combinations of comprising two or more ammonium salts, where each of the ammonium salts is distinct (e.g., compositionally distinct or the like) from the other ammonium salts, may be used. In various examples, a composition is a liquid (such as, for example, an ionic-liquid or the like), a molten salt, or the like. In various examples, a composition does not comprise an ionic liquid, such as, for example, an imidazolium ionic liquid or the like.

A composition can have various forms. In various examples, a composition is a liquid, a molten salt, an ionic liquid, or the like. In various examples, a composition is a liquid or molten salt or an ionic liquid at a temperature of −50° C. to a temperature below the melting point of the ion-conducing salt(s) and/or a temperature at least one or more of the composition components degrades or decomposes (e.g., a temperature of about 15° C. to about 25° C. (such as, for example, about room temperature)).

A composition can comprise various ion-conducting salts. In various examples, a composition comprises a combination of structurally distinct ion-conducting salts. Non-limiting examples of ion-conducting salts include lithium salts, sodium salts, calcium salts, magnesium salts, aluminum salts, zinc salts, and the like, and any combination thereof. An ion-conducting salt comprises an ion-conducting salt cation and/or an ion-conducting salt anion. Non-limiting examples of ion-conducting salt cations include lithium cation, sodium cation, calcium cation, magnesium cation, aluminum anion, zinc cation, and the like, and any combination thereof. Non-limiting examples of ion-conducting salt anions include halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆⁻, OTf⁻, CF₃SO₃⁻, bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof. In various examples, the ion-conducting salt(s) are chosen from ion-conducting salts typically used in electrochemical devices (such as, for example, batteries and the like).

In various examples, one or more or all of the ion-conducing salt(s) (or one or more or all of the ion-conducing salt(s) or other salt(s)) is a solid or are solids at ambient temperature. In various examples, one or more or all of the ion-conducing salt(s) (or one or more or all of the ion-conducing salt(s) or other salt(s)) is a solid or are solids at minus 50° C. to a temperature below the melting point of the ion-conducing salt(s) and/or below a temperature at least one or more of the composition components degrades or decomposes (e.g., a temperature of about 15° C. to about 25° C. (such as, for example, about room temperature), including all 0.1° C. values and ranges therebetween.

A composition can comprise various ammonium salts. In various examples, a composition comprises a combination of two or more structurally distinct ammonium salts. Without intending to be bound by any particular theory, it is considered that addition of the ammonium salt(s) results in a decrease of the melting point(s) of the ion-conducting salt(s) (or one or more of the ion-conducing salt(s) or salt(s)) (e.g., such that the composition is a liquid or molten salt or an ionic liquid at temperatures from about 18° C. to about 25 (e.g., about room temperature)).

Non-limiting examples of ammonium salt include primary ammonium cations, secondary ammonium cations, tertiary ammonium cation, quaternary ammonium cations, and any combination thereof. Non-limiting examples of quaternary ammonium salt cations include primary ammonium cations, secondary ammonium cations, tertiary ammonium cations, quaternary ammonium cations, and any combination thereof, which may be asymmetric (e.g., no two of the N substituent groups of the quaternary ammonium salt cation are the same). Non-limiting examples of asymmetric ammonium salts include asymmetric primary ammonium salt(s), asymmetric secondary ammonium salt(s), asymmetric tertiary ammonium salt(s), asymmetric quaternary ammonium salt(s), and the like, and any combination thereof. In various examples, an ammonium salt cation (such as, for example, a quaternary ammonium salt cation or the like), which may be asymmetric, has the following structure: N⁺(R¹)(R²)(R³)(R⁴), wherein R¹, R², R³, and R⁴ are independently at each occurrence chosen from H group, alkyl groups (such as, for example C₁ to C₄ alkyl groups and the like), aryl groups, and the like. In various examples, no two of R¹, R², R³, or R⁴ are the same. In various examples, at least a portion or all of the ammonium salt(s) (such as, for example, quaternary ammonium salt(s) or the like) have C3v symmetry, or the like, or a combination thereof.

An ammonium salt can comprise various anions. In various examples, a composition comprises a combination of structurally distinct ammonium salt anions. Non-limiting examples of ammonium salt anions include halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆⁻, OTf⁻, CF₃SO₃⁻, bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof.

In an illustrative example, a composition comprises AlCl₃. In this case, the ammonium salt(s) is/are chosen such that the composition comprises (or forms) greater than about 70% (e.g., about 70% to about 99%) of the electroactive spec(ies) in the composition are Al₂Cl₇⁻ or the like, or any combination thereof.

A composition can comprise various amounts of ion-conducting salt(s) and/or ammonium salt(s). In various examples, a composition comprises an ion-conducting salt(s):ammonium salt(s) ratio (e.g., molar ratio or the like) of about 0.7:1 to about 3:1 (e.g., about 1:1 to about 2.2:1), including all 0.1 ratio values and ranges therebetween.

In various examples a composition further comprises one or more salt(s) (e.g., other ion-conducting salt(s) or the like that is/are compositionally different than the ion-conducting salts) (which may be second salt(s)). In various examples, an other salt or salts is/are different from the ion-conducting salt(s) in terms of cation composition and/or anion composition. Non-limiting examples of salts (other salt(s)), which may be ion-conducting salts, include lithium salts, sodium salts, calcium salts, magnesium salts, aluminum salts, zinc salts, and the like, and any combination thereof. An other salt comprises an other salt cation and/or an other salt anion. Non-limiting examples of other salt cations include lithium cation, sodium cation, calcium cation, magnesium cation, aluminum cations, zinc cations, and the like, and any combination thereof. Non-limiting examples of other salt anions include halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆, OTf (CF₃SO₃⁻), bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof. In various examples, Non-limiting examples of other salt cations include lithium cation, sodium cation, calcium cation, magnesium cation, aluminum cations, zinc cations, and the like, and any combination thereof. Non-limiting examples of other salt anions include halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆, OTf (CF₃SO₃⁻), bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof. In various examples, an other salt comprises one of the aforementioned cations and one of the aforementioned anions.

In various examples, an other salt or salts have the same cation(s) as the ion-conducting salt(s) or at least one or all of the salt cation(s) are different than at least one or all of the ion-conducting salt(s). In various examples, a composition comprising the salt(s) (other salt(s)) (e.g., where at least one or all of the salt cation(s) are different than at least one or all of the ion-conducting salt(s)) are suitable for use as an electrolyte in a dual-ion device (such as, for example, dual-ion battery or the like.)

A composition can comprise various amounts of other salt(s). In various examples, an other salt or salts (e.g., other salt(s)) is/are present (e.g., in the aggregate) at about 0.01 M to about 1.5M (e.g., 0.1 M to about 1 M) (e.g., based on the total volume of the composition, including all 0.005 M values and ranges therebetween.

Without intending to be bound by any particular theory, it is considered that the compositions comprise (or form) a desirable concentration of one or more acidic spec(ies) that can remove substantially or all of an insulating layer (such as, for example, an oxide layer or a hydroxide layer (or an oxide/hydroxide layer)) from at least a portion or all of the relevant surface(s) of an electrode (e.g., an anode and/or a cathode) and/or form an SEI layer (e.g., an SEI layer having a desirable thickness)

In various examples, a composition comprises (or forms) a desirable concentration of one or more acidic spec(ies) or the like that can remove substantially or all of an oxide insulating layer from at least a portion or all of the relevant surface(s) of an anode. In an illustrative example, in the case of a composition comprising an AlCl₃ ion conducting salt and aluminum anode, the composition comprises (or forms) a desirable concentration of Al₂Cl₇⁻, AlCl₄⁻, or the like, or a combination thereof that can remove substantially or all of an Al₂O₃ insulating layer from at least a portion or all of the relevant surface(s) of an aluminum anode electrode and/or forms an AlClO—layer (SEI layer) (e.g., an AlClO-layer having a desirable thickness) on the aluminum anode at least a portion or all of the relevant surface(s) of an aluminum anode electrode.

In various examples, a composition is an electrolyte in an electrochemical device or the like. In various examples, a composition is an electrolyte in a battery (e.g., a primary battery or a secondary/rechargeable battery) or the like.

A composition can be made by combining one or more ion-conducing salt(s), one or more ammonium salt(s), and optionally, one or more other salt(s). It may be desirable to add (e.g., in a controlled manner to avoid decomposition of any of the composition components) the ion-conducing salt(s) and optionally, other salt(s) to the ammonium salt(s). It may be desirable to form the composition in an inert atmosphere (e.g., nitrogen, argon, or the like) and minimize exposure of the composition to water (e.g., carry out the addition in a low water content atmosphere (e.g., <0.1 ppm H₂O or the like).

In an aspect, the present disclosure provides anodes and anode materials. The anodes may be reversible anodes. The anode materials may be reversible anode materials. Anodes and anode materials may be made by methods of the present disclosure. Non-limiting examples of anodes and anode materials are disclosed herein.

An anode or an anode material comprises: a metal anode or metal substrate; and optionally, a layer of a metal (e.g., an electrochemically active metal or the like), which is disposed on at least a portion or all of one or more relevant surface(s) a metal anode or metal substrate. In various examples, the metal (e.g., the electrochemically active metal or the like) is lithium metal, sodium metal, calcium metal, magnesium metal, aluminum metal, zinc metal, or the like. The layer of metal (e.g., the electrochemically active metal or the like) may be uniform and/or continuous. The layer of metal (e.g., electrochemically active metal or the like) may be planar or non-planar. In various examples, the layer of metal (e.g., the electrochemically active metal or the like) active metal does not comprise any orphaned electrochemically active metal (which may be referred to as electrochemically active dead metal). In various examples, an anode is a metal anode. In various examples, a metal anode is a lithium metal anode, a sodium metal anode, a calcium metal anode, a magnesium metal anode, an aluminum metal anode, a zinc metal anode, or the like. An anode or anode material may be formed in situ.

In various examples, an anode or a metal substrate is planar or non-planar. In various examples, an anode comprises a metal substrate comprising a metal or metal alloy (e.g., a metal or metal alloy on which a layer of layer of electroactive metal can be deposited or reversibly deposited (e.g., plated and/or stripped or the like)). In various examples, a metal or metal alloy is stainless steel, copper, aluminum, nickel, tantalum, molybdenum, or the like, or an alloy thereof.

In various examples, the metal anode or metal substrate or electrochemically active metal comprise (or is) lithium metal, sodium metal, calcium metal, magnesium metal, aluminum metal, zinc metal, or the like, or any combination thereof. In various examples, an anode is a lithium anode, a sodium anode, a calcium anode, a magnesium anode, an aluminum anode, a zinc anode, or the like.

In various examples, an anode comprises a layer of a metal (e.g., a layer of an electrochemically active metal or the like). A layer of metal (e.g., electrochemically active metal or the like) can have various thicknesses. In various examples, the layer of the metal (e.g., electrochemically active metal or the like) has a thickness (which may a linear dimension substantially perpendicular (or perpendicular) to a longest dimension (which may be a linear dimension) of the layer or a linear dimension substantially perpendicular (or perpendicular) to a surface of or a longitudinal axis of the metal anode or metal substrate) of 10 nm to 1 mm (e.g., 50 nm to 500 nm or 100 μm to 300 μm), including all 0.1 nm values and ranges therebetween.

In various examples, a layer of the metal (e.g., electrochemically active metal or the like) is be continuous (e.g., continuous over about 50% or greater, about 60% or greater, about 70% or greater, about 80% or greater, about 90% or greater, about 95% or greater, or about 100% of one or more relevant surface(s) of the metal anode or metal substrate. In various examples, there are no observable discontinuities in the layer of the metal (e.g., the electrochemically active metal or the like) over at about 50% or greater, about 60% or greater, about 70% or greater, about 80% or greater, about 90% or greater, about 95% or greater, or about 100% of one or more relevant surface(s) of the metal anode or metal. Discontinuities can be observed by methods known in the art. In various examples, no discontinuity is observed by optical microscopy, electron microscopy, or both, over about 50% or greater, about 60% or greater, about 70% or greater, about 80% or greater, about 90% or greater, about 95% or greater, or about 100% of one or more surface(s) of the electrically conducting 3-D carbon matrix.

A layer of the metal (e.g., an electrochemically active metal) may not exhibit an isolated metal (e.g., electrochemically active metal) deposit and/or deposits (e.g., one or more electrochemically active metal deposit(s) not in contact with any other metal deposits) and/or isolated metal (electrochemically active metal) deposit or an isolated metal (electrochemically active metal). In various examples, a metal (e.g., an electrochemically active metal or the like) deposit has at least one linear dimension of 20 to 50 microns, including all 0.1 micron values and ranges therebetween. In various examples, the layer of the metal (e.g., the electrochemically active metal or the like) does not exhibit isolated a metal deposit or deposits over about 50% or greater, about 60% or greater, about 70% or greater, about 80% or greater, about 90% or greater, about 95% or greater, or about 100% of one or more relevant surface(s) of the metal anode or metal substrate. In various examples, there are no observable isolated metal deposit or deposits in the layer of the metal (e.g., the electrochemically active metal or the like) over about 50% or greater, about 60% or greater, about 70% or greater, about 80% or greater, about 90% or greater, about 95% or greater, or about 100% of one or more relevant surface(s) of the metal anode or metal substrate. An isolated metal (e.g., the electrochemically active metal or the like) deposit or deposits can be observed by methods known in the art. In various examples, no isolated metal (e.g., the electrochemically active metal or the like) deposit or metal (e.g., the electrochemically active metal or the like) deposits is/are observed by optical microscopy, electron microscopy, or both, over about 50% or greater, about 60% or greater, about 70% or greater, about 80% or greater, about 90% or greater, about 95% or greater, or about 100% of one or more relevant surface(s) of the metal anode or metal substrate.

In various examples, an anode (which may be a reversible anode) comprises a solid electrolyte interphase (SEI) layer disposed on at least a portion or all of the relevant portion(s) of the anode. In various examples, the SEI layer is formed by interaction with (such as, for example, reaction with or the like) a composition or compositions of the present disclosure. In various examples, the SEI layer (such as, for example, an AlClO—SEI layer or the like) comprises a thickness of about 1 nm to about 2 microns (e.g., about 1 nm to about 500 nm), including all 0.1 nm values and ranges therebetween. As an illustrative example, in the case of an aluminum metal anode, the SEI layer comprises AlClO—.

In various examples, an anode does not comprises any surface modification(s) (other than those formed as a result of contact with the composition(s). In various examples, an anode is not pretreated prior to contact with the composition(s).

An anode or anode material may be formed in situ. In various examples a device (such as, for example, a battery or the like) is configured such that the anode(s) and/or anode material(s) are formed prior to the first bulk electrochemically active metal electrodeposition on the anode(s) and/or anode material(s) during routine operation of the device.

In an aspect, the present disclosure provides devices. The devices comprise one or composition(s) and/or one or more anode(s) and/or anode material(s) of the present disclosure. In various examples, the composition(s) comprise/comprise(s) an electrolyte/electrolyte(s) of a device. Non-limiting examples of devices are disclosed herein.

An anode or anodes or anode material or anode materials may have a metal (e.g., an electrochemically active metal) pre-plated (or electrodeposited) (e.g., prior to device fabrication, prior to first electrochemically active metal deposition (which may be bulk deposition), or the like) onto the anode or metal substrate of an anode. An anode or anode material may not have a metal (e.g., an electrochemically active material) thereon (e.g., an electrochemically active metal pre-plated onto the anode or metal substrate), which may be referred to as an anode-free setup.

An anode or anodes or anode material or anode materials may be formed in situ. In various examples, a device (such as, for example, a battery or the like) is configured such that the anode(s) and/or anode material(s) are formed prior to the first bulk metal electrodeposition on the anode(s) and/or anode material(s) during routine operation of the battery.

In various examples, a device does not comprise any other conducting ions (other than those of the composition(s) or formed by the composition(s). In various examples, a device does not comprise and/or any other electrolyte(s) (other than those of the composition(s). In various examples, a device does not comprise any other conducting ions (other than those of the composition(s) or formed by the composition(s) and/or any other electrolyte(s) (other than those of the composition(s).

In various examples, a device is an electrochemical device. Non-limiting examples of electrochemical devices include batteries, supercapacitors, fuel cells, electrolyzers, electrolytic cells, and the like.

In various examples, an electrochemical device is a battery. Non-limiting examples of batteries include secondary/rechargeable batteries, primary batteries, and the like. A battery may be an ion conducting battery. In various examples, a battery is a metal battery (such as, for example, a metal anode battery), or the like.

In various examples, a metal ion-conducting battery is an aluminum-ion conducting battery, a zinc-ion conducting battery, a lithium-ion conducting battery, a sodium-ion conducting battery, a calcium-ion conducting battery, or a magnesium-ion conducting battery. In various examples, a metal ion-conducting battery comprises a metal anode (such as, for example, a lithium anode, a sodium anode, a calcium anode, a magnesium anode, a zinc anode, or the like).

In various examples, a device comprising composition(s) and/or anode(s) and/or anode material(s) of the present disclosure further comprise one or more cathode(s). A cathode may independently comprise one or more cathode material(s). Combinations of cathode materials may be used. Examples of suitable cathode materials are known in the art.

In various examples, the cathode material(s) is/are one or more lithium-containing cathode material(s), one or more sodium-containing cathode material(s), one or more calcium-containing cathode material(s), one or more magnesium-containing cathode material(s), one or more aluminum-containing cathode material(s), one or more zinc-containing cathode material(s), or the like. Examples of suitable metal-containing cathode materials are known in the art. Non-limiting examples of lithium-containing cathode materials include lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and any combination thereof, and the like, and any combination thereof. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂@graphene composites, and the like, and any combination thereof. Non-limiting examples of magnesium-containing cathode materials include magnesium-containing materials (such as, for example, MgMSiO₄ (M=Fe, Mn, Co) materials and MgFePO₄F materials, and the like). Any of these cathodes/cathode materials may comprise a conducting carbon aid.

In various examples, a cathode comprises (or is) a carbon material (such as, for example, carbon black (such as, for example, Ketjen Black carbon and the like), carbon paper, carbon fibers, carbon particles (such as, for example, carbon nanoparticles, carbon microparticles, and the like), hard carbon, graphite, graphitic sheets, Super P® carbon, carbon nanotubes (CNTs) (e.g., single-wall CNTs and multiwall CNTs), or the like, or any combination thereof) or the like. In various examples, a cathode comprising a carbon material (such as, for example, carbon black (such as, for example, Ketjen Black carbon and the like), carbon paper, carbon fibers, carbon particles (such as, for example, carbon nanoparticles, carbon microparticles, and the like), hard carbon, graphite, graphitic sheets, Super P® carbon, carbon nanotubes (CNTs) (e.g., single-wall CNTs and multiwall CNTs), or the like, or any combination thereof) or the like is substantially unchanged or unchanged after contacting a composition or compositions, optionally, after one or more charging and/or discharging cycles.

In various examples, a cathode is a conversion-type cathode. Non-limiting examples of conversion-type cathode materials include iodine, sulfur, sulfur composite materials, polysulfides, metal (e.g., transition metal or the like) sulfides, such as, for example, MoS₂, FeS₂, TiS₂, oxides, selenides, fluorides, nitrides, phosphides, and the like, and any combination thereof. Any of these cathodes/cathode materials may comprise a conducting carbon aid.

A device may further comprise a current collector disposed on at least a portion of the cathode and/or the anode. In various examples, the current collector is a conducting metal or metal alloy. Non-limiting examples of current collectors are known in the art. In various examples, a metal or metal alloy is stainless steel, copper, aluminum, nickel, tantalum, molybdenum, or the like, or an alloy thereof.

In various examples, a device further comprises one or more cathode(s) and optionally, one or more separator(s) (which of which may be disposed between a cathode and an anode), optionally, one or more current collector(s), optionally, one or more solid-phase electrolyte(s), and, optionally, and/or one or more additional structural component(s). Non-limiting examples, of additional structural components include bipolar plates, external packaging, electrical contacts/leads to connect wires, and the like, and any combination thereof.

In various examples, a composition/compositions (which may be an electrolyte/electrolytes), optionally, an anode/anodes, cathode/cathodes, and, optionally, current collector/collectors form a cell of a battery. In various examples, a composition/composition (which may be an electrolyte/electrolytes), optionally, an anode/anodes, a cathode/cathodes, and, optionally, a current collector/collectors form a cell of a battery. A battery may comprise a plurality of the cells and each adjacent pair of the cells is separated by a bipolar plate. In various examples, a device comprises a plurality of cells, each cell independently comprising one or more composition(s) and/or one or more anode(s) and/or anode material(s), and optionally, one or more current collector(s), or a combination thereof. The number of cells in the battery may be determined by the performance requirements (e.g., voltage output and the like) of the battery and is limited only by fabrication constraints. In various examples, a battery comprises 1 to 500 cells, including all integer number of cells and ranges therebetween.

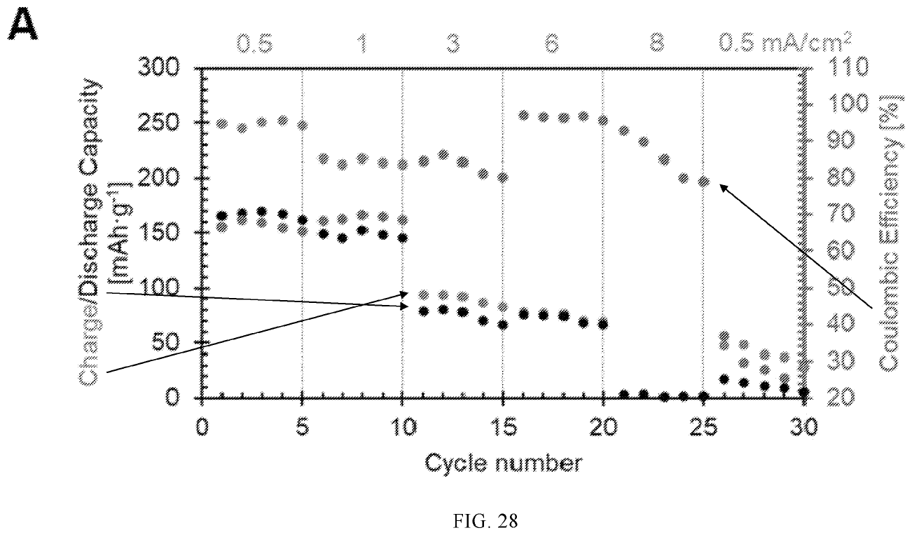

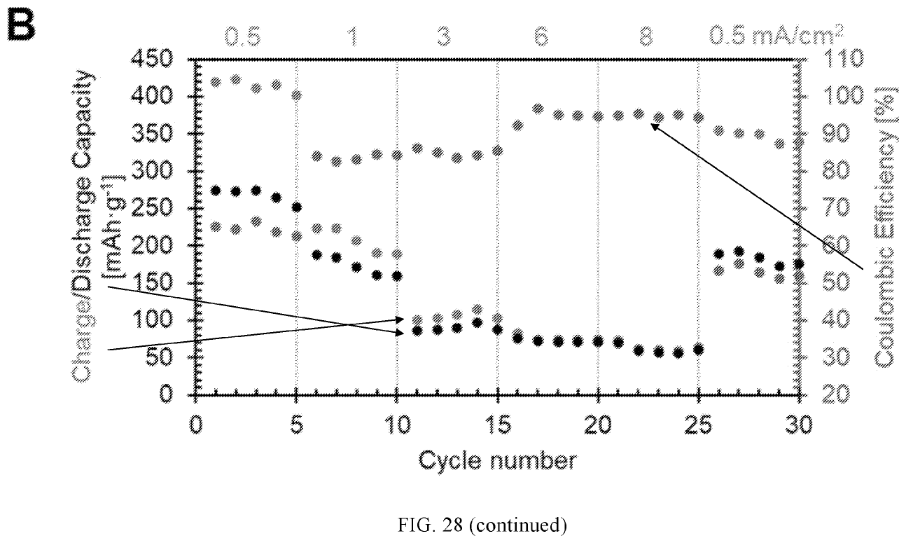

A device can exhibit one or more desirable propert(ies). In various examples, a battery comprises an Al anode, a graphite cathode, and a 1.5:1 molar ratio AlCl₃-TriMAHCl electrolyte, and the battery, with an areal loading of about 12 mg/cm², exhibits one or both of the following: the battery does not exhibit detectable dendritic growth and/or orphaning (e.g., exhibits at least about 1,400 charging/discharging cycles without failure); or discharge capacities between about 15 to about 20 mAh/g (e.g., at a current density of about 6 mA/cm²). When areal loadings are decreased to about 2 mg/cm² in these battery, discharge capacities between about 60 and about 270 mAh/g are observed, when applying current densities of about 0.5 and about 8 mA/cm², with coulombic efficiencies ranging from about 50% to about 96% (see FIG. 28). In various examples, a battery comprises an Al anode, a graphite cathode, and a 1.6:1 AlCl₃-TriEAHCl electrolyte, and the battery, with an areal loading of about 5 mg/cm², exhibits one or both of the following: the battery does not exhibit detectable dendritic growth and/or orphaning (e.g., exhibits at least about 1200 or more charging/discharging cycles without failure); or discharge capacities between about 17 to about 25 mAh/g at a current density of about 6 mA/cm². When the areal loading is decreased to about 2 mg/cm², discharge capacities between about 1 to about 165 mAh/g are observed, when applying current densities between 0.5 to 8 mA/cm², with coulombic efficiencies ranging from about 17 to 97% (see FIG. 28).

The following Statements describe various examples of compositions, anodes, and devices of the present disclosure and are not intended to be in any way limiting:

Statement 1. A composition (e.g., an electrolyte composition) comprising (or consisting essentially of, or consisting of): one or more ion-conducing salt(s) (which may be first salt(s)); one or more ammonium salt(s) (e.g., asymmetric ammonium salt(s) or the like); and optionally, one or more salt(s) (e.g., other ion-conducting salt(s) or the like compositionally different than the ion-conducting salts) (which may be second salt(s)).
Statement 2. A composition according to Statement 1, wherein the composition is a liquid, a molten salt, an ionic liquid, or the like.
Statement 3. A composition according to Statement 1 or 2, wherein the ion-conducting salt(s) are chosen from lithium salts, sodium salts, calcium salts, magnesium salts, aluminum salts, zinc salts, and the like, and any combination thereof.
Statement 4. A composition according to any one of the preceding Statements, wherein the ion-conducting salt cation(s) are chosen from lithium cation, sodium cation, calcium cation, magnesium cation, aluminum cation, zinc cation, and the like, and any combination thereof.
Statement 5. A composition according to any one of the preceding Statements, wherein the ion-conducting salt anions(s) are chosen from halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆⁻, OTf⁻, CF₃SO₃⁻, bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof.
Statement 6. A composition according to any one of the preceding Statements, wherein the quaternary ammonium salt cations(s) are chosen from primary ammonium cations, secondary ammonium cations, tertiary ammonium cations, quaternary ammonium cations, and any combination thereof, wherein the cations are asymmetric (e.g., no two of the N substituent groups of the quaternary ammonium salt cation are the same).
Statement 7. A composition according to any one of the preceding Statements, wherein the quaternary ammonium salt cation has, independently at each occurrence, the following structure: N⁺(R¹)(R²)(R³)(R⁴), wherein R¹, R², R³, and R⁴ are independently at each occurrence chosen from H group, alkyl groups (such as, for example C₁ to C₄ alkyl groups and the like), aryl groups, and the like, with the proviso that no two of R¹, R², R³, or R⁴ are the same.
Statement 8. A composition according to any one of the preceding Statements, at least a portion or all of the quaternary ammonium salt(s) have C3v symmetry, or the like, or a combination thereof.
Statement 9. A composition according to any one of the preceding Statements, wherein the quaternary ammonium salt anions are chosen from halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆⁻, OTf⁻, CF₃SO₃⁻, bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof.
Statement 10. A composition according to any one of the preceding Statements, wherein the ion-conducting salt(s):ammonium salt(s) ratio (e.g., molar ratio or the like) is about 0.7:1 to about 3:1 (e.g., about 1:1 to about 2.2:1).
Statement 11. A composition according to any one of the preceding Statements, wherein the salt(s) (other salt(s) are chosen from lithium salts, sodium salts, calcium salts, magnesium salts, aluminum salts, zinc salts, and the like, and any combination thereof.
In various examples, the other salt(s) is/are different from the ion-conducting salt(s) in terms of cation composition and/or anion composition.
Statement 12. A composition according to any one of the preceding Statements, wherein the other salt cation(s) are chosen from lithium cation, sodium cation, calcium cation, magnesium cation, aluminum anion, zinc ions, and the like, and any combination thereof and/or the ion-conducting salt anions(s) are chosen from halide anions (e.g., F⁻, Cl⁻, Br⁻, and I⁻), hydroxide, perchlorate, nitrate, sulfate, phosphate, borates (such as, for example, hexaflurophosphate, tetrafluoroborate, bis(oxalato)borate, [salicylato benzenediol]borate, and the like), AsF₆—, OTf, CF₃SO₃⁻, bis(fluoromethylsulfonyl)imide (FSI), bis(trifluoromethylsulfonyl)imide (BMPTFSI) ([N(SO₂CF₃)₂]⁻), bis(perfluoroethane)sulfonyl)imide (BETI), heterocyclic anions (such as, for example, 4,5-dicyano-2-(trifluoromethyl)imidazolate (TDI), 4,5-dicyano-2-(pentafluoroethyl)imidazolate (PDI), and the like), and the like, and any combination thereof.
Statement 13. A composition according to any one of the preceding Statements, wherein the salt(s) (e.g., other salt(s)) is/are present (e.g., in the aggregate) at about 0.01 M to about 1.5M (e.g., 0.1 M to about 1 M) (e.g., based on the total volume of the composition, including all 0.005 M values and ranges therebetween.
Statement 14. A composition according to any one of the preceding Statements, wherein the composition is an electrolyte in an electrochemical device (such as, for example, a battery (e.g., a primary battery or a secondary/rechargeable battery) or the like).
Statement 15. An anode (which may be a reversible anode) comprising a solid electrolyte interphase (SEI) layer disposed on at least a portion or all of the relevant portion(s) of the anode formed by interaction with (such as, for example, reaction with or the like) a composition of any one of the preceding Statements.
Statement 16. An anode according to Statement 14, wherein the anode is a metal anode (such as, for example, lithium anode, sodium anode, calcium anode, magnesium anode, aluminum anode, zinc anode, or the like).
Statement 17. An anode according to Statement 15 or 16, wherein the anode comprises a layer of electrochemically active metal.
Statement 18. An anode according to any one of Statements 15-17, wherein the electrochemically active metal comprises (or is) lithium metal, sodium anode, calcium anode, magnesium anode, aluminum anode, zinc anode, or the like.
Statement 19. An anode according to any one of Statements 15-18, wherein the layer of the metal (electrochemically active metal) is continuous over 50% or greater of one or more relevant surface(s) of anode.
Statement 20. An anode according to any one of Statements 15-19, wherein there are no observable discontinuities in the layer of the metal (electrochemically active metal) over 50% or greater of one or more relevant surface(s) of anode.
Statement 21. An anode according to any one of Statements 15-20, wherein the layer of the metal (the electrochemically active metal) does not exhibit an isolated metal (electrochemically active metal) deposit or an isolated metal (electrochemically active metal).
Statement 22. A device comprising one or more composition(s) and/or anode(s) of the present disclosure (e.g., composition(s) according to any of Statements 1-14 and/or anode(s) according to any of Statements 15-21).
Statement 23. A device according to Statement 22, wherein the device is an electrochemical device.
Statement 24. A device according to Statement 22 or 23, wherein the device (or electrochemical device) is a battery (e.g., a primary battery, a secondary/rechargeable battery, or the like) a supercapacitor, a fuel cell, an electrolyzer, an electrolytic cell, or the like.
Statement 25. A device according to any one of Statements 22-24, wherein the battery is a metal ion-conducting battery and/or a metal battery (e.g., metal anode battery or the like). 26. A device according to any one of Statements 22-25, wherein the metal ion-conducting battery is an aluminum-ion conducting battery, a zinc-ion conducting battery, a lithium-ion conducting battery, a sodium-ion conducting battery, a calcium-ion conducting battery, or a magnesium-ion conducting battery.
Statement 27. A device according to any one of Statements 22-26, wherein the battery or ion-conducting battery is a rechargeable metal-ion conducting battery, or the like.
Statement 28. A device according to Statement 22-27, wherein the device comprises one or more cathode material(s) (or cathode(s) comprising one or more cathode material(s)).
Statement 29. A device according to Statement 28, wherein the cathode material(s) is/are lithium-containing cathode material(s), one or more sodium-containing cathode material(s), one or more calcium-containing cathode material(s), one or more magnesium-containing cathode material(s), one or more aluminum-containing cathode material(s), one or more zinc-containing cathode material(s).
Statement 30. A device according to Statement 28, wherein the lithium-containing cathode materials are chosen from lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and any combination thereof, and the like, and any combination thereof.
Statement 31. A device according to Statement 28, wherein the sodium-containing cathode materials are chosen from Na₂V₂O₅, P2-Na₂₃Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂@graphene composites, and the like, and any combination thereof.
Statement 32. A device according to Statement 28, wherein the magnesium-containing cathode materials are chosen from MgMSiO₄ (M=Fe, Mn, Co) materials, MgFePO₄F materials, and the like).
Statement 33. A device according to Statement 22-32, wherein the device comprises one or more conversion-type cathode(s), intercalation-type cathode(s), or the like, or any combination thereof.
Statement 34. A device according to any one of Statements 22-33, wherein the device further comprises a current collector disposed on at least a portion of the cathode or each of the cathodes and/or at least a portion of the anode or each of the anodes.
Statement 35. A device according to any one of Statements 22-34, wherein the device further comprises one or more cathode(s) and optionally, one or more separator(s) (which of which may be disposed between a cathode and an anode), optionally, one or more current collector(s), optionally, one or more solid-phase electrolyte(s), and, optionally, and/or one or more additional structural component(s).
Statement 36. A device according to Statement 35, wherein the one or more additional structural component(s) is/are chosen from bipolar plates, external packaging, electrical contacts/leads to connect wires, and the like, and any combination thereof.
Statement 37. A device according to any one of Statements 22-36, wherein the composition(s), the anode(s), cathode(s), and, optionally, the current collector(s) form a cell of a battery.
Statement 38. A device according to Statement 37, wherein the device comprises a plurality of the cells and each adjacent pair of the cells is separated by a bipolar plate.
Statement 39. A device according to Statement 37 or 38, wherein the device comprises a plurality of cells, each cell comprising one or more composition(s) and/or one or more anode(s) and/or anode material(s), and optionally, one or more current collector(s), or a combination thereof.
Statement 40. A device according to Statement 39, wherein the device comprises 1 to 500 cells.

The following example is presented to illustrate the present disclosure. It is not intended to be limiting in any manner.

### Example

This example provides a description of compositions, anodes, and devices of the present disclosure and uses thereof. This example also provides a description of devices of the present disclosure.

We hypothesized that simple, low-cost electrolytes designed using ammonium-based salts of broken symmetry (i.e., in which the four moieties connected to the nitrogen atom are not equivalent), can be designed to simultaneously exhibit melting points below room temperature and high solvation power for AlCl₃ and its analogs. Such electrolytes would therefore enable plating and stripping of Al inside electrochemical cells with comparable levels of reversibility as the IL melts investigated in earlier works.

Described are findings from a systematic study that sheds light on the structural requirements, physicochemical, and transport properties of the IL electrolytes responsible for the high reversibility of Al battery anodes. Significantly, it was found that the most important interfacial and transport properties of these electrolytes can be achieved in other electrolytes, including ammonium-based molten salts that are available at costs as much as twenty-times lower than the IL-AlCl₃ melt. High Al reversibility in ammonium- and imidazolium-based electrolytes is specifically shown to require an important ratio of the solvation species (AlCl₄⁻ and Al₂C₇⁻), where Lewis's acidity and beneficial interfacial reactions continuously etch the Al₂O₃ resistive interfacial layer and form beneficial solid electrolyte interphase at the anode. The findings yield a quantitative molecular-level understanding of Al electrodeposition in room-temperature ammonium-based molten salts. New electrolyte families were developed that support high Al anode reversibility. Our findings therefore open new opportunities for developing simple, cost-effective, room-temperature Al batteries that enable long-duration electrical energy storage.

A family of low-cost electrolytes intentionally designed enable highly reversible plating and stripping of metallic aluminum inside electrochemical cells was developed. It was shown that by tuning the ratio of [AlCl₄]⁻ and [Al₂Cl₇]⁻ ions in solution, it is possible to sustain the high reversibility over thousands of charge-discharge cycles. The electrolyte molecular design approach described herein provides low melting point electrolytes with the desired Lewis acidity for highly reversible Al electrodeposition and dissolution in secondary batteries.

In considering how one might design lower-cost analogs of the IL electrolytes, we first note that the desirable IL electrolyte properties are not unique to the [EMIM] cation. The Lewis acidity is in fact controlled by the molar ratio between the IL salt ([C]⁺X⁻) and AlCl₃ (e.g., [C]⁺Cl⁻+AiCl₃→[C]⁺[AlCl₄]⁻). This, in turn, sets the relative concentration of electrochemically active [AlX₄]⁻ and [Al₂X₇]⁻ species present at room temperature. The low melting point of the AlCl₃-EMIMCl electrolyte melt in contrast, is conventionally attributed to the large size of the imidazolium cation in comparison with the Cl—anion; the size mismatch destabilizes the ion packing in the solid-state and therefore results in a lower melting point. A key discovery was that the electrolyte properties required for high Al anode reversibility in electrochemical cells are independent of the specific chemical structure of the cation species [C]⁺. This surprising finding opens new approaches for designing chemically simpler and thus, inexpensive electrolytes that enable highly reversible cycling of Al batteries.

As a first step to designing the instant electrolytes, ILs in which [C]⁺ is a quaternary ammonium species were considered; a variety of quaternary ammonium cations composed of short-chain alkyl groups, e.g., methyl-, and ethyl- that are commercially available. Manipulating the symmetry of the cation offers a powerful route towards achieving low melting point electrolytes with the desired Lewis acidity. The simplest symmetry breaking of the nitrogen atom is achievable by replacing one alkyl group with a hydrogen atom, making it a ternary amine. The hydrogen atom breaks the perfect tetrahedron that facilitates packing and alters the symmetry of the cation from a high-order T_{d} point group to a low-order C₃ᵥ point group. Even this modest change reduces the number of symmetry elements from 24 to 6. We note here that symmetry breaking interferes with molecular packing and is an already studied approach for depressing the melting point of molecular crystals, a.k.a. Carnelley's rule.

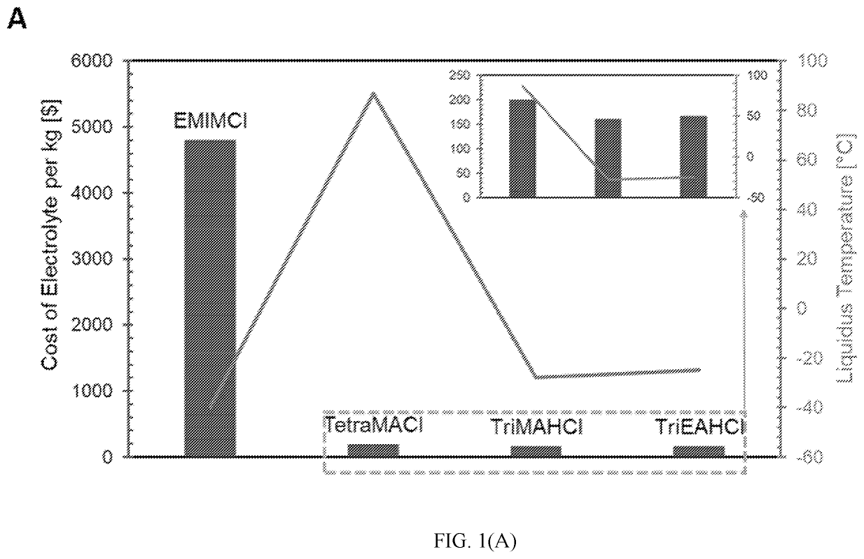

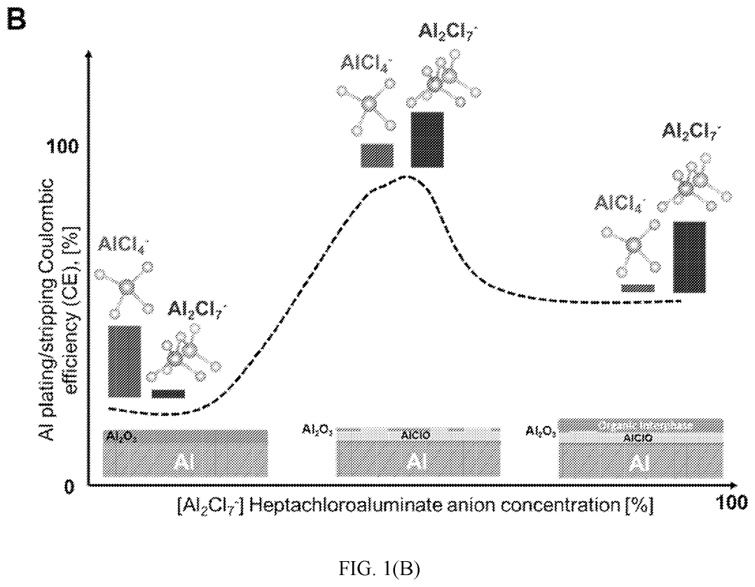

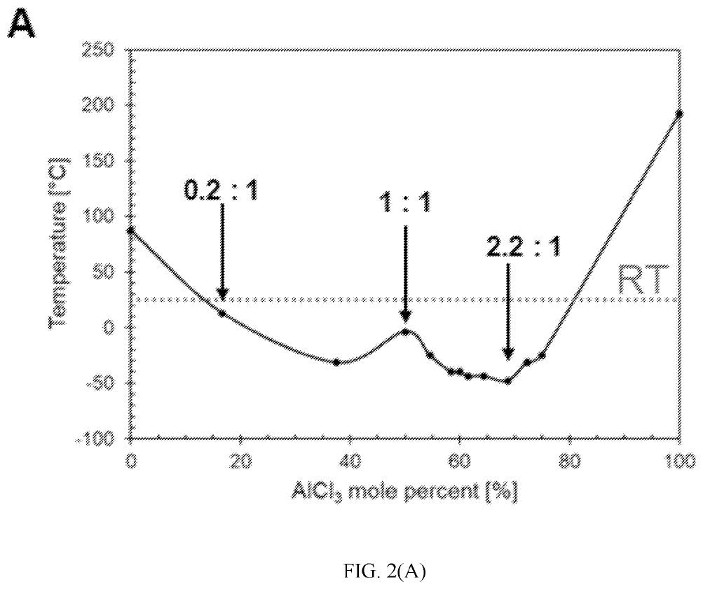

To evaluate this hypothesis, physical and electrochemical properties of Al were studied in electrolytes based on tetramethylammonium chloride (AlCl₃-TetraMACl), Triethylamine-hydrochloride (AlCl₃-TriEAHCl), and Trimethylamine-hydrochloride (AlCl₃-TriMAHCl) melts, in which the symmetry of the ammonium ion is broken to progressively greater extents. As reference, the studied properties were compared to those measured using AlCl₃-EMIMCl, the most frequently used IL electrolyte in Al electrochemical cells. As illustrated in FIG. 1A, the measured melting points of the symmetry-broken quaternary ammonium species drop markedly with reduced symmetry of the cation; the values achieved for TriMAHCl are in fact comparable to those for EMIMCl. Significantly, we also find that Al electrodes are reversible in all of the studied electrolytes and that in Al plating/stripping experiments, the quaternary ammonium chloride-based electrolytes display high levels of reversibility (Al plating/stripping coulombic efficiencies ≥99.3% for 1000 cycles at practical areal capacities and current densities (1 mAh·cm⁻², 4 mA·cm⁻²), which are comparable to those observed in the AlCl₃-EMIMCl electrolyte.

Using ²⁷Al quantitative nuclear magnetic resonance (NMR), electrochemical measurements, and scanning probe microscopy, we show that plating/stripping reversibility increases with AlCl₃ concentration with an upper limit. By probing the surface chemistry of the anodes and imaging the electrode's morphology after electrodeposition using focused ion beam scanning electron microscopy (FIB-SEM), we find that Al plating/stripping reversibility is increased by continuous etching of the Al₂O₃ resistive interfacial layer and formation of a stable conductive solid electrolyte interphase (SEI) on the Al anode. The magnitude of the increase depended on the AlCl₄⁻:Al₂Cl₇⁻ ratio (FIG. 1), where a balance between Lewis's acidity and lack of excess corrosion of the cell components determine the critical ratio. Our results quantitatively link the concentration of solvation species in the electrolytes to Al plating/stripping reversibility. In addition, the composition and resistivity of the SEI was deconvoluted through X-ray photoelectron spectroscopy and electrochemical impedance measurements as a function of the number of cycles.

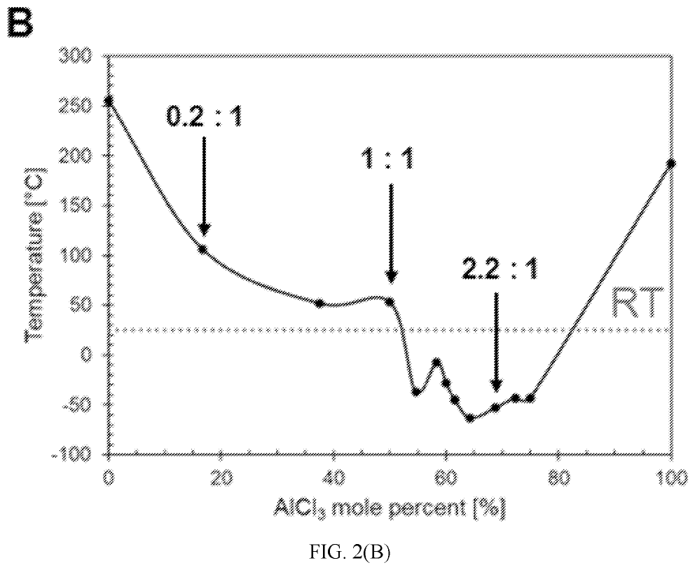

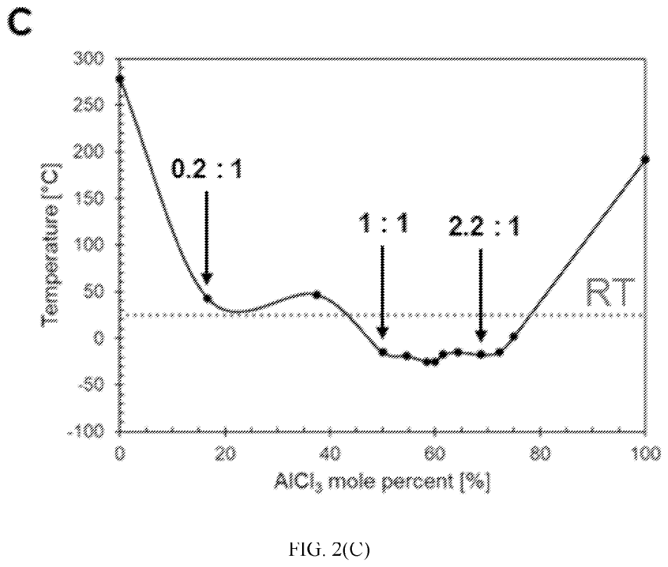

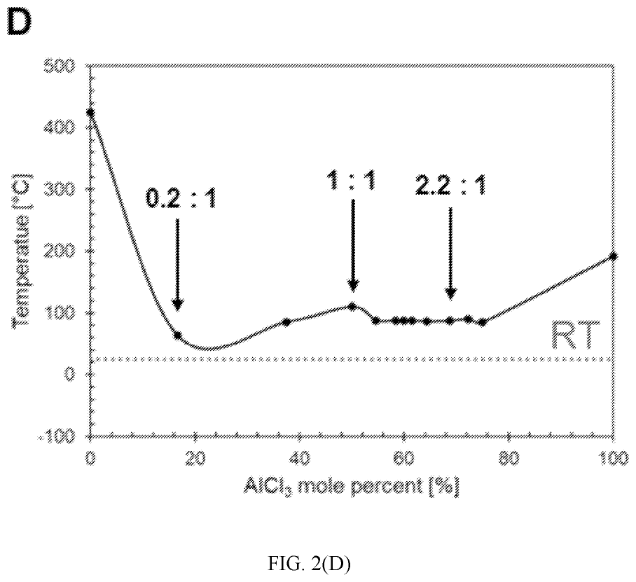

We mapped out the concentrations of ammonium-based electrolytes that form ILs (or molten salts at room temperature) using phase diagrams obtained from differential scanning calorimeter (DSC) with heating and cooling capabilities (FIG. 2). The effect of the cooling/heating rate on freezing points in AlCl₃-EMIMCl (1.5:1 in molar ratio) was evaluated to select the rate that is less dependent on the kinetics of the measurement. As seen in (FIG. 7), rates between 3-6° C.·min⁻¹ result in a minor change in the freezing point of the mixtures. Thus, 3° C.·min⁻¹ was chosen to construct phase diagrams in all systems.

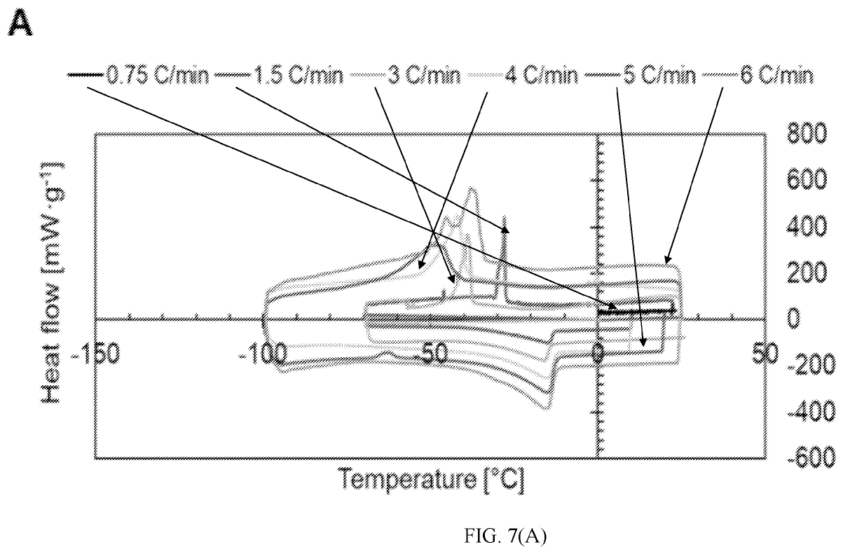

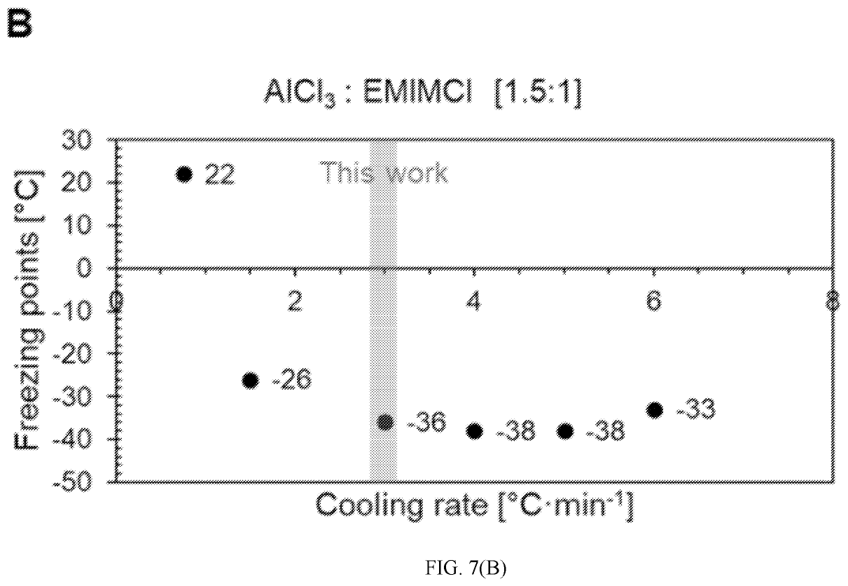

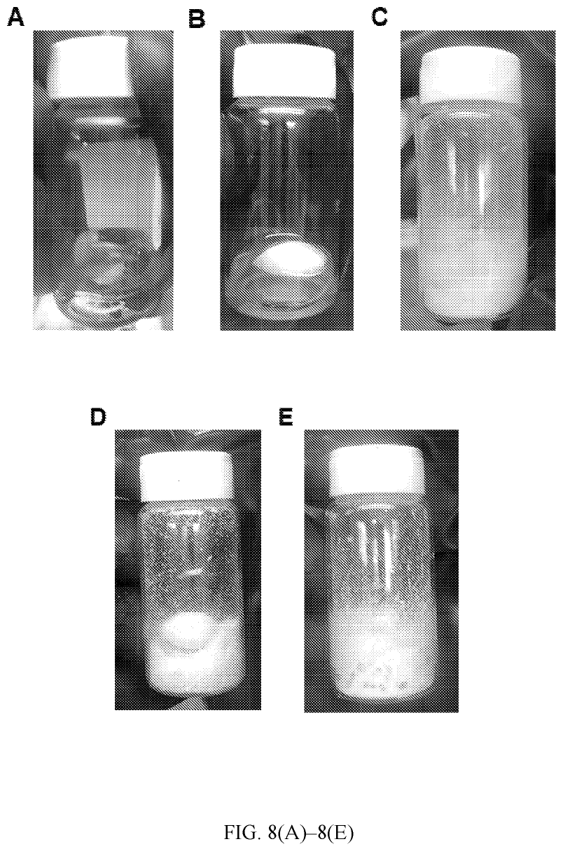

The concentrations that formed molten salts at room temperature were mainly observed between the AlCl₃—salt ratios 1:1 (50 mol % AlCl₃) to 2.6:1 (72.2 mol % AlCl₃). The exception is the electrolyte system composed of the most symmetric and highest molar mass cation AlCl₃—TetraMACl, which remained in solid, crystalline form over the entire concentration range of AlCl₃ studied. These measurements are in agreement with our preliminary observations in mixing higher tetra-alkyl-based compounds with AlCl₃ (FIG. 8), confirming the effect of molecular structure on the melting point and liquid ranges. Increasing the molecular symmetry in the electrolyte, as is the case with tetra-alkyl compounds (FIG. 9), promotes charge ordering and efficient packing remaining in crystalline form at room temperature.

Using the group contribution method (GCM) developed by Lazzús, melting temperatures (Tₘ) for a wide range of ILs with cation groups including imidazolium, pyridinium, pyrrolidinium, ammonium, etc. can be estimated with an average deviation of 7%. Thus, the GCM method was used to rationalize the structural effects on the thermal behavior of each system. The mathematical foundation of the GCM method is based on the principle of collinearity. Tₘ is a linear combination of any number of functions of the independent variables or functional groups in this case. The functional groups are divided into groups for the cation and the anion part, and the size, shape, asymmetry of the cation and anion parts of each system play a role in the Tₘ measured. The melting point decreased as the AlCl₃ concentration increased due to the formation of Al₂Cl₇⁻ anions, which are larger than AlCl₄⁻, known to be formed in acidic compositions, i.e., when AiCl₃ is added in excess of the EMIMCl. An increase in anion size led to reductions in the melting points by reducing the Coulombic attraction contributions to the lattice energy of the crystal and increasing the covalency of the ions. For the cation part, length and asymmetry were more significant in determining the melting point and liquid ranges. The TriEAHCl systems having longer alkyl chains than the TriMAHCl enable higher charge delocalization, further reducing the overall charge density, and both of their asymmetries disrupts the crystal packing and reduces the crystal lattice energy resulting in a lower melting temperature. Given that the TetraMACl system remained crystalline for all concentration ranges, it was not further explored as an electrolyte for the room-temperature Al electrochemical cells of interest here.

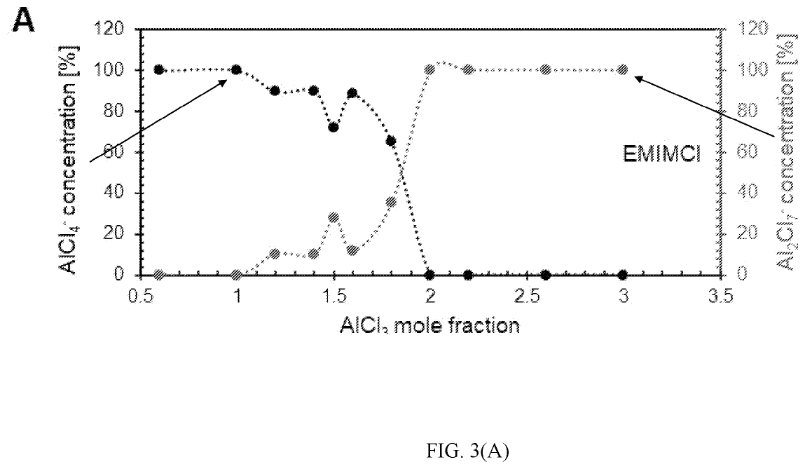

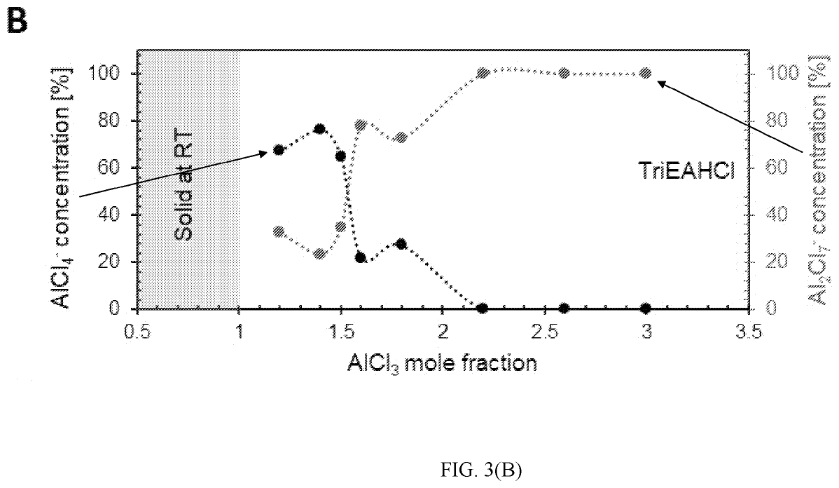

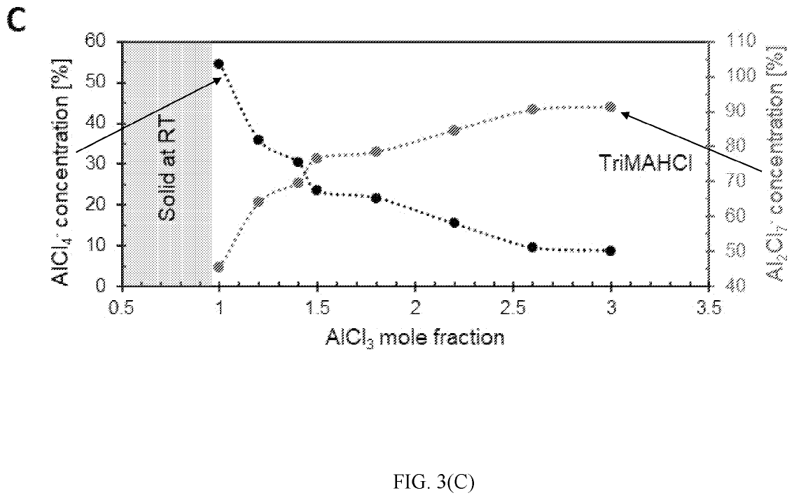

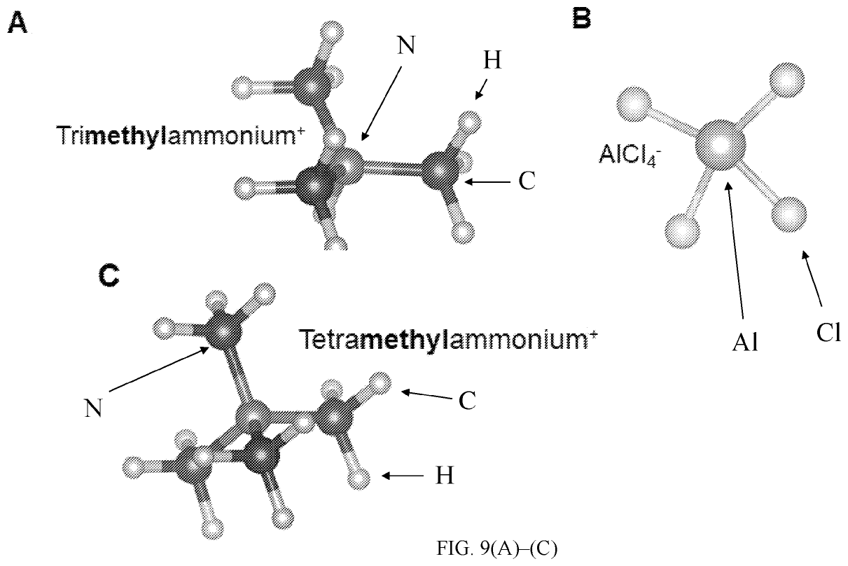

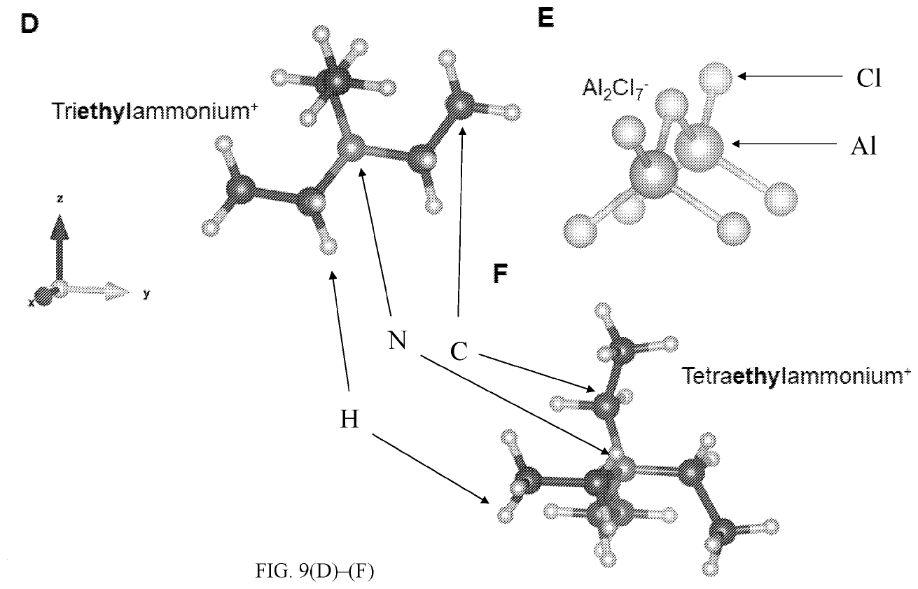

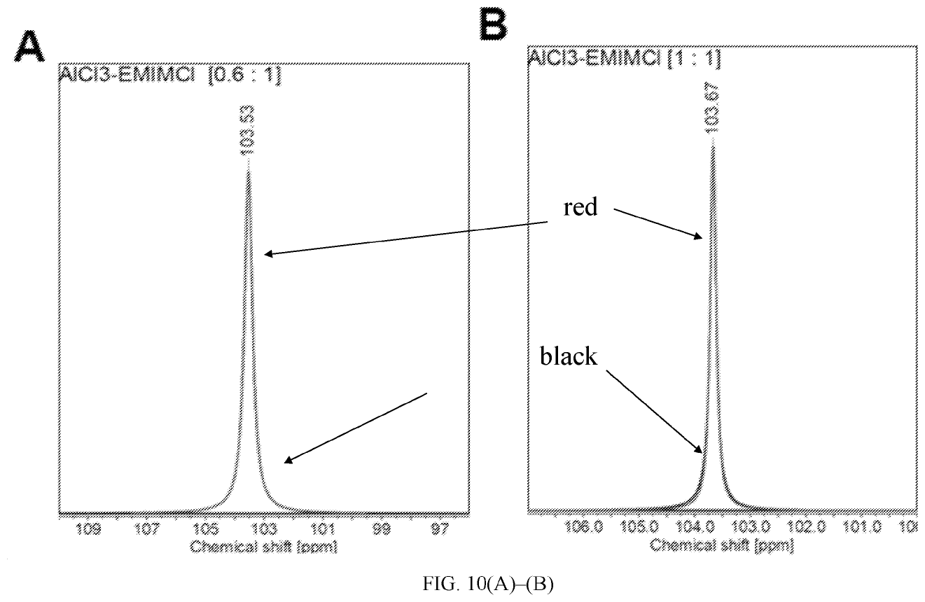

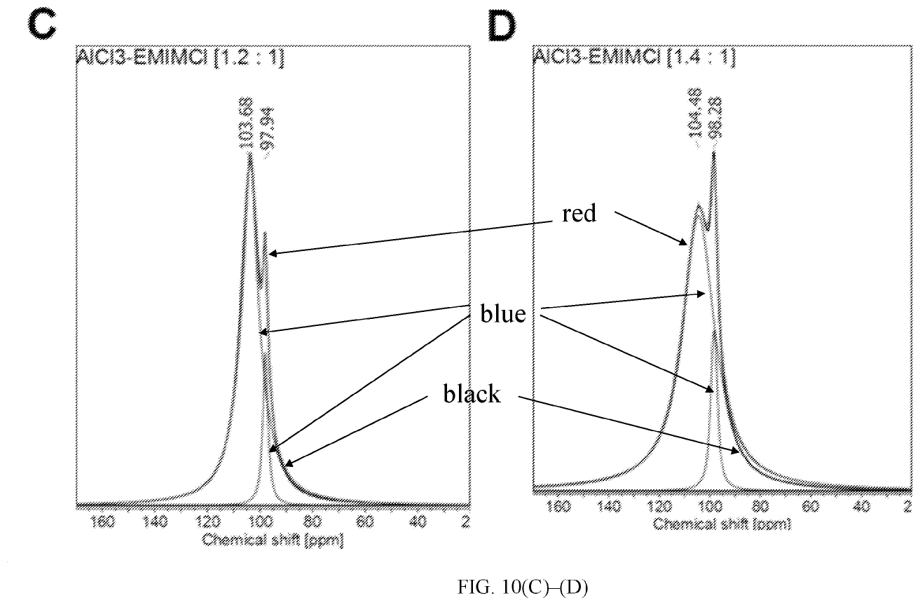

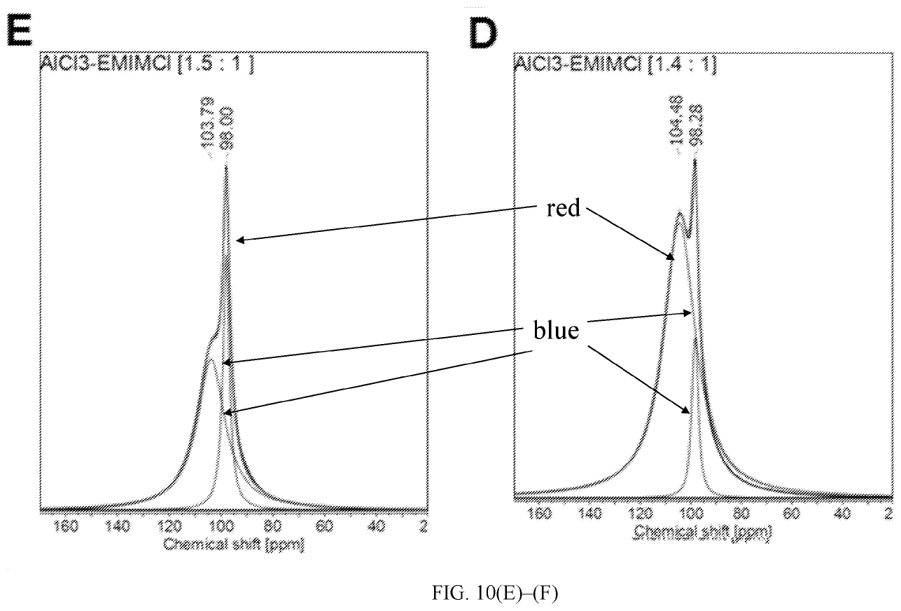

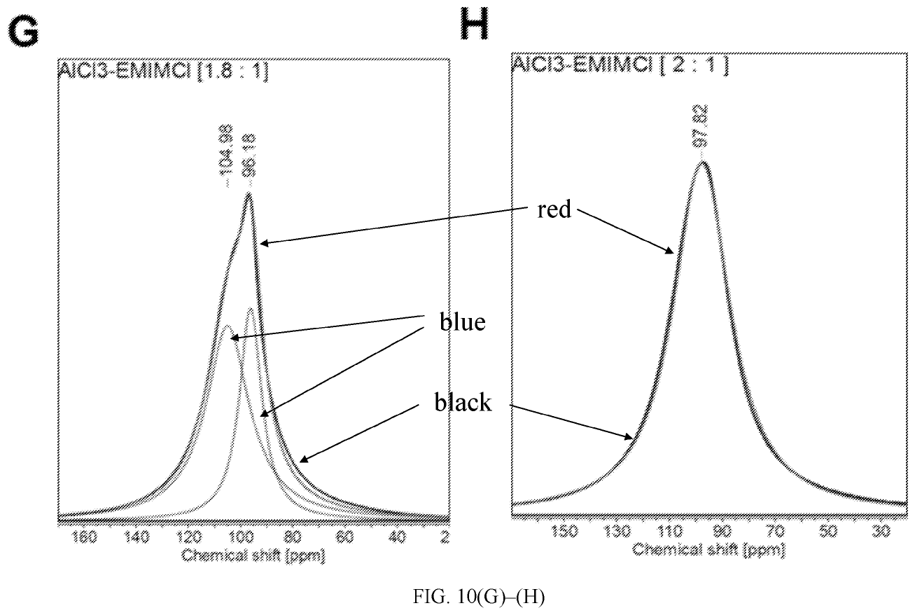

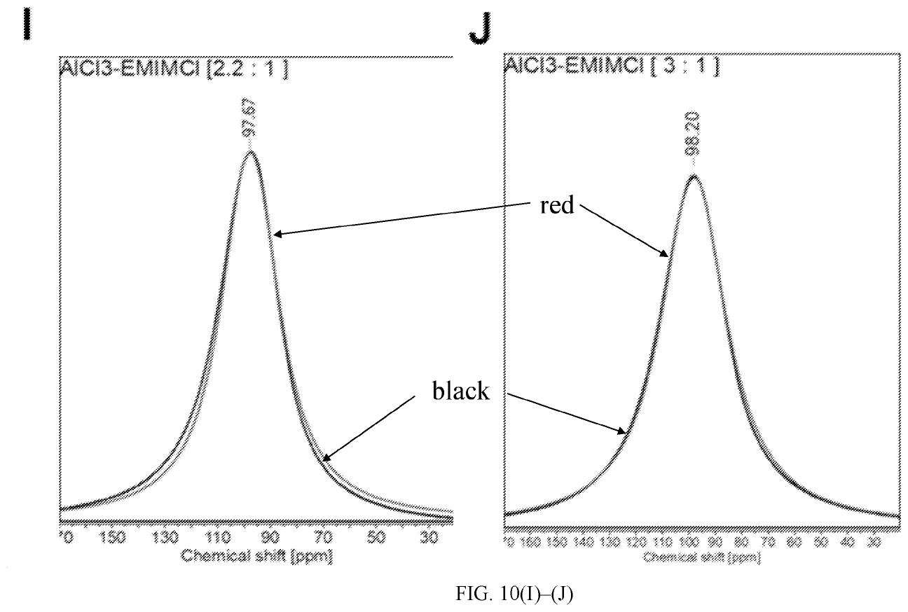

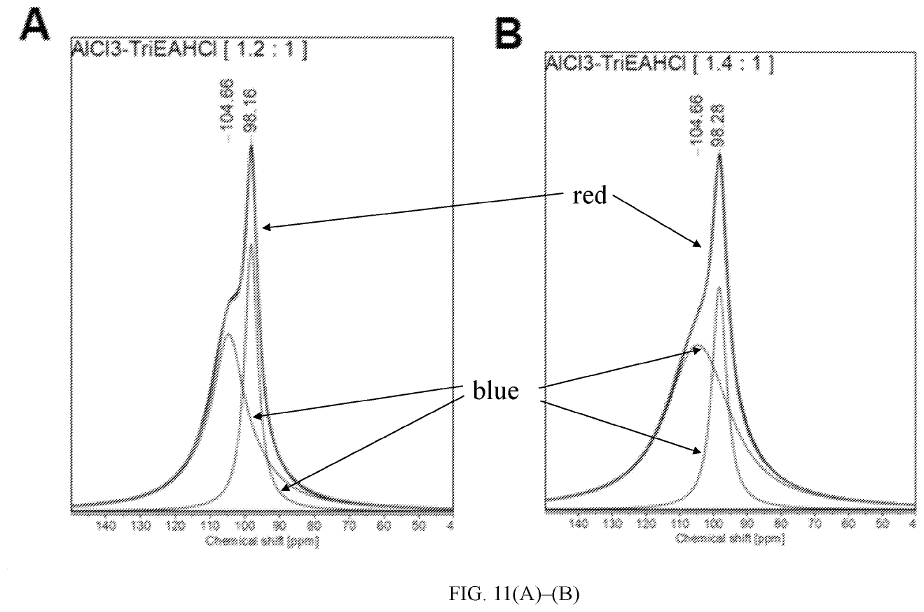

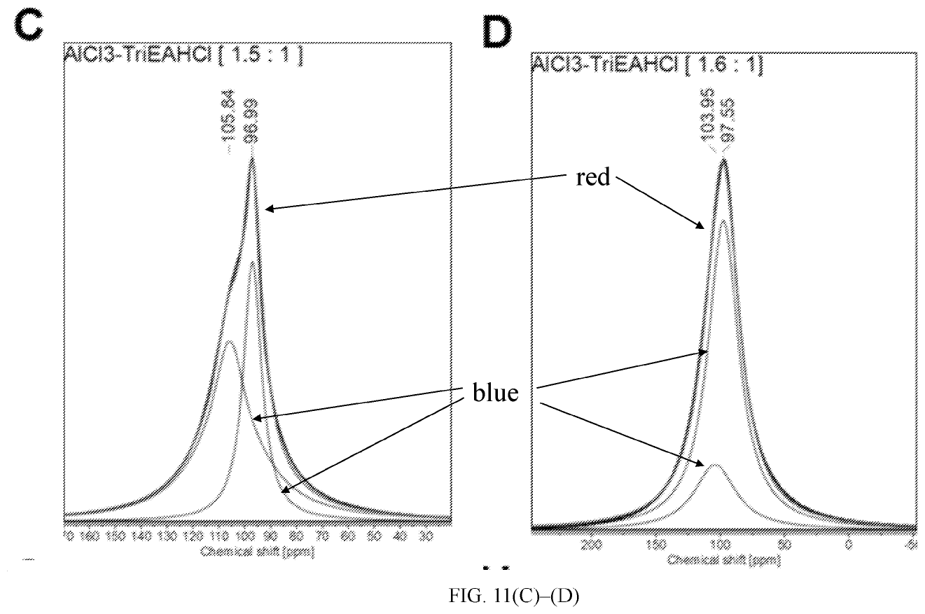

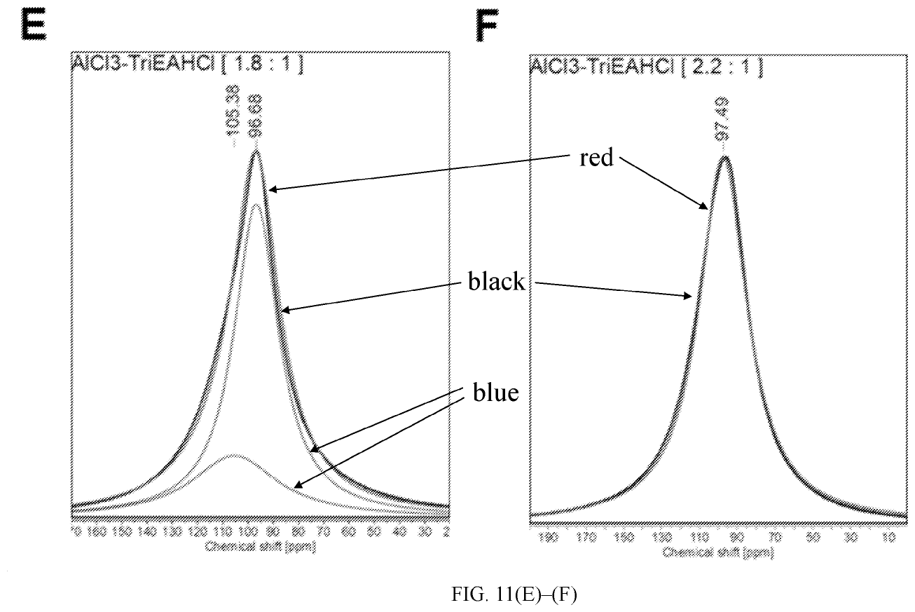

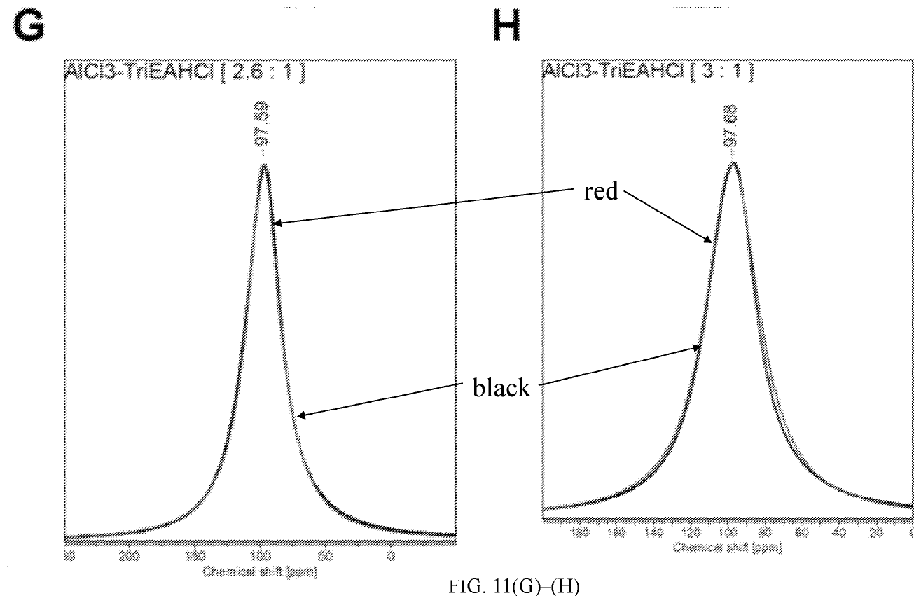

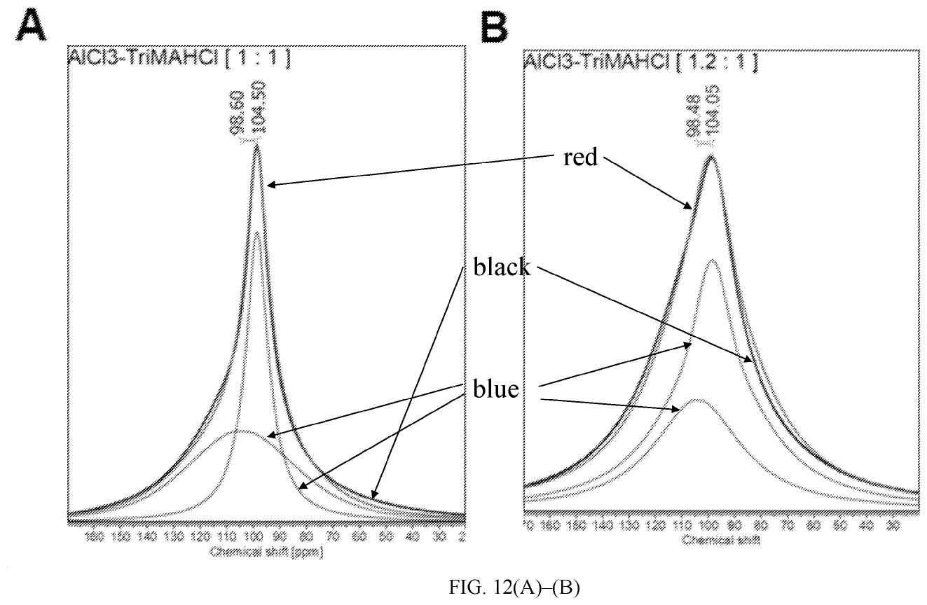

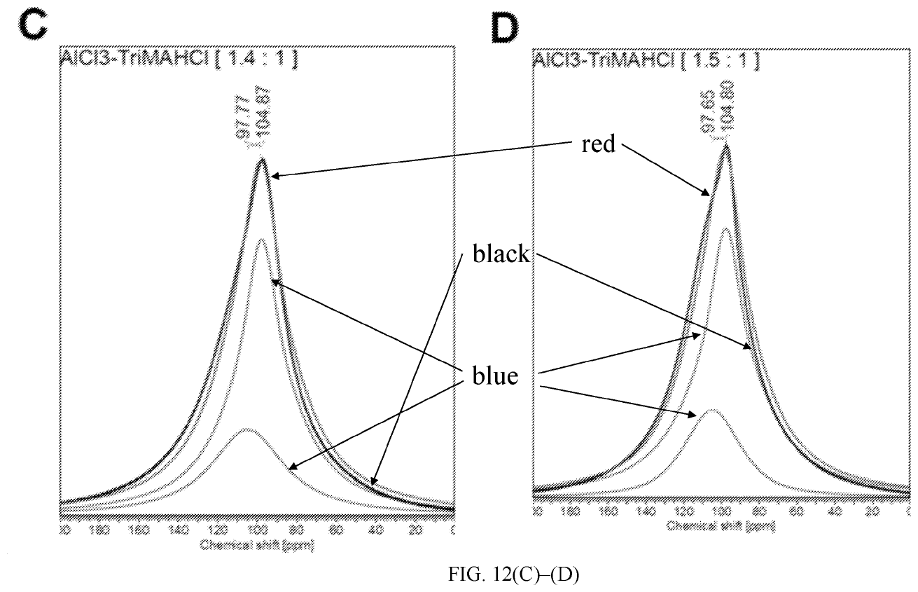

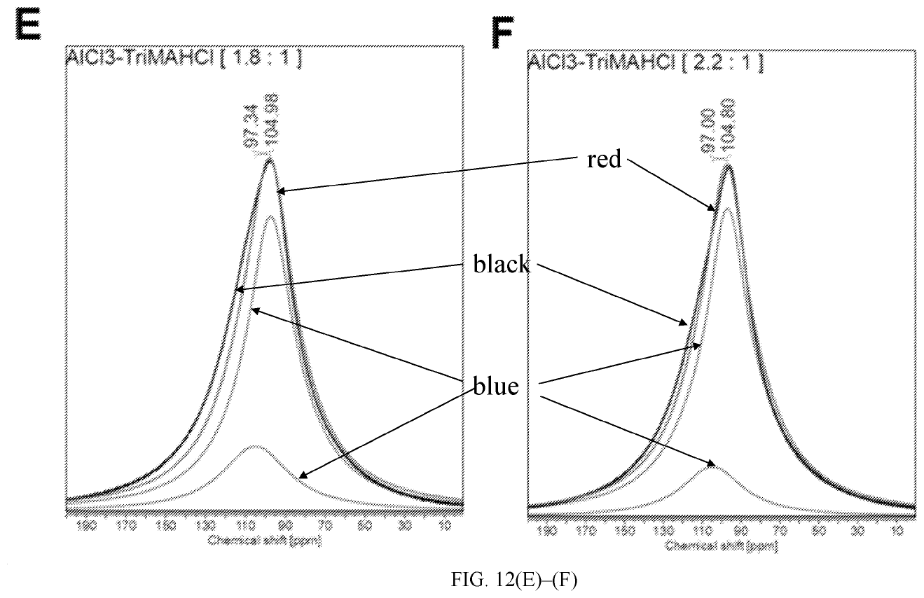

We next interrogated the solvation species in the ammonium-based and imidazolium-based IL electrolytes using ²⁷Al NMR from chemical shifts; 103.8±2.0 ppm for AlCl₄⁻, and 97.5±1.0 ppm for Al₂Cl₇⁻ (FIGS. 10-12). There was no detectable concentration of Al₃Cl₁₀⁻ species, 81 ppm throughout the entire AlCl₃ concentration range evaluated in this work. The spectra were fitted to quantitatively compare the relative concentration of the anionic solvation species for each sample that form molten salts at room temperature (FIG. 3). Both TriMAHCl and TriEAHCl systems exhibited the same aluminum anion species as the AlCl₃-EMIMCl system. Nevertheless, the ratio of each species in the electrolytes varies for each system, especially for the TriMAHCl system. FIG. 3A, B show that from the range at which the EMIMCl and TriEAHCl systems form a molten salt, there is a wide range of AlCl₄⁻ and Al₂Cl₇⁻ concentrations that can be attained by varying the AlCl₃ mole fraction. These observations are consistent with previous ²⁷Al NMR studies of AlCl₃-EMIMCl electrolytes. In contrast, FIG. 3C shows that the majority of the molten salts formed in the TriMAHCl system have Al₂Cl₇⁻ as the majority species (≥64%), i.e., all acidic.

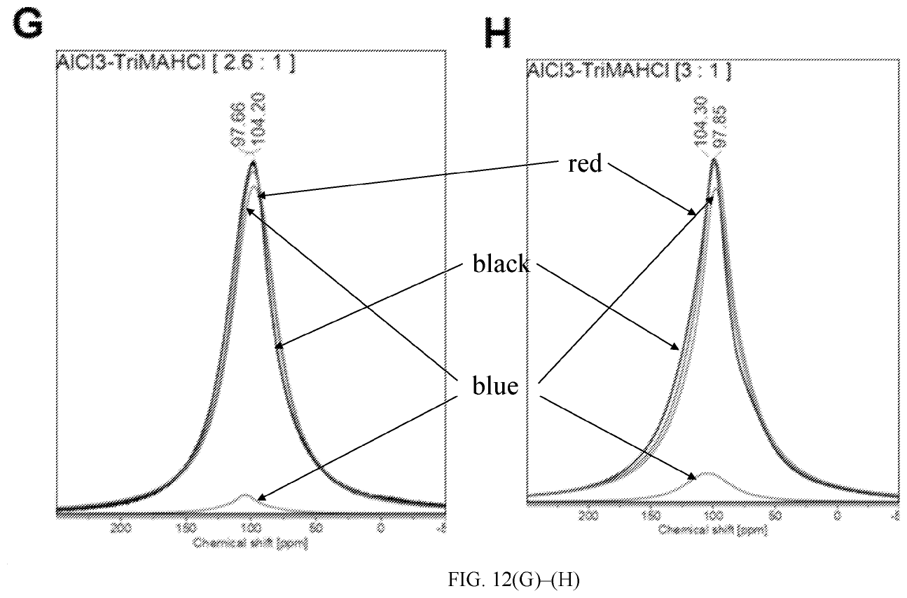

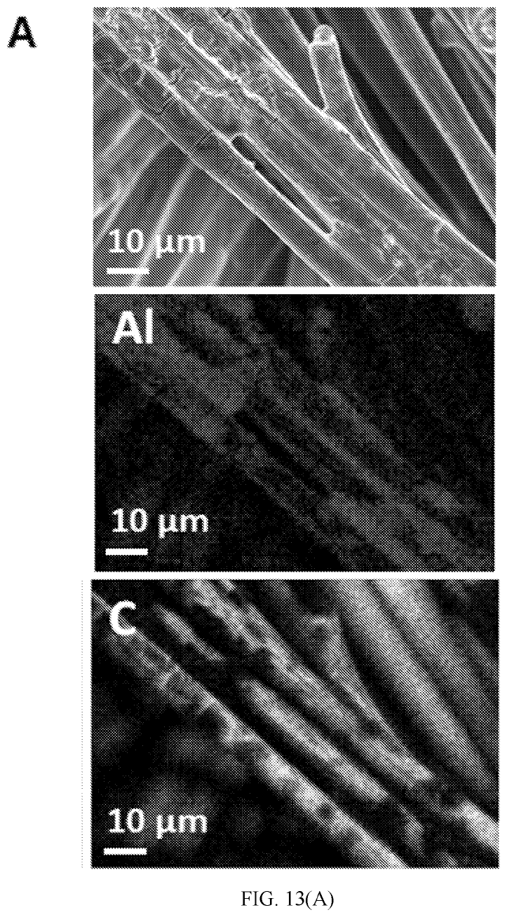

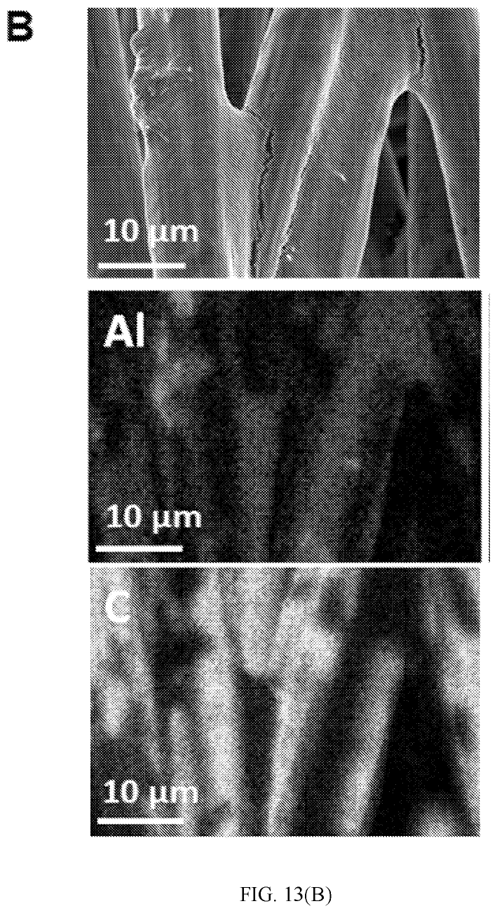

One of the critical challenges in developing rechargeable Al batteries is the limited number of electrolytes that enable reversible Al plating/stripping at room temperature. We investigated the reversibility of Al in TriMAHCl and TriEAHCl electrolytes using galvanostatic experiments in which Al was deposited on a conductive fibrillar carbon substrate. The carbon 3D-electrode architecture was chosen since it has been demonstrated to facilitate electron transport and promote strong oxygen-mediated chemical bonding between Al deposits and the carbon substrate, facilitating control of deposition morphology and limiting out-of-plane Al growth in imidazolium-based electrolytes. Scanning electron microscopy (SEM) and energy dispersive spectroscopy (EDS) analysis of the substrate were conducted to study the chemistry of the electrodeposits. From the EDS elemental maps (FIG. 13), it is evident that conformal coatings composed of Al is formed in the fibres of the carbon substrate for all systems. This finding is in agreement with the morphology observed in a prior study using 1.3:1 AlCl₃-EMIMCl.

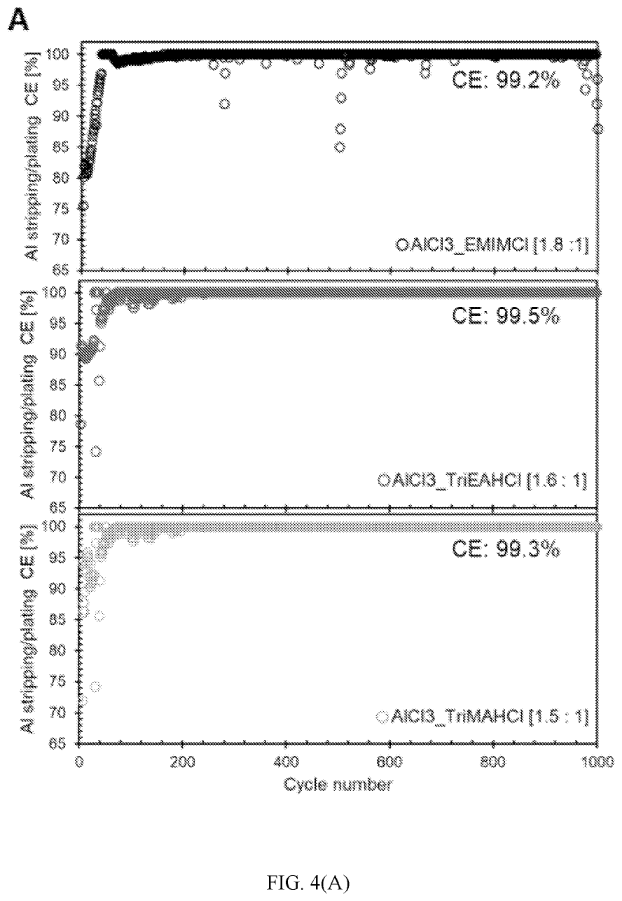

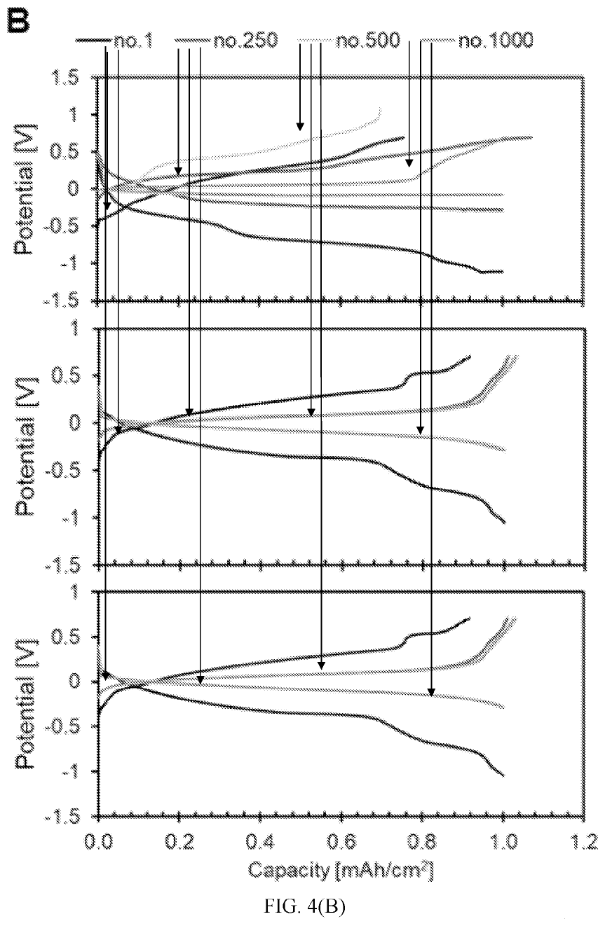

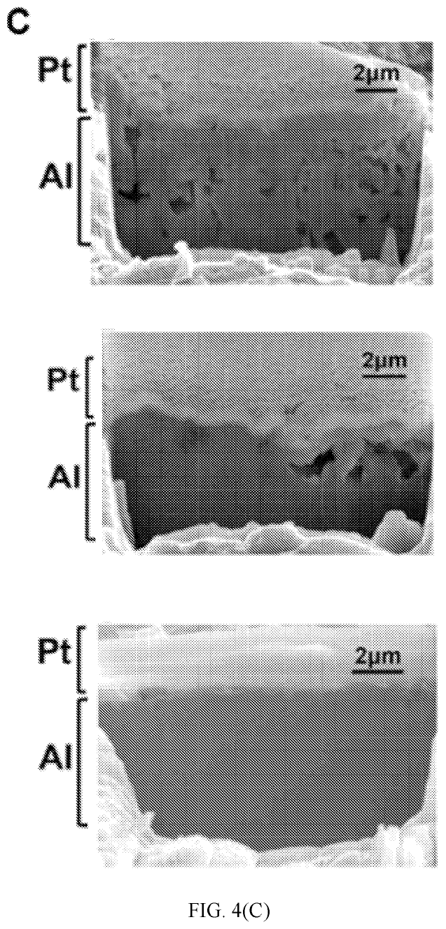

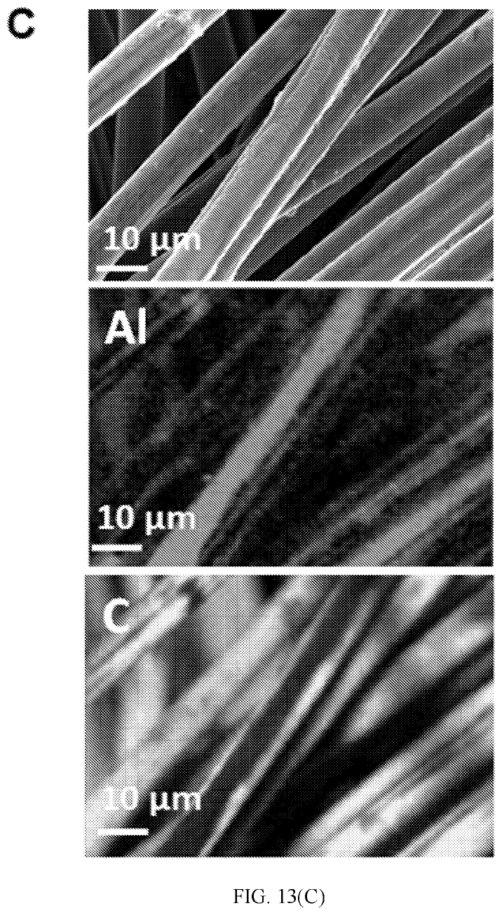

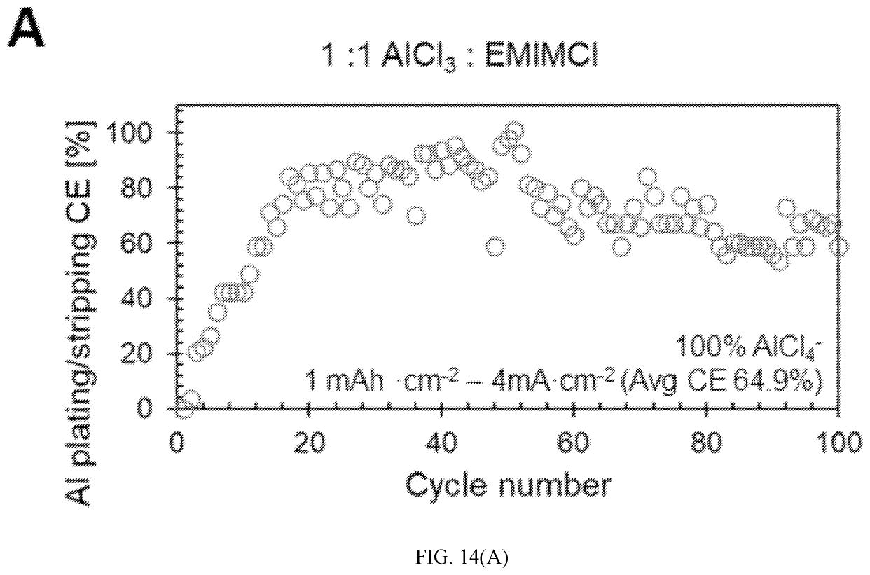

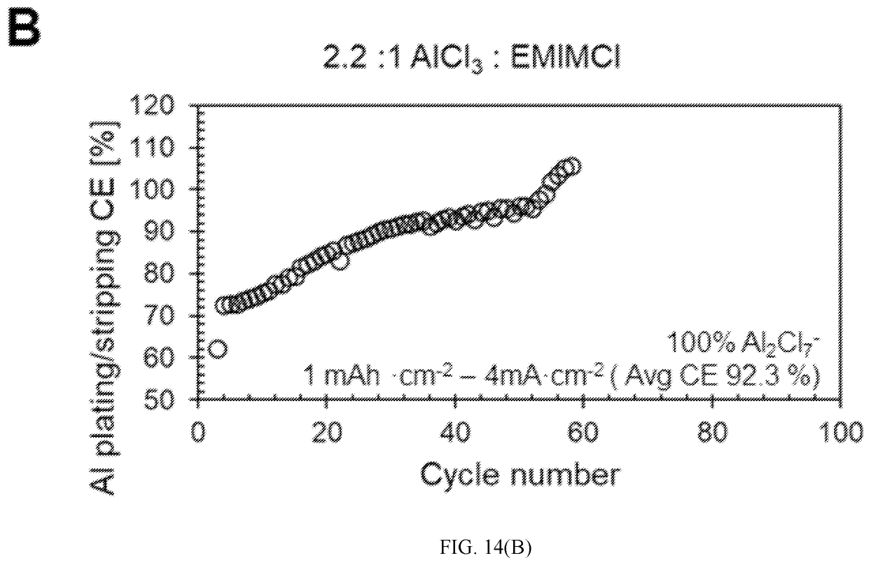

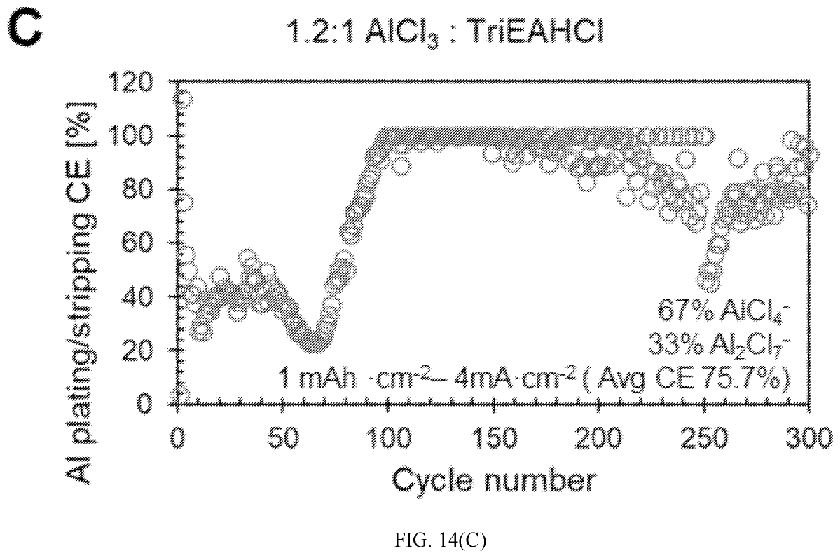

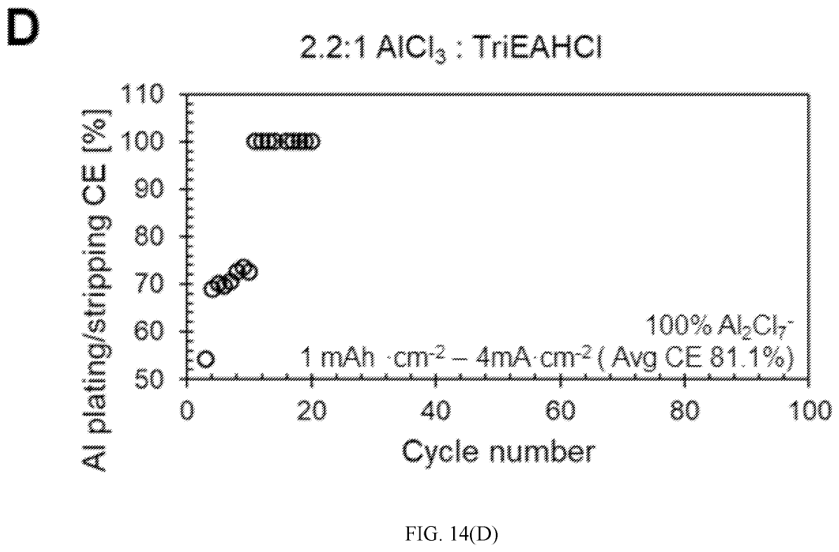

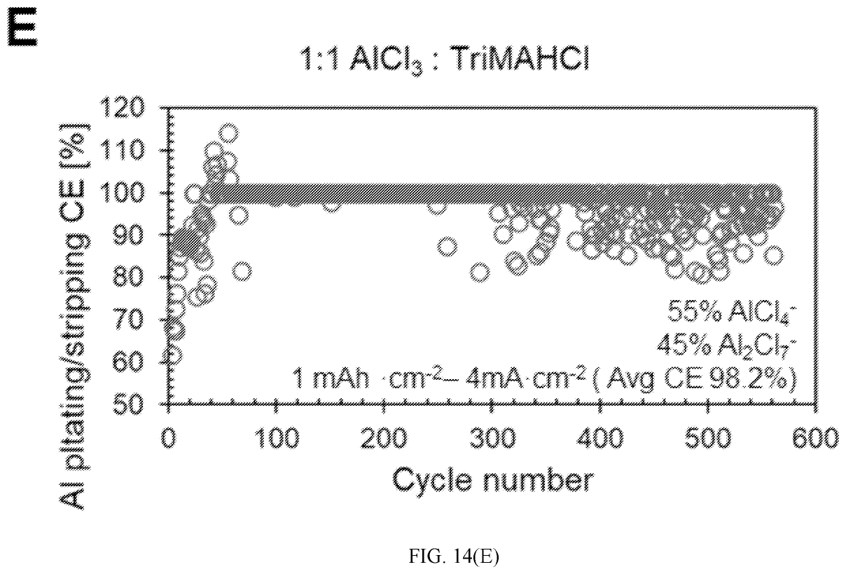

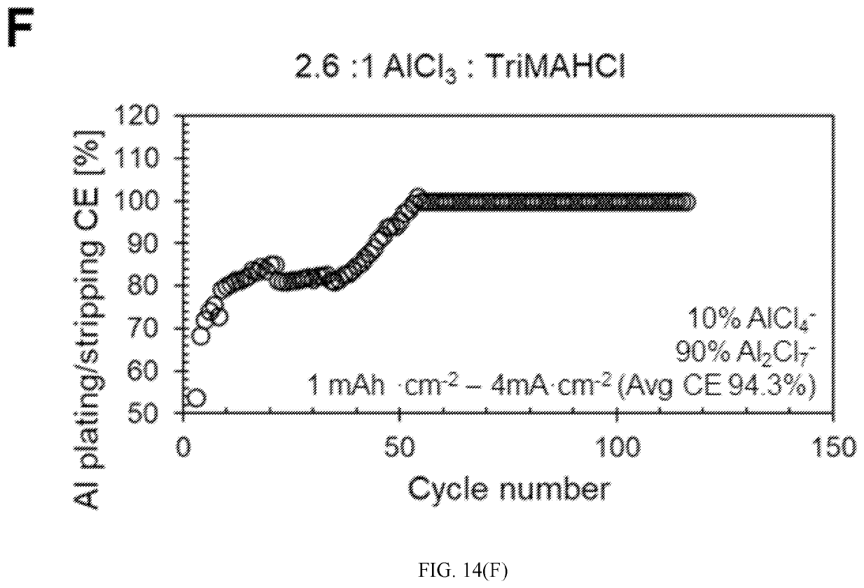

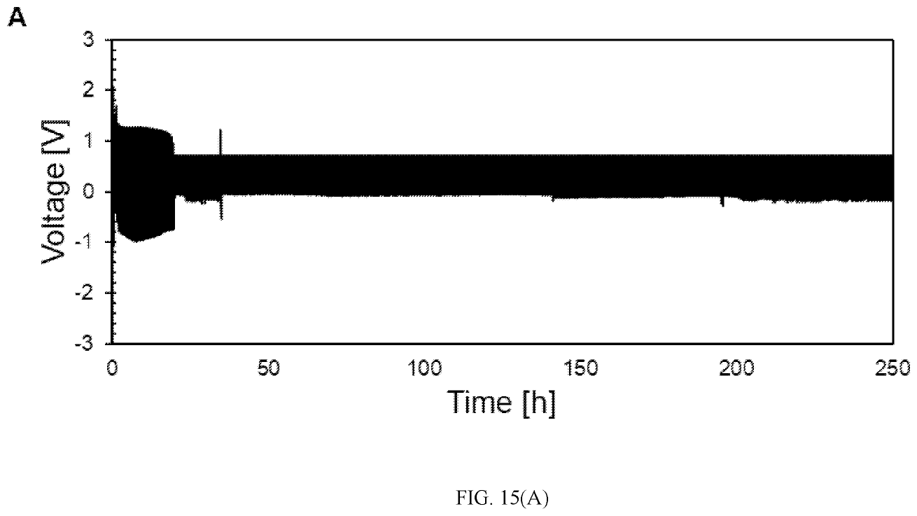

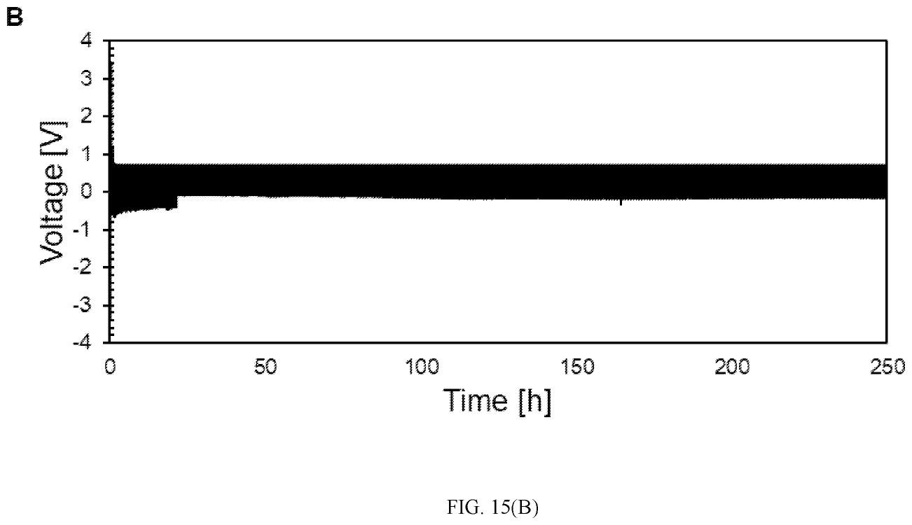

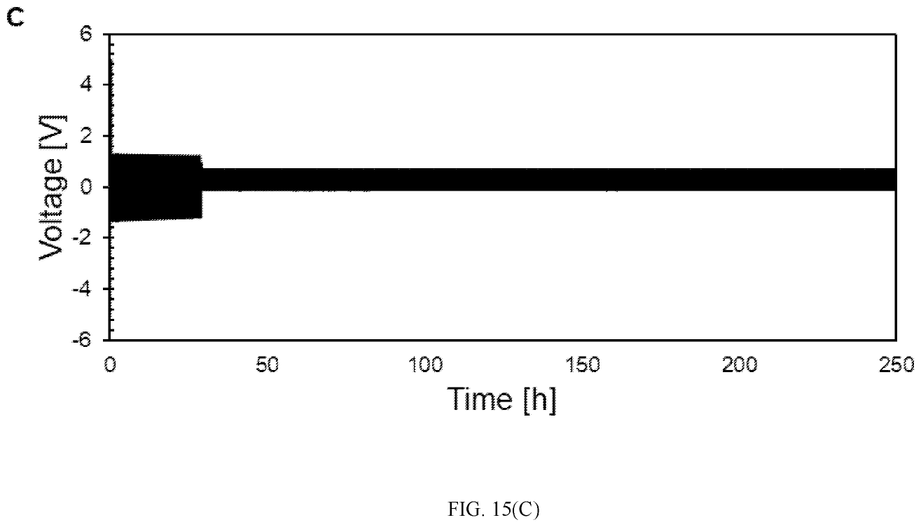

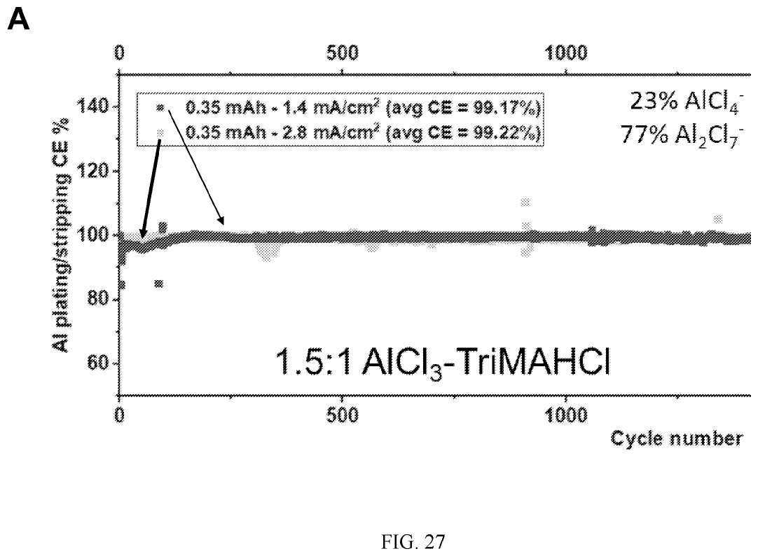

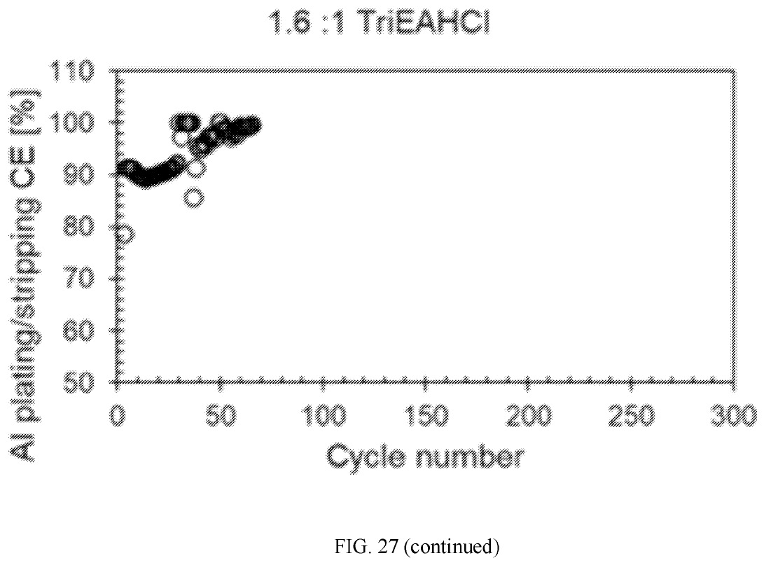

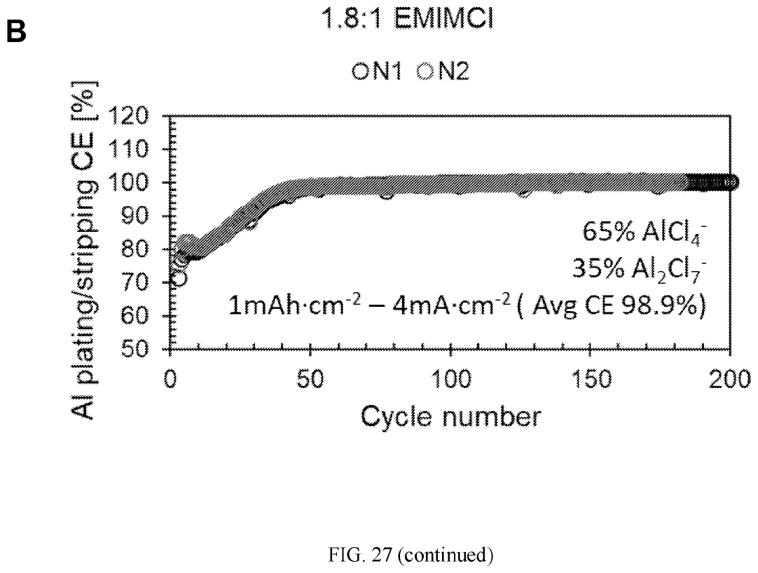

The confirmation of Al electrodeposits in the proposed systems combined with the knowledge gained via NMR spectroscopy enables detailed investigation of the electrolyte features responsible for the observed reversibility, by simply varying the AlCl₄⁻ and Al₂Cl₇⁻ concentration. Prior studies reported that acidic AlCl₃-EMIMCl melts (i.e., melts in which AlCl₃ is added in excess of the EMIMCl, and for which the dominant species is Al₂Cl₇⁻) are responsible for the reversible Al deposition according to the reaction 4 Al₂Cl₇⁻+3 e−↔Al+7 AlCl₄⁻. Al plating/stripping Coulombic efficiency (reversibility) was measured by performing galvanostatic tests on carbon 3D-electrode substrates using selected compositions of each electrolyte system. The CE of each system quantifies the percentage of Al metal that can be stripped from the Al originally plated. In these studies, three concentrations were chosen for each electrolyte; one with AlCl₄⁻ as the dominant species, one with the Al₂Cl₇⁻ as the dominant species, and a third that consisted of a mixture of both anionic species. The electrolytes with a mixture of both anionic species, especially those with a higher concentration of Al₂Cl₇⁻ (FIG. 4), showed higher reversibility for all electrolytes (FIG. 14, FIG. 27, and Table 2). It is noteworthy that the AlCl₃-EMIMCl mixture containing approximately 65% of AlCl₄⁻ and 35% Al₂Cl₇⁻, compared favorably to those, respectively, containing 22% and 23% of AlCl₄⁻ and 78% and 77% of Al₂Cl₇⁻ for the TriEAHCl and TriMAHCl mixtures. The Al plating/stripping coulombic efficiencies (CE) measured were 99.2%, 99.5% and 99.3%, for 1.8:1 AlCl₃-EMIMCl, 1.6:1 AlCl₃-TriEAHCl, and 1.5:1 AlCl₃-TriMAHCl, respectively, at 1 mAh·cm⁻² areal capacity and 4 mA·cm⁻² current density for 1,000 cycles. Interestingly, we observed that these modest changes in CE are accompanied by quite large differences in cell polarization and morphology of the electrodeposited Al. The voltage profiles in FIG. 4B reveal more stable Al stripping/plating reaction for the TriEAHCl and TriMAHCl electrolytes by a reduced overpotential that remains constant from cycles ˜50-1000, compared to the EMIMCl electrolyte. Comparable behavior was observed in Al symmetric cells (FIG. 15). The increase in coulombic efficiency and narrowing of the overpotential over the first 50 cycles will be explained in detail in the next section via surface chemistry analyses via X-ray photoelectron spectroscopy (XPS).

Representative SEM analysis on FIB-cut cross-sections of the electrodeposited Al confirmed the presence of voids near the surface and within the bulk of the anode for the EMIMCl electrolyte (FIG. 4C). Evidence of voids and pitting are apparent near the surface of the electrodeposited Al in the TriEAHCl. In contrast, electrodeposited Al harvested from the TriMAHCl electrolyte forms as a dense layer throughout the bulk and near the surface of the anode. Multiple areas in all electrolytes were examined to confirm that these observations are in fact quite general. Our results therefore show that ammonium-based electrolytes composed of a mixture of AlCl₄—and Al₂Cl₇⁻, with Al₂Cl₇⁻ as the moderate majority (≥70%) ionic species, facilitate higher reversibility of Al and formation of deposits with planar, dense morphologies. The mixtures with the dominant species of either AlCl₄⁻ or Al₂Cl₇⁻ (>65% of AlCl₄⁻ or ≥90% of Al₂Cl₇⁻) comparatively underperformed in Al plating/stripping reversibility (FIG. 14). The mixtures with a predominantly higher concentration of AlCl₄⁻ showed poor reversibility, with average CE values ranging from 64.9 to 75.7% (FIG. 14)(A) and (C)).

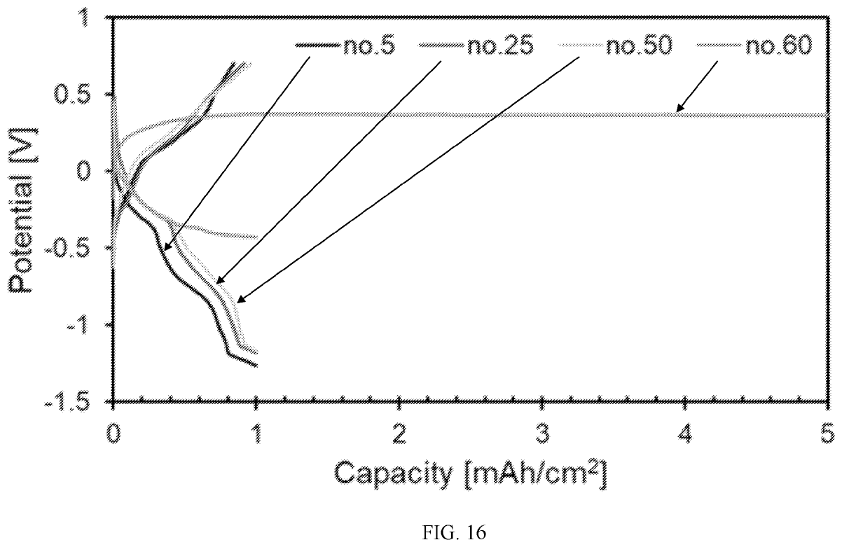

This is a direct result of the inherent irreversibility of the predominant electrodeposition process in neutral melts: AlCl₄⁻+3 e−↔Al+4 Cl⁻. As the Al₂Cl₇⁻ concentration increases, the Lewis acidity of the electrolytes increases. Thus, a higher Lewis acidity corresponds to a higher affinity from the electrolytes to accept a pair of electrons and form a coordinate covalent bond, resulting in electrochemical corrosion of the metal parts in the cell. This phenomenon was observed in highly acidic electrolytes (Al₂Cl₇⁻≥90%), where the charging step would extend for overly long periods, indicative of a faradaic process occurring, as seen in (FIG. 16). Although the CE values appeared to be higher than the mixtures with high AlCl₄⁻ concentration, upon closer examination of the potential curves, electrochemical corrosion after tens of cycles was identified as the controlling process occurring within the cell.

Although the AlCl₄⁻ ion cannot be reduced directly at the electrode to form Al, it can affect the Al electrodeposition process through a dissociation reaction: 2 AlCl₄⁻↔Al₂Cl₇⁻+Cl⁻. In turn, the reduction of Al₂Cl₇⁻ leads to aluminum deposition according to the reaction: 4 Al₂Cl₇⁻+3e−↔Al+7 AlCl₄⁻. A key remaining question concern the effect of the electrolyte composition on physicochemical and transport properties. The conductivity of a material is a measure of the available charge carriers and their mobility. Ionic liquids composed entirely of ions would be expected to have high ionic conductivity values. However, ion-pairing and/or ion aggregation commonly decrease the number of available charge carriers. Prior work from Fannin et al. reported ionic conductivity values at room temperature for the AlCl₃-EMIMCl system; the basic concentrations with a value of ˜6.5 mS·cm⁻¹ (presence of Cl—and AlCl₄⁻ anions), neutral with a value of ˜23.0 mS·cm⁻¹ (presence of AlCl₄⁻ anions), and acidic concentrations with a value of ˜15.0 mS·cm⁻¹ (presence of AlCl₄⁻ and Al₂Cl₇⁻ anions). We measured the ionic conductivity of electrolytes used in the study using a dielectric spectrometer with a temperature controller incorporated. The values measured for the EMIMCl electrolytes followed the expected trend: the neutral concentration exhibited the highest conductivity, followed by acidic concentrations, and a lower conductivity for the only basic concentration considered in this work. Both TriMAHCl and TriEAHCl electrolyte mixtures with a high concentration of AlCl₄⁻ presented the highest conductivity values and a decrease as the concentration of Al₂Cl₇⁻ increased per ²⁷Al quant-NMR analysis. The TriMAHCl mixtures having Al₂Cl₇⁻ as the majority species (≥64%) exhibited lower conductivity values (4-21 mS·cm⁻¹) compared to the TriEAHCl mixtures (12-37 mS·cm⁻¹). Even though the large ion size from the triethylammonium cation would be expected to reduce ion mobility even further than a trimethylammonium cation, the decrease in the number of available charge carriers via the AlCl₄⁻ dissociation reaction dominates.

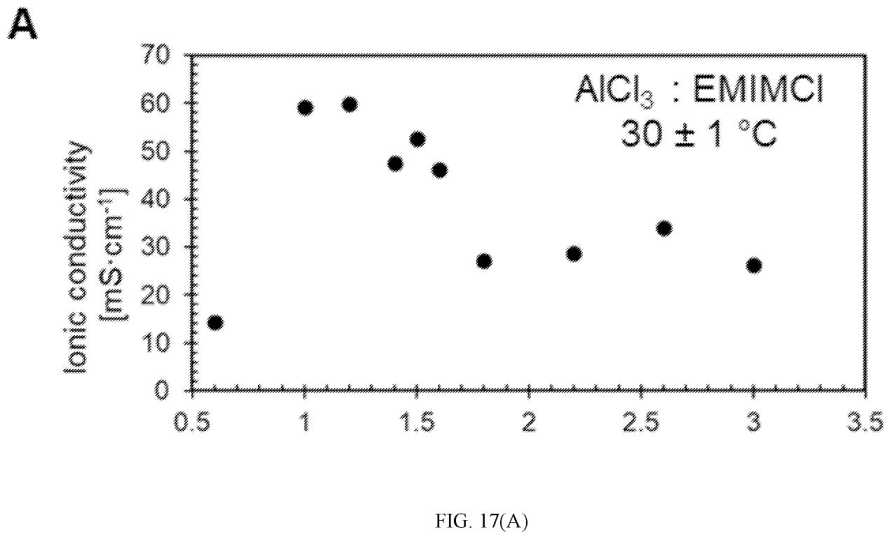

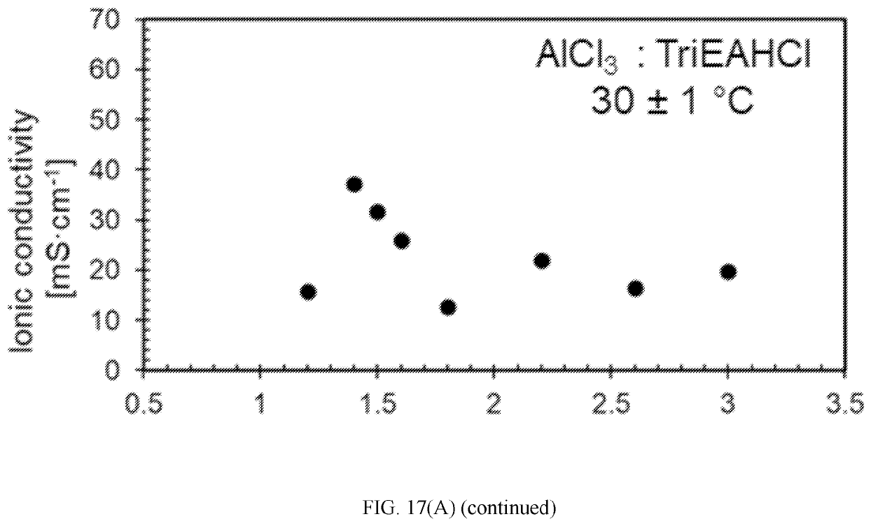

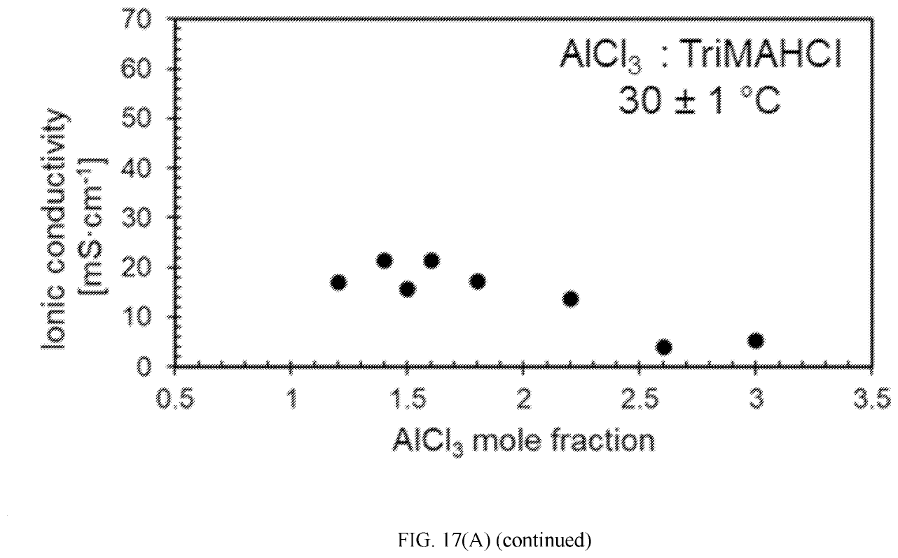

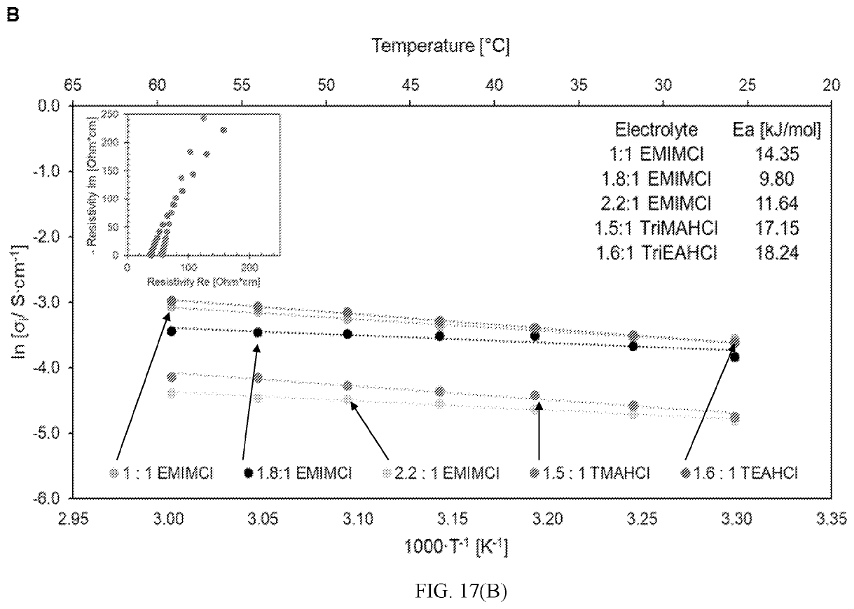

The observed temperature-dependent conductivity behavior exhibited a classical linear Arrhenius behavior above room temperature (FIG. 17), as observed in most ionic liquids. Generally, as the ionic liquids approach their glass transition temperatures, the conductivity displays a significant negative deviation from linear behavior, consistent with glass-forming liquids, best described using the empirical Vogel-Tammann-Fulcher (VTF) equation. In the temperature range evaluated, the linear behavior may be explained by postulating the onset of an ionic solid-like conductance mechanism. Thus, there may occur a process where fluctuations in configurational entropy determine the relaxation time, and a process where individual ions undergo successive displacement in a semirigid lattice. Both processes contribute to the conductance and hence to the slope of the ln σ vs. 1000·T⁻¹ line, i.e., the activation energy.

The activation energy for AlCl₄⁻ and Al₂Cl₇⁻ conduction through the AlCl₃-EMIMCl electrolytes varied based on the ions present in each mixture and their relative concentration. The electrolyte mixture with a 65% AlCl₄⁻ and 35% Al₂Cl₇⁻ showed the lowest activation energy (9.80 kJ·mol⁻¹) compared to the mixtures with AlCl₄⁻ as the majority species or the Al₂Cl₇⁻ as the majority species (14.35 and 11.64 kJ·mol⁻¹, respectively) in the AlCl₃-EMIMCl system. Interestingly, the 1.5:1 AlCl₃-TriMAHCl electrolyte that exhibited a dense electrodeposited morphology compared to the rest presented a comparable activation energy for ionic conduction to the 1.6:1 AlCl₃-TriEAHCl electrolyte and higher than the 1.8:1 AlCl₃-EMIMCl electrolyte that exhibited a porous electrodeposited morphology. The activation energies calculated in combination with the ionic conductivities measured indicated that the high reversibility for plating and stripping is not a result of the ionic transport within the electrolyte but point out that it may be an interfacial-controlled phenomenon.

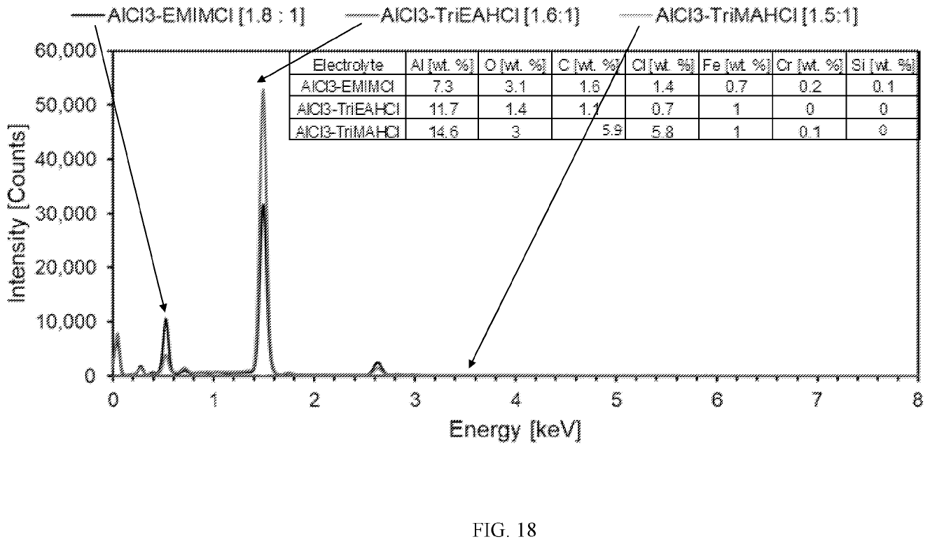

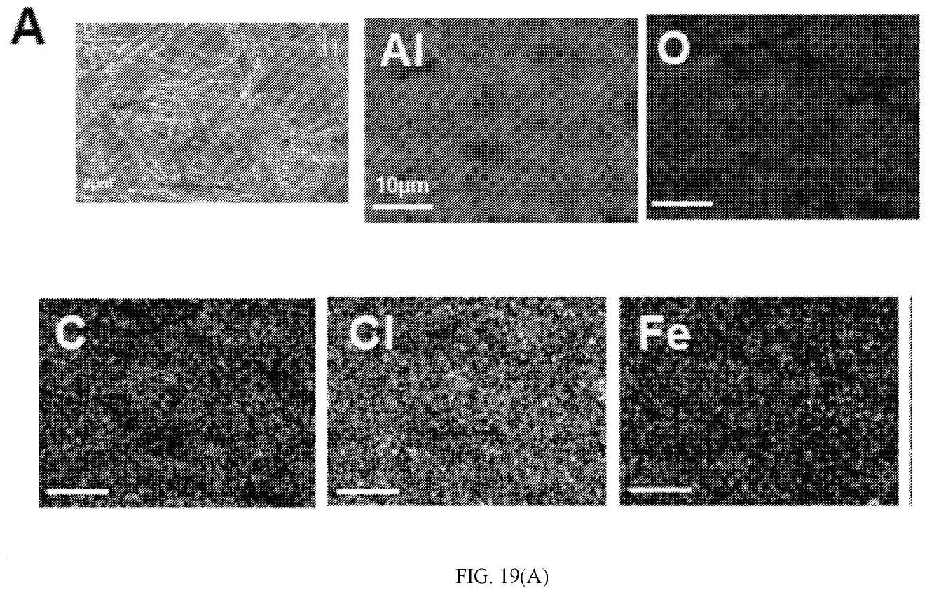

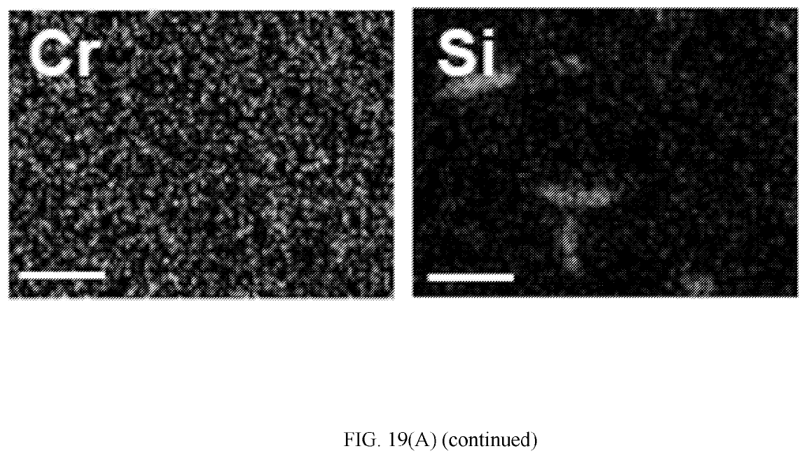

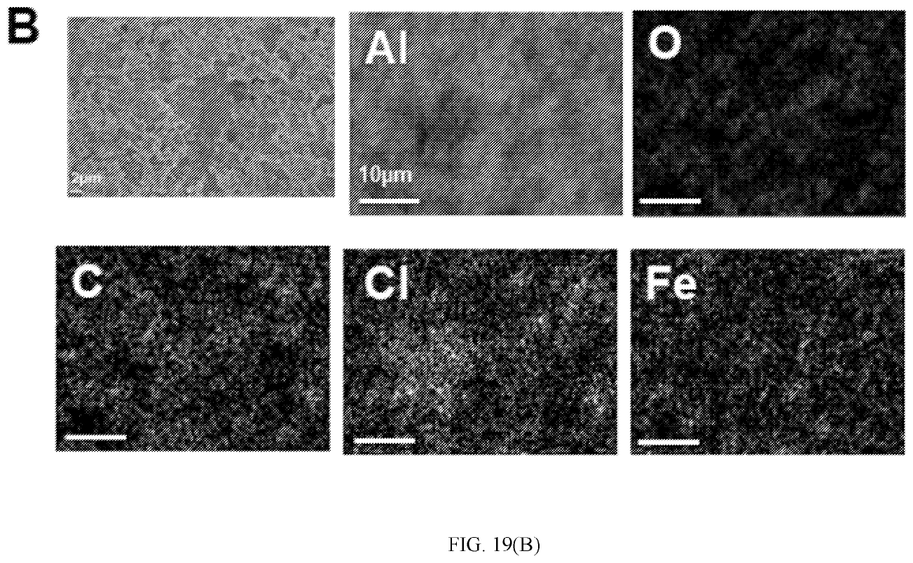

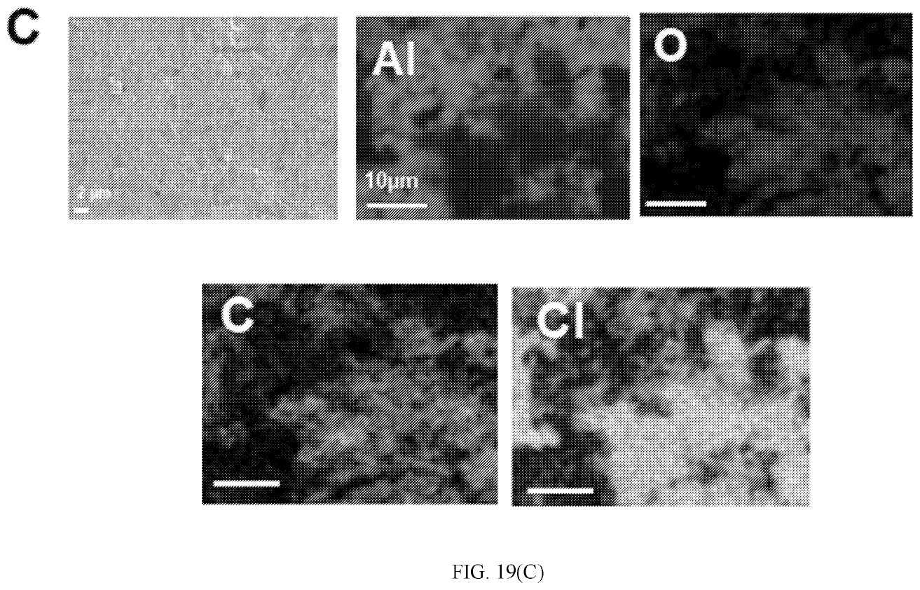

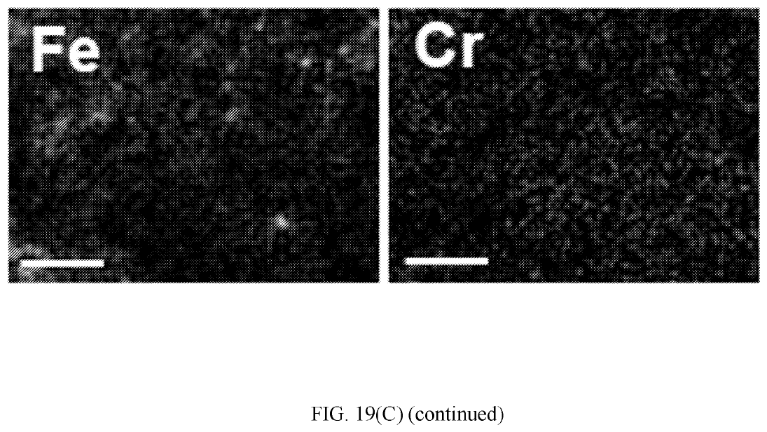

Progress in developing practical Al batteries has been hindered by multiple challenges associated with slow interfacial charge transport and sluggish electrochemical reactions at both the anode and the cathode. Among these challenges, the rapid formation of an irreversible, resistive, passivating Al₂O₃ film on the metal anode is considered the most difficult, because the oxidation reaction is thermodynamically favored, impedes stripping of Al³⁺, and reduces the battery working voltage. Imidazolium-based IL electrolytes have been reported to overcome the anode passivation problem. These electrolytes are believed to etch the passivating layer on the Al anode surface and form a new interfacial layer (solid electrolyte interphase, SEI) that simultaneously protect Al and regulate transport of ions to the electrode. Thus, we interrogated the surface chemistry of the Al anodes after a hundred cycles of Al plating/stripping using SEM-EDS (FIG. 18 and FIG. 19), followed by a more in-depth examination using X-Ray Photoelectron Spectroscopy (XPS).

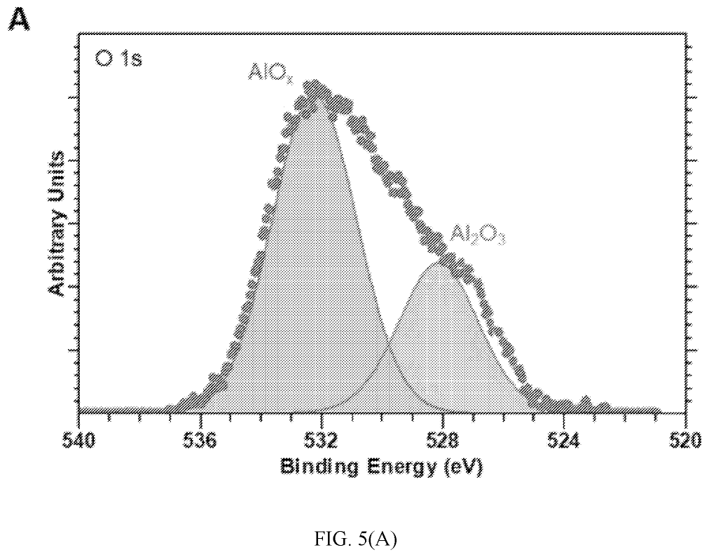

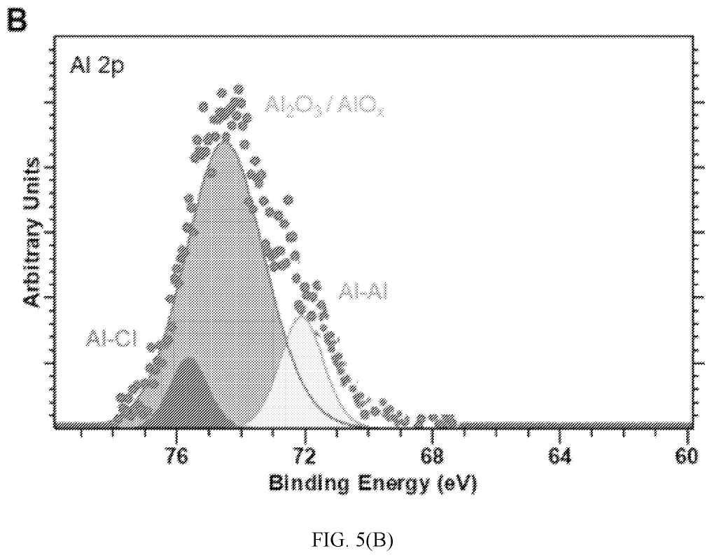

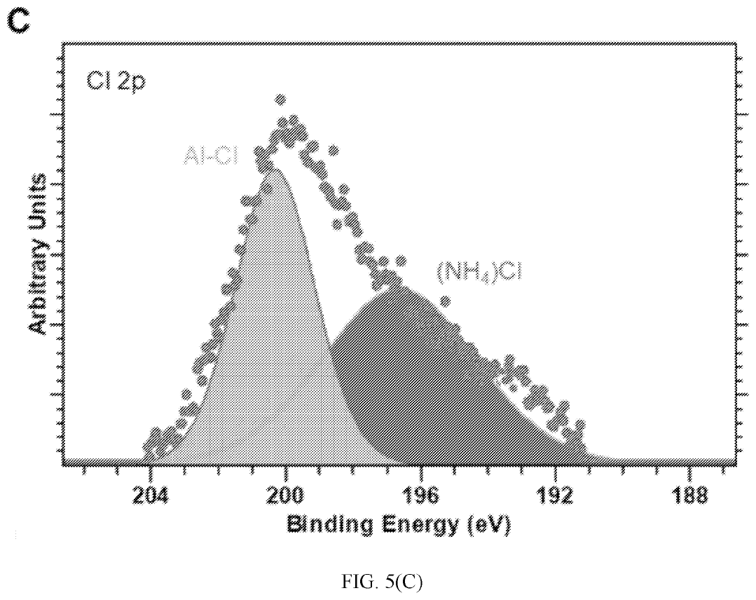

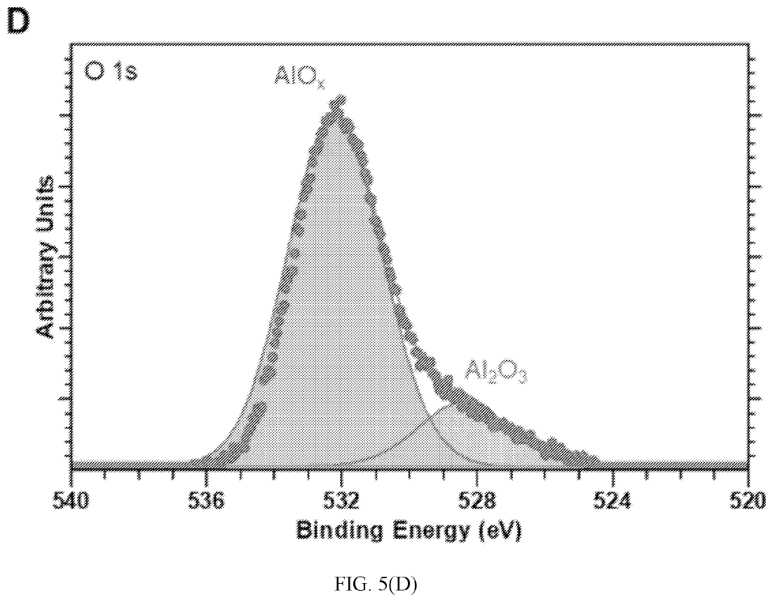

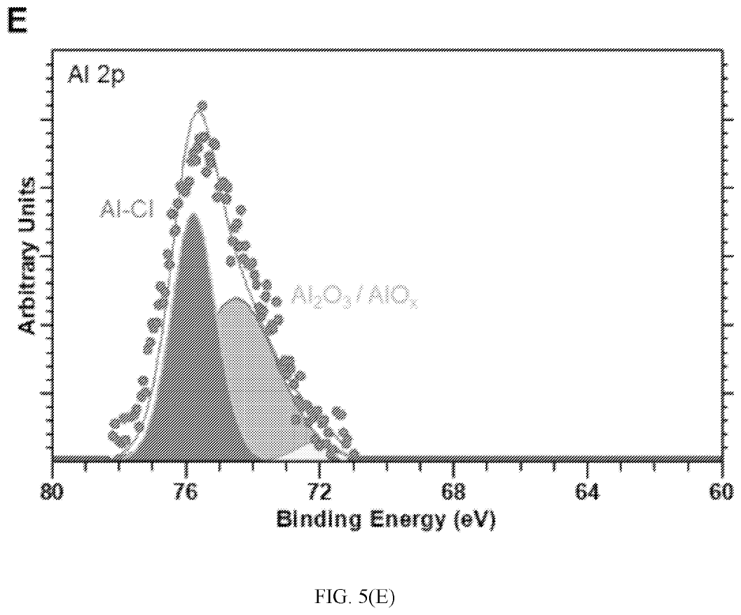

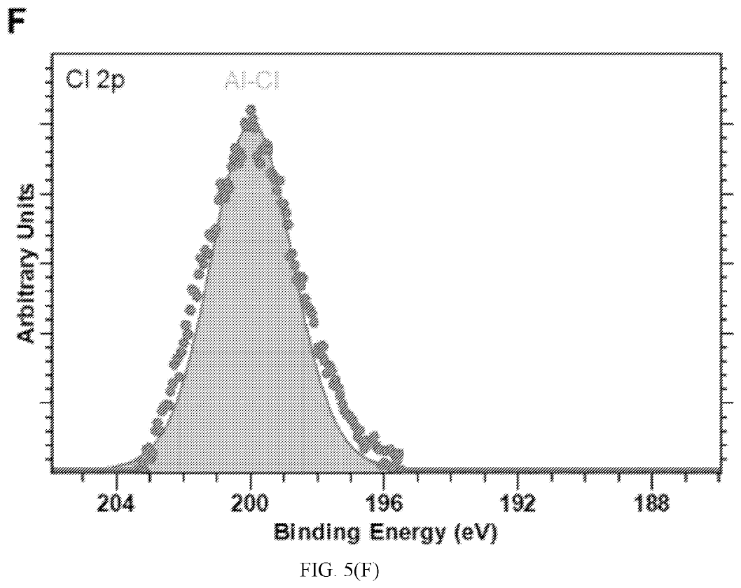

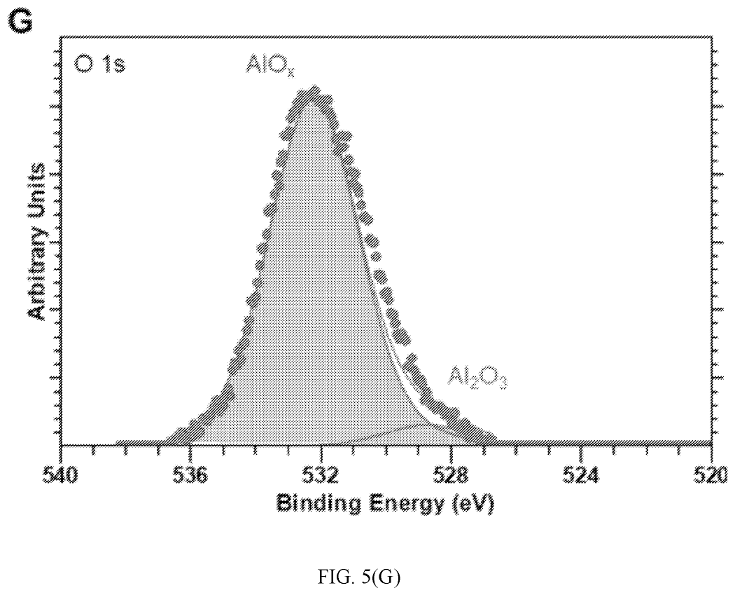

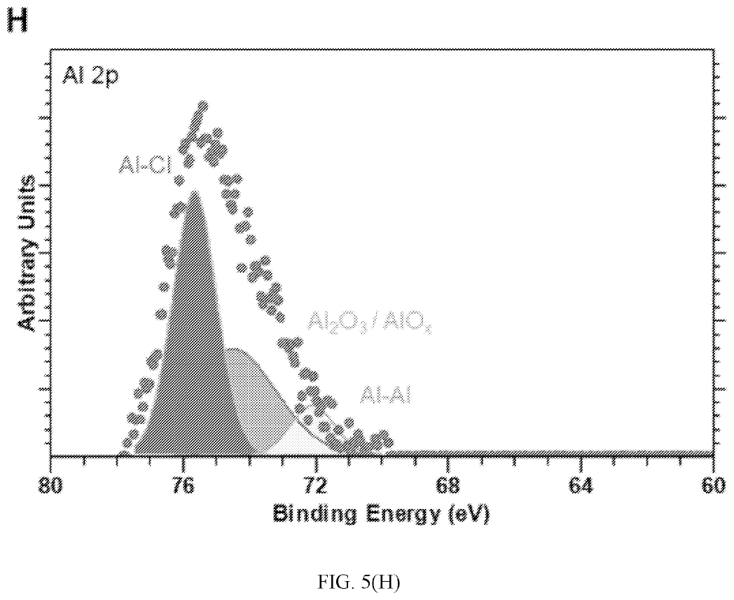

EDS analyses showed that the oxygen content present in the imidazolium-based electrolytes is twice as high as the oxygen present in the ammonium-based electrolytes after 100 cycles of plating and stripping (ending with a plating step), suggesting that etching of the Al₂O₃ layer is favored in the ammonium-based electrolytes. The XPS high-resolution core scans provided insight into the nature of the bonds that each element detected participate in the surface chemistry evolution of the Al anode as the number of cycles increased, going from a lower CE until it stabilized at a higher value (FIG. 5(A-I) and Table 1).

TABLE 1
O 1 s, Al 2 p, and Cl 2 p XPS peak assignments for Al anodes after 5 and 50 cycles,
including one anode after 50 cycles and 127 min. (min(s). = minute(s)) of Ar+ ion sputtering.

| | | | Al anode, cycle no.50 | |
|---|---|---|---|---|
| | | Al anode, | after 127 min of | |
| | Al anode, | cycle no.50 | Ar⁺ ion sputtering | |
| Sample | cycle no.5 | BE | BE | |
| XPS | BE (FWHM) | (FWHM) | (FWHM) | |
| fit | rel. % | rel. % | rel. % | Chemistry |
| O 1 s | 528.1 (3.1) 31 | 528.4 (3.1) 15 | 528.7 (3.1) 5 | Al₂O₃ |
| | 532.2 (3.3) 69 | 532.2 (3.3) 85 | 532.2 (3.3) 95 | AlOx |
| Al 2 p | 74.5 (2.91) 74 | 74.5 (2.91) 53 | 74.5 (3.1) 40 | Al₂O₃/AlOₓ |
| | 72.1 (1.6) 16 | 72.1 (1.6) 4 | 72.1 (1.6) 10 | Al—Al |
| | 75.6 (1.47) 10 | 75.7 (1.57) 43 | 75.6 (1.57) 50 | Al—Cl |
| Cl 2 p | 200.3 (2.8) 47 | 200.0 (2.9) 100 | 200.1 (2.9) 100 | Al—Cl |
| | 196.6 (5.4) 53 | | | (NH₄)Cl |

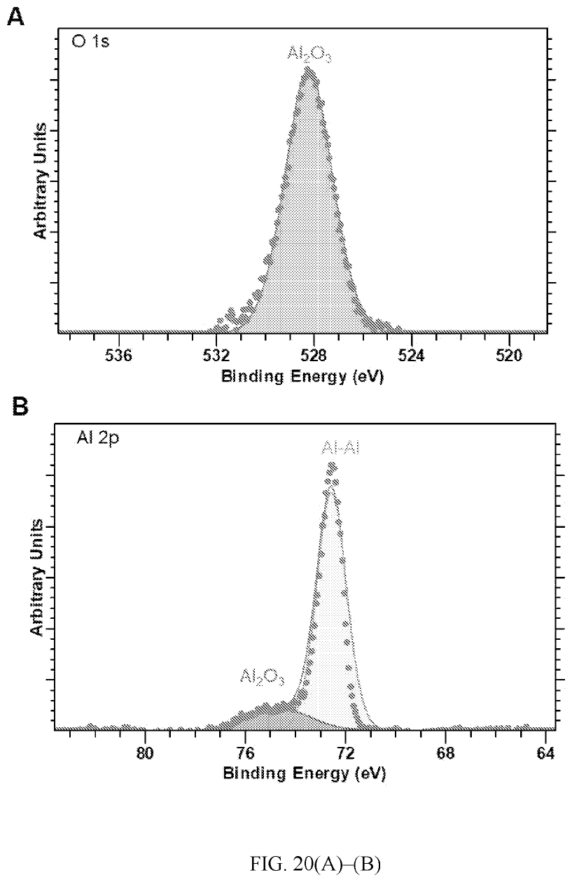

The anodes cycled with the 1.5:1 AlCl₃-TriMAHCl electrolyte were chosen for more in-depth studies since these anodes showed the more planar, dense electrodeposited morphology compared to the other systems. In addition, Al foil as-received was analyzed as a baseline (FIG. 20). High-resolution and depth profiling measurements were performed on Al anodes transferred without air exposure between an Ar-filled glovebox and the ultrahigh vacuum XPS chamber. The O 1s and Al 2p signals reveal a significant difference between the surface layer after galvanostatic cycling in AlCl₃-TriMAHCl electrolyte vs. as-received. The anode surface after 5 cycles of galvanostatic plating and stripping exhibited two chemical environments for both elements. The Cl 2 p signal was also evaluated due to the presence of chloroaluminate species detected via ²⁷Al NMR in the electrolytes. To determine the nature of the bonds of each element, the Al—O—Cl phase diagram was evaluated since it determines the thermodynamically stable phases in this system. The binary/ternary stable phases according to their standard Gibbs free energy of formation energy are Al₂O₃<AlClO<AlCl₃<ClO₂<ClO₃<Cl₂O₇ (−3.427, −2.785, −1.966, −0.353, −0.339, −0.303 eV·atom⁻¹, respectively).

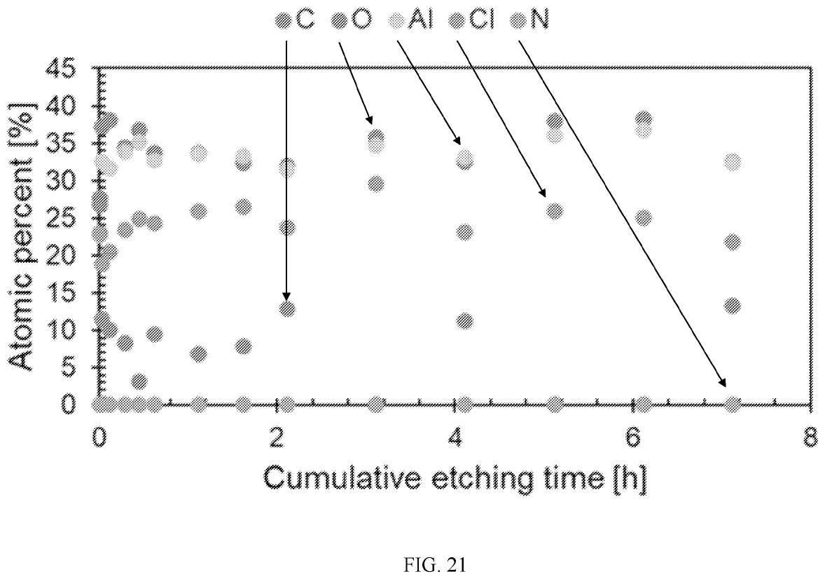

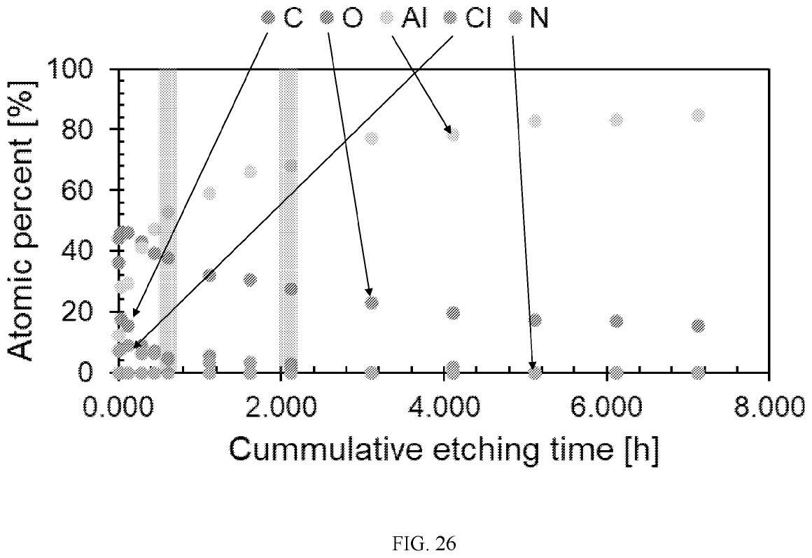

It is reasonable to expect that the phase that will form after etching the alumina phase, will be the one with the most negative standard Gibbs free energy of formation. In this case, AlClO, with an anticipated higher binding energy than the oxide given the Cl higher electronegativity. In addition, the atomic percent measured of each species, especially after >2 h of Ar-sputtering (FIG. 21 and FIG. 26) further confirmed that the higher binding energy bonding environment corresponds to AlClO and not AlCl₃, Al(OH)₃, AlO(OH) or Cl₂ species. The anode surface consists of predominantly AlClO species, while a greater concentration of Al₂O₃ exists on the as-received Al. This suggests that the ammonium-based electrolyte etches part of the Al₂O₃ layer and reacts with the Al anode upon galvanostatic cycling, forming a less resistive compound protecting the Al surface from further oxidation. Even though the resistance of the AlClO layer is not expected to be significantly less electronically resistive than the native Al₂O₃ given their band gaps (5.597 eV vs. 6.044 eV), (32) the ion conduction of chloroaluminate species through the AlClO layer is expected to be favored compared to an Al₂O₃ layer as it was observed through electrochemical impedance spectroscopy (EIS) measurements in Al symmetric cells (FIG. 5 J-K). As assembled, the cell exhibited two constant phase elements; one corresponding to the native Al₂O₃ layer, “SL” for solid layer (capacitance value of 1×10⁻⁶ F, KHz range) and a second one corresponding to the charge transfer resistance between the Al anode and the liquid electrolyte, “Al-LE”, (capacitance value of 12×10⁻⁵ F, Hz—mHz range). The capacitance values obtained through the equivalent circuit modelling for each semi-circle are in good agreement with values for surface layers and sample-electrode interface transport phenomena. Analogously, the EIS spectrum after 50 cycles of cycling (after the CE values have reached its equilibrium value and remain constant onwards), was analyzed using the same equivalent circuit model. However, in this case, the first semi-circle, is attributed to the newly formed AlClO layer (“SEI”) confirmed by survey and high-resolution scans through XPS measurements on the Al anode, showing a significant lower impedance compared to the alumina layer with improved charge transfer impedance. Thus, the beneficial SEI layer in combination with the ease of charge exchange at the interface facilitates the kinetics of the electrodeposition process at the electrode-electrolyte interface, resulting in a more planar, dense electrodeposited morphology.

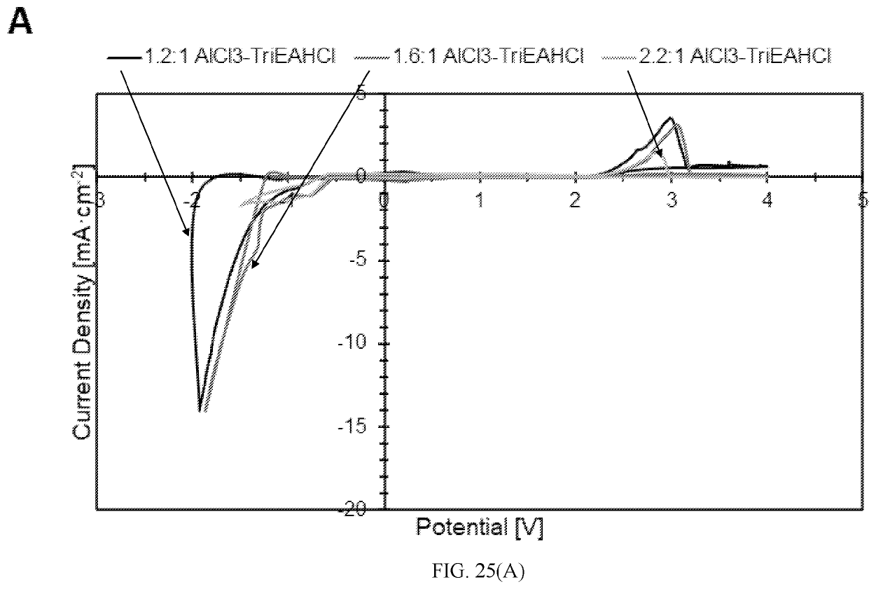

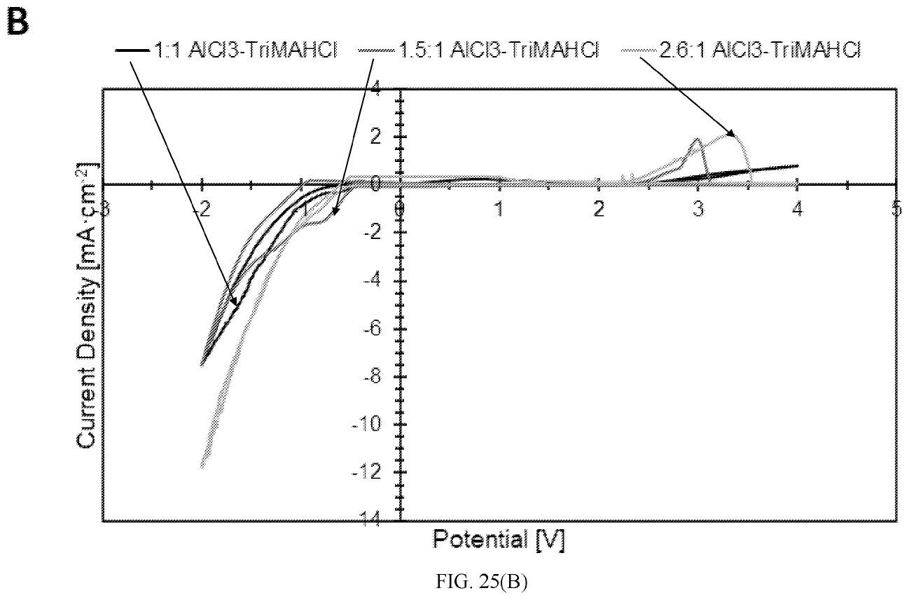

The anodes collected after 50 cycles of galvanostatic plating/stripping were analyzed before and after ˜2 h of Ar-sputtering (˜170 nm deep from the surface), (FIG. 5 D-F, and G-I). After 50 cycles, the CE reached its highest value and remained roughly constant. The amount of Al₂O₃ present at the surface was lower, while the AlClO increased, consistent with the signals observed in the O 1s, Al 2p and Cl 2p core levels. The closer to the bulk of the Al anode, the layer more closely resembled the presence of AlClO while the Al₂O₃ contribution disappeared. In total, these observations suggest that the Lewis' acidity of the electrolytes continuously etch the ionically resistive alumina layer, exposing the Al anode to the electrolyte, that in turn, reacts with the chloroaluminate species forming AlClO. However, there is an upper limit to the Lewis' acidity (i.e., concentration of Al₂Cl₇—species) needed for this to occur. At high concentrations of Al₂Cl₇— (e.g., ≥90%), corrosion of the components is observed (FIG. 16) and readily electrochemical decomposition of the electrolyte is anticipated under reductive conditions (FIGS. 22 and 25(A)-(B)) forming an organic interphase.

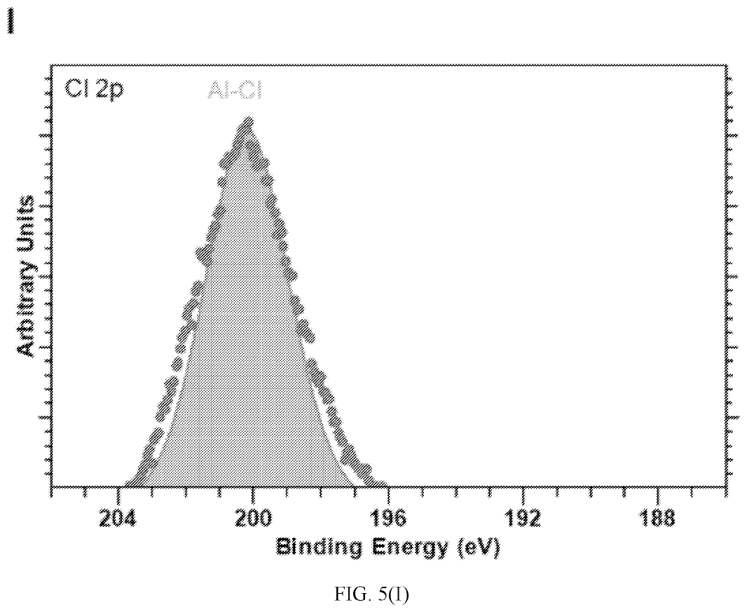

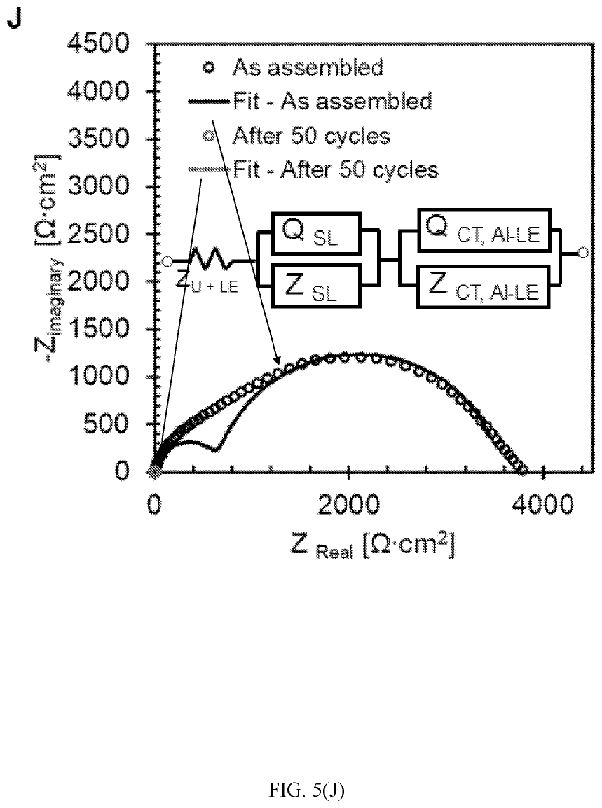

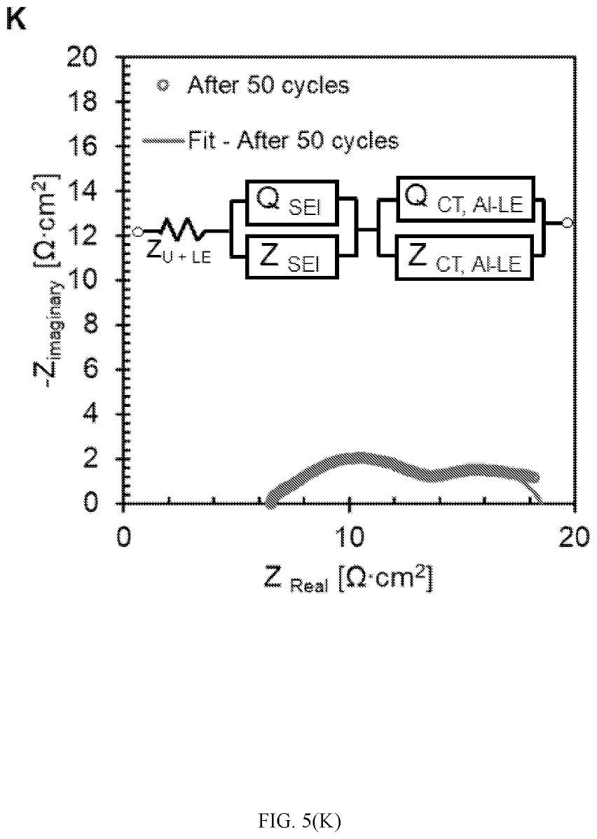

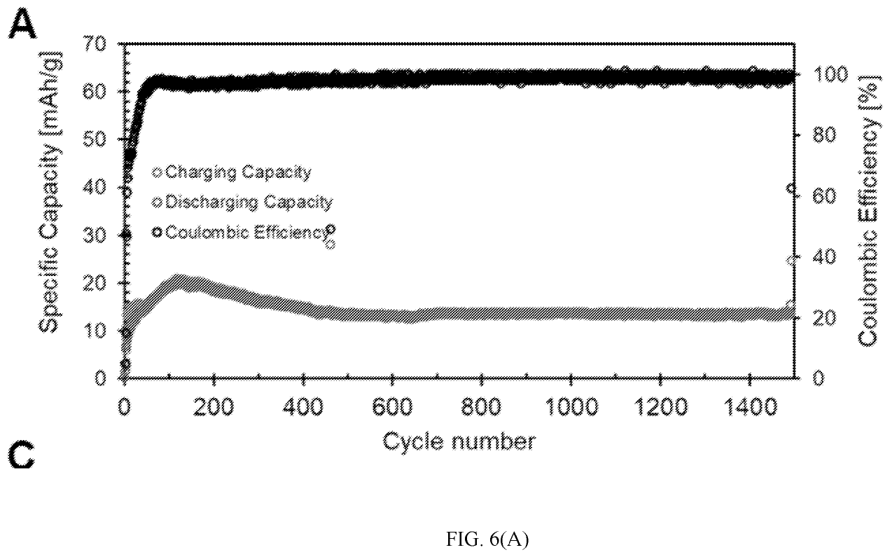

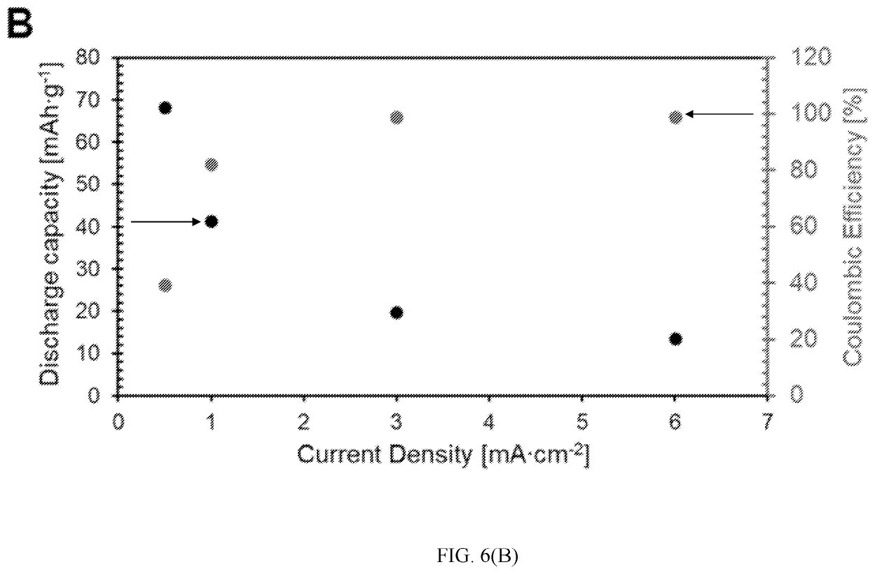

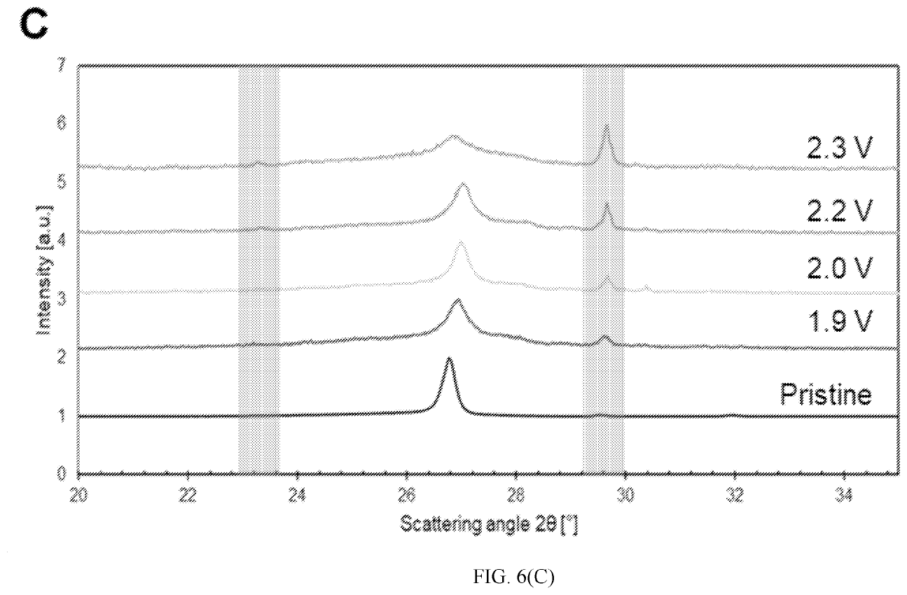

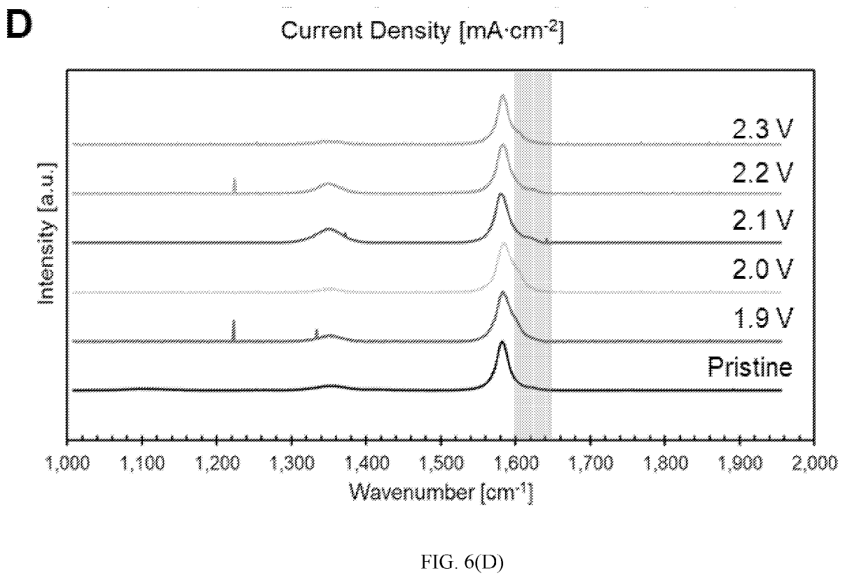

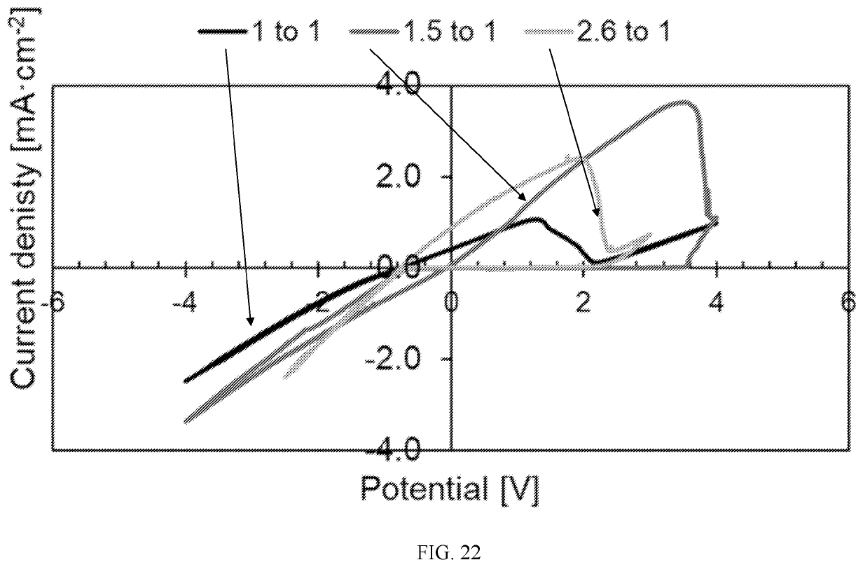

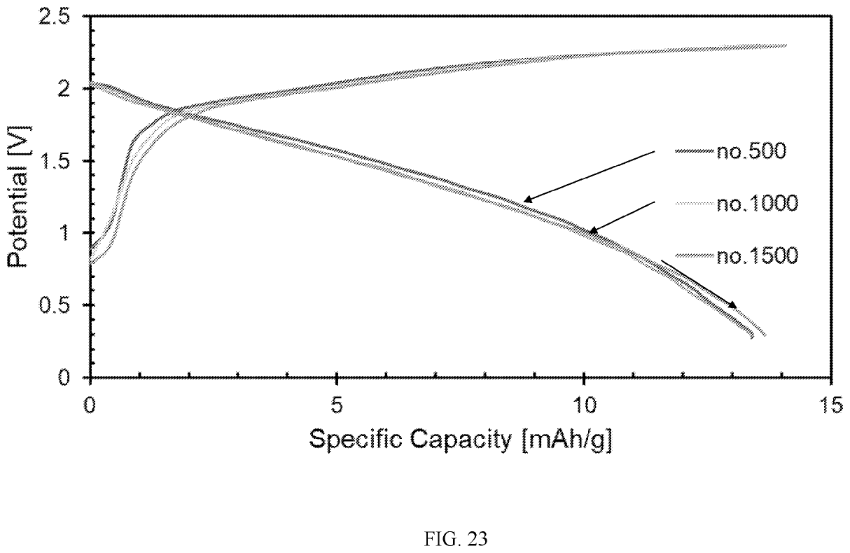

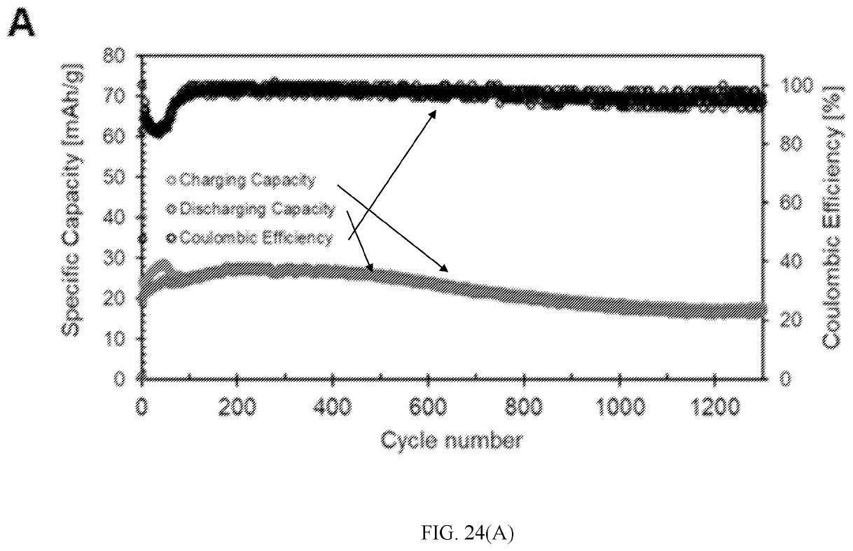

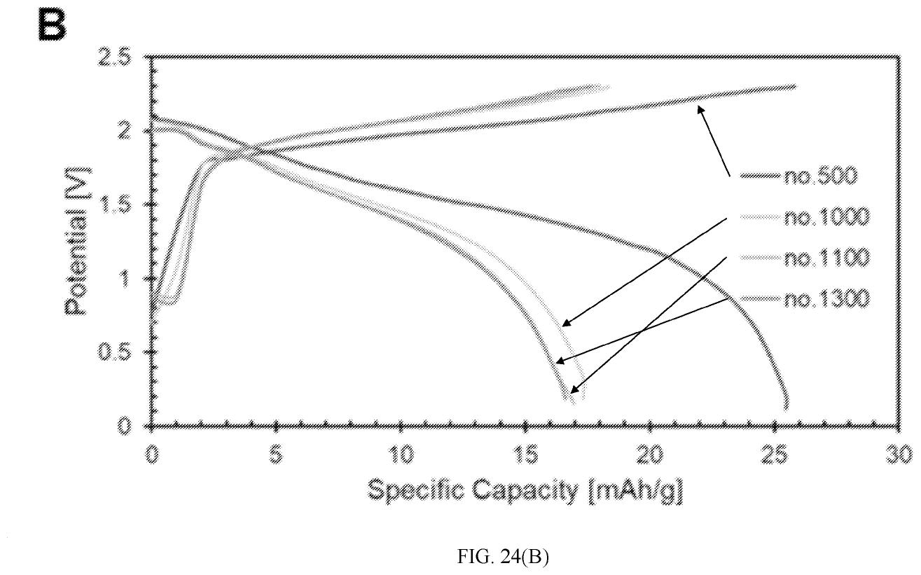

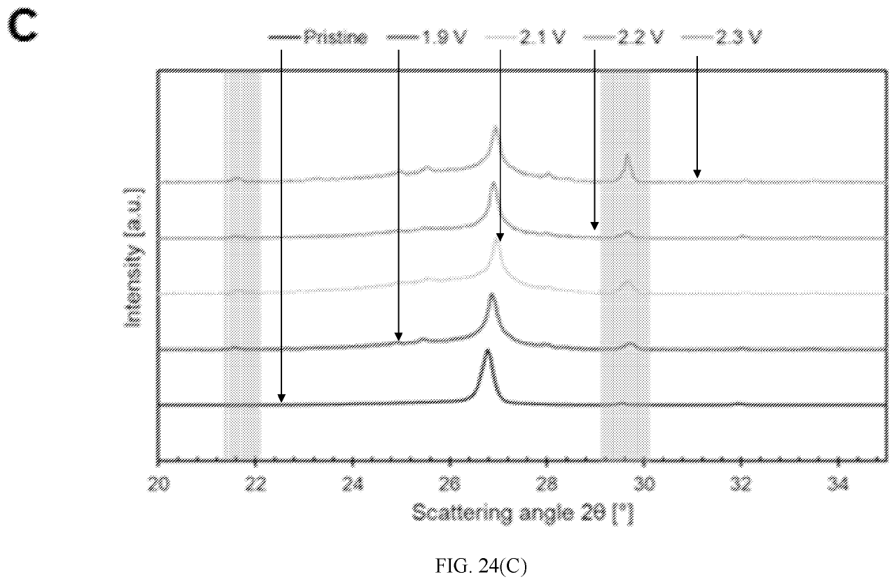

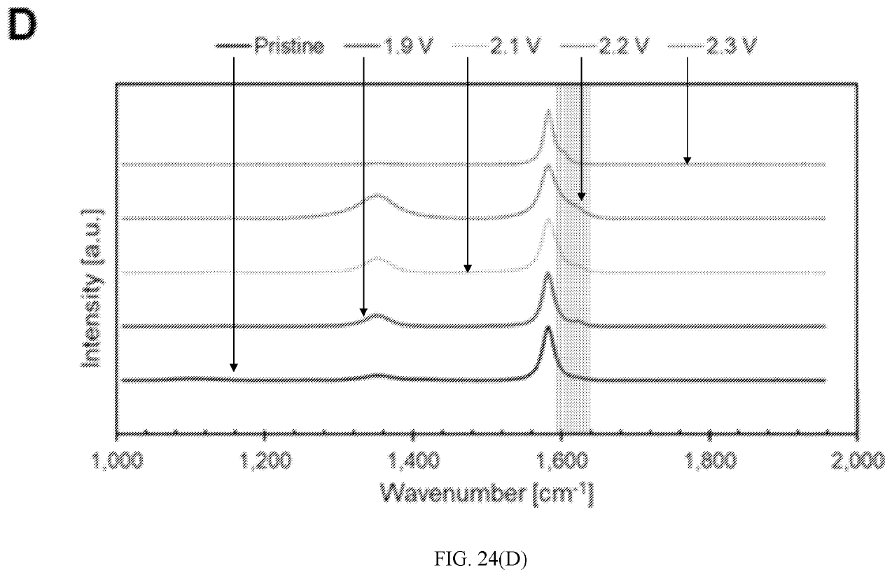

As a first demonstration of the practical relevance of our findings, Al vs. graphite full cells were evaluated in galvanostatic cycling experiments using the electrolytes that showed the highest Al plating/stripping reversibility: AlCl₃-TriMAHCl (1.5:1) and AlCl₃-TriEAHCl (1.6:1). We note that although the ratio of AlCl₄⁻ to Al₂Cl₇⁻ are similar in these electrolytes and the electrolytes exhibit comparable Al plating/stripping reversibility, only the AlCl₃-TriMAHCl (1.5:1) supported stable long-term cycling of Al batteries, with more capacity fade when using AlCl₃-TriEAHCl (FIG. 6A and FIGS. 23-24). We conclude that the specific cation chemistry and physical properties play an important role in the solvation/de-solvation characteristics of the electrolytes. We will take this aspect up in a follow-up study in which the effects of TriMAH⁺ and TriEAH⁺ size on the de-solvation energy and formation of a cathode electrolyte interphase could provide insight into the cycling stability of both systems. In addition, the increase in reversibility in the first ˜50 cycles is attributed to the anode interface, where the etching of the alumina surface layer occurs followed by the formation of a SEI consisting of AlClO that enables high reversibility of Al plating and stripping.

FIG. 6A reports the discharge capacity and columbic efficiency of Al vs. graphite full cells cycled at a fixed current density of 335.4 mA·g⁻¹ (6 mA·cm⁻²). Under these conditions, a specific discharge capacity of approximately 15 mAh·g⁻¹ (based on the graphitic carbon mass in the cathode) and average Coulombic efficiency of 97.65% are maintained for over 1,300 cycles in battery cells that use AlCl₃-TriMAHCl (1.5:1) as electrolyte. While lower than the approximately 60 mAh·g⁻¹ reported by Lin et al. using a custom fabricated type of graphitic carbon foam as the cathode, our findings are in good agreement with expectations for a stage-3 graphite intercalation compound (GIC) based on analysis of the diffraction patterns (FIG. 6C) and theoretical predictions. Bhauriyal et al. predicted via first-principles calculations that graphite can store from 25.94 to 69.62 mAh·g⁻¹ of chloroaluminate species for a stage-4 and stage-1 GIC, respectively; implying that with better cathode design and lower discharge rates, higher discharge capacities are achievable, as seen in FIG. 6B. The current cathode design can achieve a stage-1 GIC, reaching the theoretical value predicted by Bhauriyal et al., however, the reversibility of the process is reduced significantly. Additionally, the intercalant gallery height (distance separating two graphite layers) was estimated to be ˜5.22 Å based on the diffraction patterns, suggesting that the AlCl₄⁻ anions with a comparable size (˜5.28 Å) are the most likely intercalant species.

Prior experimental and theoretical work have proposed that a distorted tetrahedral geometry of AlCl₄⁻ is intercalated as opposed to a planar geometry given its higher thermodynamic stability. The distortion results from the van der Waals forces between the graphite layers, reducing the graphite interlayer distance by compressing the size of tetrahedral AlCl₄, giving it a distorted geometry. The Raman spectra collected on the same cathodes was also performed to probe chloroaluminate anion intercalation into graphite upon charge (FIG. 6D). The graphite G band (˜1584 cm⁻¹) shows evidence of a right shoulder at ˜1605 cm⁻¹ upon anion intercalation, in good agreement with prior work by Lin et al. and Angell et al. We note that the initial G band remains largely intact, indicating that more hosting capacity exists in the cathode than utilized in the battery discharge when using 1 mA·cm⁻², as it was observed when charging at a lower current density (0.5 mA·cm⁻²), and achieving a larger gravimetric capacity (FIG. 6B).

The XRD and Raman measurements both suggest that anion intercalation occurs upon charging and that AlCl₄⁻ is the intercalation species in the graphite cathode. Nevertheless, to more conclusively establish the identity of the intercalated species, we performed X-ray Absorption Spectroscopy (XAS) measurements. XAS measurements were collected on graphite cathodes charged to 2.3 V where the electrolyte was either AlCl₃:TriMAHCl (1.5:1) or AlCl₃:EMIMCl (1.8:1), for comparison.

We report that low-cost electrolytes based on quaternary ammonium-based salts of broken symmetry can be designed with melting points below room temperature. By means of electrochemical, spectroscopic, and morphological analyses we evaluate the critical role of each chloroaluminate species in Al electrochemical properties in batteries. We find that the reversibility of Al plating and stripping, the nature of the solid electrolyte interphase it forms, and the morphological evolution during plating and stripping of Al depend sensitively and quantitatively on the ratio of AlCl₄⁻ to Al₂Cl₇⁻ ions in the electrolyte. The sensitivity stems from the dual role the ions play in facilitating electroreduction at the Al/electrolyte interface and in etching the resistive alumina surface layer that forms on the Al that prevents transport to the interface. A key finding is that provided the ratio of AlCl₄⁻ to Al₂Cl₇⁻ ions can be preserved in room temperature electrolytes with broken cation symmetry, it is possible to achieve highly efficient plating and stripping of Al in cost-effective quaternary ammonium-based electrolyte media.

We leverage the last discovery to create Al∥graphite electrochemical cells and study them as platforms for achieving low-cost, long-duration storage of electrical energy. Galvanostatic charge-discharge measurements show that these cells demonstrate stable long-term cycling performance, particularly when AlCl₃-TriMAHCl (1.5:1) is used as electrolyte. The electrolyte molecular design approach presented here therefore offers a promising, new route towards achieving low melting point electrolytes with the desired Lewis acidity for highly reversible Al electrodeposition and dissolution in secondary batteries.

TABLE 2
Room-temperature electrochemical potential windows for ionic liquids.

| | | | | [Al₂Cl₇]⁻ | | |
|---|---|---|---|---|---|---|
| Ionic liquid | | AlCl₃ mole | | concentration | Window | |
| system | Cation(s) | fraction | Anion(s) | [%] | [V] | Reference |
| AlCl₃-EMIMCl | [EMIM]+ | 0.7 | [AlCl₄]⁻/Cl⁻ | Not reported | 2.8 | Wasserscheid, |
| | | (Basic) | | | | P. et al. |
| | | 1 | [AlCl₄]⁻ | Not reported | 4.4 | |
| | | (Neutral) | | | | |
| | | 1.2 | [Al₂Cl₇]⁻/[AlCl₄]⁻ | Not reported | 2.9 | |
| | | (Acid) | | | | |
| AlCl₃-TriEAHCl | [TriEAH]+ | 1.2 | [Al₂Cl₇]⁻/[AlCl₄]⁻ | 33 | 2.91 | This work |
| | | 1.6 | [Al₂Cl₇]⁻/[AlCl₄]⁻ | 78 | 2.87 | |
| | | 2.2 | [Al₂Cl₇]⁻/[AlCl₄]⁻ | 100 | 2.78 | |
| AlCl₃-TriMAHCl | [TriMAH]+ | 1 | [Al₂Cl₇]⁻/[AlCl₄]⁻ | 45 | 2.95 | This work |
| | | 1.5 | [Al₂Cl₇]⁻/[AlCl₄]⁻ | 77 | 2.84 | |
| | | 2.6 | [Al₂Cl₇]⁻/[AlCl₄]⁻ | 90 | 2.80 | |

Reference: Wasserscheid, P., Welton, P., Ionic Liquids in Synthesis. Volume 1, edition 2, 2007. John Wiley & Sons Ltd. Chapter 3: Physicochemical Properties.

Electrolyte preparation. The chloroaluminate compounds were prepared by slowly adding appropriate amounts of anhydrous AlCl₃ to 1-ethyl-3-methylimidazolium chloride (EMIMCl), trimethylamine-hydrochloride (TriMAHCl), triethylamine-hydrochloride (TriEAHCl), tetramethylammonium chloride (TetraMACl) or tetraethylammonium chloride (TetraEACl) while stirring in a dry Ar-filled glovebox (<0.1 ppm H₂O, <1 ppm O₂).

Phase diagram construction. Differential Scanning Calorimetry (DSC) measurements were carried out at different cooling/heating rates: 0.75, 1.5, 3, 4, 5 and 6° C.·min⁻¹. Exposure to moisture was minimized by drying the DSC pans in a vacuum oven at −120° C. for >8 h, use of hermetic pans and sealing the samples inside of a dry Ar-filled glovebox (<0.1 ppm H₂O, <1 ppm O₂) right before the measurement was conducted. Freezing temperatures (T_{freeze}) were obtained upon solidification of the samples, starting with a cooling step for the compositions that form room temperature (RT) molten salts. Alternatively, the compositions that are crystalline at RT were heated up to their melting temperature, followed by a cooling step.

Molecular structures. ACD/ChemSketch/3D Viewer (Freeware) 2021.1.0, version D25E41 was used to draw the structures in ball-and-stick style and converted into 3D. VESTA Ver. 3.4.8 was used to modify orientation and polyhedral style of the molecules.

²⁷Al Nuclear Magnetic Resonance (NMR). Spectra were collected by using a Bruker AV400 NMR spectrometer at room temperature (298 K), BBFO broadband probe, HD electronics console. The quantitative acquisition was performed (128 scans, 900 excitation, is relaxation delay) with background suppression. The relative concentration determination of AlCl₄⁻ and Al₂Cl₇⁻ species were performed in MestReNova version 14.2.1-27684 (© 2021 Mestrelab Research S.L) with a qNMR plug-in.

Electrode imaging and elemental mapping. Plain carbon cloth working electrodes (WE) were collected from coin cells assembled for Coulombic efficiency measurements after an electrodeposition step was completed. Coin cells were disassembled inside an Ar-filled glovebox, cleaned with dimethyl carbonate (DMC), mounted on carbon tape, and examined by SEM (Zeiss Gemini 500) with an accelerating voltage of 5 kV, 20 mm aperture. The samples were transferred to the instrument using air-tight containers and loaded immediately after opening the containers to reduce exposure time to moisture. Elemental mapping was performed using Energy Dispersive X-Ray Spectroscopy-EDS/EDX with an accelerating voltage of 15 kV, 60 mm aperture.

The cross-section imaging of the Al electrode surface after cycling was conducted on Raith VELION Focused Ion Beam-Scanning Electron Microscopy (FIB-SEM) system with Au+ ion source. Before trenching, Pt was deposited onto the sample surface to protect the surface features. The cross-section images were taken using the SEM integrated into the system.

Cell assembly and electrochemical measurements. All cell assembly was conducted in a dry Ar-filled glovebox (<0.1 ppm H₂O, <1 ppm O₂) and all electrochemical tests were performed at room temperature (˜25° C.). Al plating/stripping coulombic efficiency (CE) measurements were carried out in Al (CE)∥carbon cloth (WE) and Al symmetric coin cells (CR2032) using a Neware battery tester. 0.9525 cm (⅜″) aluminum foil disks (25 m thick, 99.45% metals basis, Alfa Aesar) were punch out and used as the anodes. 1.27 cm (½″) plain carbon cloth disks (356 μm thick, 1071 HCB, Fuel Cell Store) were used as a substrate for Al galvanostatic electrodeposition/dissolution. One layer of fiberglass fiber filter paper GF-D (Whatman) was placed between the WE and CE with a diameter of 1.905 cm or ¾″, and ˜100 μL of electrolyte was poured before sealing. The amount of Al electrodeposited onto the carbon cloth in each step was fixed, followed by a stripping step. The percentage of Al stripped from the substrate electrode compared to the amount plated in the previous step represents the coulombic efficiency values reported in this work: CE [%]=(Stripping Capacity/Plating Capacity on substrate)×100.

Electrochemical impedance spectroscopy (EIS) measurements were collected in Al symmetric cells at room temperature using a potentiostat BioLogic SP-200. The frequency range used was 7 MHz-50 mHz, using a 10 mV as the perturbation voltage and 3 measurements were acquired per frequency. Al electrodes were used for ionic conductivity measurements. Equivalent circuit modeling was used to validate the analysis. The equivalent circuit used to analyze the frequency-dependent transport phenomena was Z_{u+LE}+Q_{SL/SEI}/Z_{SL/SEI}+Q_{CT, Al-LE}/Z_{CT, Al-LE}, where Z_{u+LE} correspond to the uncompensated and liquid electrolyte impedance, Q_{SL/SEI} and Z_{SL/SEI} correspond to the constant phase element and ionic impedance of the solid layer/solid electrolyte interphase, respectively. Q_{CT, Al-LE} and Z_{CT, Al-LE} denote the constant phase element and impedance at the electrode/electrolyte interface (CT=charge transfer).

Full cell measurements were carried out in Al (CE)∥graphite (WE) coin cells (CR2032) using a Neware battery tester. 0.9525 cm (⅜″) aluminum foil disks (aluminum foil disks (25 m thick, 99.45% metals basis, Alfa Aesar) were punch out and used as the anodes. 1.27 cm (½″) plain carbon cloth disks (356 m thick, 1071 HCB, Fuel Cell Store) were used as a substrate and current collector for the graphite cathodes. The graphite slurry consisted of 80 wt. % artificial graphite powder (MTI Corporation), 10 wt. % battery-grade carboxymethyl cellulose (CMC) binder, and 10 wt. % deionized water. After coating the carbon cloth substrates with the graphite slurry, the electrodes were dried in an oven at 90° C. for ≥12 h before cell assembly. One layer of fiberglass fiber filter paper GF-D (Whatman) was placed between the anode and cathode, and ˜100 μL of electrolyte was poured before sealing. The full cells were charged and discharged between the cut-off potentials of 2.3 and 0.2 V at a current density of ˜330 mA·g⁻¹ (6 mA·cm⁻²), except for the cells used for XRD and Raman characterization (1 mA·cm⁻²).

Three-electrode cyclic voltammetry measurements were performed using a potentiostat/galvanostat Bio-Logic SP-200. The working electrode was a glassy carbon disk, the counter electrode an Al foil, and a 2 mm diameter Pt reference electrode (CH Instruments, Inc.). All three electrodes were placed in a t-shaped Swagelok-type cell with two layers of fiberglass fiber filter paper GF-D (Whatman) and ˜200 μL of electrolyte. The scanning voltage range was set from −4 to 4 V (versus Pt.), and the scan rate was 20 mV·s⁻¹.

The ionic conductivity measurements as a function of temperature were conducted using a Novocontrol dielectric spectrometer with temperature control systems. The frequency range evaluated was from 10 MHz to 50 mHz, from 25-60° C. (±0.5° C.).

X-ray Photoelectron Spectroscopy Measurements. A Surface Science Instruments SSX 100 was used for all XPS experiments. A custom-made airtight transfer holder was used to load the samples from a dry Ar-filled glovebox into the XPS instrument without air exposure. Survey scans used for the depth profiling used ion energy of 4 keV, a 10 mA current, a step size of 1 eV, a raster of 2×4 mm, 150 V pass energy, and a spot size of 400 m. The high-resolution scans used a step size of 0.065 eV, resolution 2, while the rest of the parameters remained the same for the survey scans. All scans were quantified using Shirley backgrounds and sensitivity factors for O 1s, Al 2p, and Cl 2p in Casa XPS software. Core scans used a pass energy of 150 V and were calibrated using C—C bond energy at 285 eV. The following time steps and sequence were used to obtain surface chemistry measurements of the Al anode at the surface and near the bulk; 0, 2, 5 min to remove adventitious carbon, 3 measurements every 10 min of Ar-sputtering, a high-resolution scan, 3 measurements every 30 min of Ar-sputtering, a high-resolution scan, and 5 measurements every 60 min of Ar-sputtering, for a total of ˜13 h (h=hour(s)).

Structural changes of graphite cathodes upon intercalation. Graphite cathodes were collected after charging up to 1.9, 2.0, 2.1, 2.2 and 2.3 V from Al∥graphite cells utilizing either AlCl₃:TriMAHCl (1.5:1) or AlCl₃:TriEAHCl (1.8:1) electrolytes. Cathodes were rinsed with anhydrous methanol, dried, and kept under an inert atmosphere prior to analysis.

X-ray diffraction measurements were carried out using a Bruker D8 powder diffractometer (Cu kα 1.54 Å radiation, step size 0.0194577°) between 20-35 2-theta degrees at 40 kV, 25 mA, a divergent beam slit of 1.0 mm, and a detector slit of 9 mm.

Raman spectra were collected using a WITec-Alpha 300R Confocal Raman Microscope. A 532 nm green laser was used at 2 mW, 1200 l·mm⁻¹ grating, spectral center at 1500 cm⁻¹, 15 accumulations, and 30 s integration time.

Intercalation Species Determination via X-ray Absorption Spectroscopy Measurements. Cathodes were collected in the charged state (2.3 V) from Al∥graphite cells utilizing either AlCl₃:TriMAHCl (1.5:1) or AlCl₃:EMIM]Cl (1.8:1) electrolytes. Cathodes were rinsed with anhydrous methanol, dried, and kept under an inert atmosphere prior to analysis.

Although the present disclosure has been described with respect to one or more particular embodiment(s) and/or example(s), it will be understood that other embodiments and/or examples of the present disclosure may be made without departing from the scope of the present disclosure.

1. A composition comprising:
one or more ion-conducing salt(s);
one or more asymmetric ammonium salt(s); and
optionally, one or more salt(s).

2. The composition of claim 1, wherein the composition is a liquid, a molten salt, or an ionic liquid.

3. The composition of claim 1, wherein the ion-conducting salt(s) is/are chosen from lithium salts, sodium salts, calcium salts, magnesium salts, aluminum salts, zinc salts, and any combination thereof.

4. The composition of claim 1, wherein the ion-conducting salt cation(s) is/are chosen from lithium cation, sodium cation, calcium cation, magnesium cation, aluminum cation, zinc cation, and any combination thereof.

5. The composition of claim 1, wherein the ion-conducting salt anions(s) is/are chosen from halide anions, hydroxide, perchlorate, nitrate, sulfate, phosphate, borates, AsF₆⁻, OTf⁻, CF₃SO₃⁻, bis(fluoromethylsulfonyl)imide (FSI), bis(trifluoromethylsulfonyl)imide (BMPTFSI), bis(perfluoroethane)sulfonyl)imide (BETI), heterocyclic anions, and any combination thereof.

6. The composition of claim 1, wherein the asymmetric ammonium salt(s) is/are chosen from asymmetric primary ammonium salt(s), asymmetric secondary ammonium salt(s), asymmetric tertiary ammonium salt(s), asymmetric quaternary ammonium salt(s), and any combination thereof.

7. The composition of claim 6, wherein the quaternary asymmetric ammonium salt cation(s), independently at each occurrence, comprise the following structure: N⁺(R¹)(R²)(R³)(R⁴), wherein R¹, R², R³, and R⁴ are independently at each occurrence chosen from alkyl groups, and aryl groups, with the proviso that no two of R¹, R², R³, or R⁴ are the same.

8. The composition of claim 7, wherein the quaternary asymmetric ammonium salt anion(s) is/are chosen from halide anions, hydroxide, perchlorate, nitrate, sulfate, phosphate, borates, AsF₆⁻, OTf⁻, CF₃SO₃⁻, bis(fluoromethylsulfonyl)imide (FSI), bis(trifluoromethylsulfonyl)imide (BMPTFSI), bis(perfluoroethane)sulfonyl)imide (BETI), heterocyclic anions, and any combination thereof.

9. The composition of claim 1, wherein one or more or all of the asymmetric ammonium salt(s) has/have C3v symmetry.

10. The composition claim 1, wherein the ion-conducting salt(s): asymmetric ammonium salt(s) molar ratio is about 0.7:1 to about 3:1.

11. The composition of claim 1, wherein the salt(s) is/are chosen from lithium salts, sodium salts, calcium salts, magnesium salts, aluminum salts, zinc salts, and any combination thereof.

12. The composition of claim 1, wherein the salt(s) is/are present at about 0.01 M to about 1.5M, based on the total volume of the composition.

13. The composition of claim 1, wherein the composition is an electrolyte in an electrochemical device.

14. The composition of claim 1, wherein at least a portion of the ion-conducting salt(s) is aluminum trichloride, and the composition comprises Al₂Cl₇⁻, AlCl₄⁻, or a combination thereof.

15. A metal anode comprising a solid electrolyte interphase (SEI) layer disposed on at least a portion or all of the relevant portion(s) of the anode formed by interaction with a composition of claim 1.

16. The metal anode of claim 15, wherein the SEI layer comprises a thickness of about 1 nm to about 2 microns.

17. The metal anode of claim 15, wherein the anode comprises a layer of electrochemically active metal comprising lithium metal, sodium metal, calcium metal, magnesium metal, aluminum metal, or zinc metal.

18. The metal anode of claim 17, wherein the layer of the electrochemically active metal is continuous over about 50% or greater of one or more relevant surface(s) of anode and/or there are no observable discontinuities in the layer of the electrochemically active metal over about 50% or greater of one or more relevant surface(s) of anode and/or the layer of the electrochemically active metal does not exhibit an isolated electrochemically active metal deposit.

19. The metal anode of claim 15, wherein the metal anode comprises aluminium metal and the SEI layer comprises AlClO—.

20. A device comprising one or more metal anode(s) of claim 15, wherein the composition(s) is/are an electrolyte/electrolytes in the device.

21. The device of claim 20, wherein the device is an electrochemical device.

22. The device of claim 21, wherein the electrochemical device is a battery, a supercapacitor, a fuel cell, an electrolyzer, or an electrolytic cell.

23. The device of claim 22, wherein the battery is a metal ion-conducting battery and/or a metal battery.

24. The device of claim 23, wherein the metal ion-conducting battery is an aluminum-ion conducting battery, a zinc-ion conducting battery, a lithium-ion conducting battery, a sodium-ion conducting battery, a calcium-ion conducting battery, or a magnesium-ion conducting battery.

25. The device of claim 23, wherein the metal ion-conducting battery is a rechargeable metal-ion conducting battery.

26. The device of claim 21, wherein at least a portion of the ion-conducting salt(s) is aluminum trichloride and the composition comprises Al₂Cl₇⁻, AlCl₄⁻, or a combination thereof, and wherein the anode is an aluminum metal anode and the SEI layer comprises AlClO-layer.

27. The device of claim 22, wherein the device comprises one or more cathode(s) or one or more cathode material(s).

28. The device of claim 22, wherein the device further comprises one or more cathode(s) and one or more separator(s) and/or one or more current collector(s) and/or one or more solid-phase electrolyte(s) and/or one or more additional structural component(s).

29. The device of claim 28, wherein the composition(s), the anode(s), cathode(s), and, optionally, the current collector(s) form a cell of a battery.

30. The device of claim 29, wherein the device comprises a plurality of cells, each cell independently comprising one or more composition(s) and/or one or more anode(s) and/or anode material(s), and optionally, one or more current collector(s), or a combination thereof.

31. The device of claim 29, wherein the device comprises 1 to 500 cells.
